(19) United States
(12) Patent Application Publication
(10) Pub. No.: US 2009/0214193 A1
(43) Pub. Date: Aug. 27, 2009

(54) LIGHT EMISSION TYPE HEATING METHOD AND LIGHT EMISSION TYPE HEATING APPARATUS

(75) Inventors: Shinji SUZUKI, Tokyo (JP); Kyohei Seki, Hyogo (JP); Tetsuya Kitagawa, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/392,481

(22) Filed: Feb. 25, 2009

(30) Foreign Application Priority Data
Feb. 25, 2008 (JP) 2008-042777

(51) Int. Cl. F26B 3/28

(52) U.S. Cl. 392/411

(57) ABSTRACT

A light emission type heating apparatus comprises a first lamp unit which includes two or more lamps, in which at least one of the lamps includes two or more filaments in its light emission bulb, and intensity of light emitted from each filament is independently controlled, and a second lamp unit which is made up of two or more lamps, and wherein the lamps of the first lamp unit are grouped, in each of which a filament of at least one of the lamps and a filament of another one of the lamps are arranged to form groups, wherein a temperature of the workpiece is detected, and electric power to be applied to each of the groups of filaments is controlled based on the detected temperature of the workpiece.

### CROSS-REFERENCES TO RELATED APPLICATION

This application claims priority from Japanese Patent Application Serial No. 2008-042777 filed Feb. 25, 2008, the content of which is incorporated herein by reference in its entirety.

### TECHNICAL FIELD

The present invention relates to a light emission type heating apparatus and a light emission type heat treatment method for rapidly heat-treating a workpiece at high temperature by emitting light thereto.

### BACKGROUND

Generally, a heat treatment is adopted in various steps such as film forming, oxidization diffusion, impurity diffusion, nitriding, film stabilization, silicidizing, crystallization, and/or ion implantation activation, of a semiconductor manufacturing process. In order to improve the yield rate or the quality in such a semiconductor manufacturing process, a rapid thermal processing (RTP) in which the temperature of a workpiece, such as a semiconductor wafer, is rapidly raised or lowered, is desirably used. In the RTP, a light emission type heating treatment apparatus, which uses light emitted from a light source such as an incandescent lamp, is used widely.

The incandescent lamp having a filament which is disposed inside a light emission bulb made of light transmissive material, radiates 90% or more of applied power in total, and can heat the workpiece without any contact, so that such an incandescent lamp is a typical lamp by which light can be used as heat. When the incandescent lamp is used as a heat source for heating of a glass substrate or a semiconductor wafer, the temperature of the workpiece can be raised or lowered at a high speed as compared with a resistance heating method.

That is, the temperature of the workpiece can be raised to 1,000 degree Celsius or more in approximately ten seconds to several tens of seconds by such a light emission type heat treatment. The irradiated woke piece is rapidly cooled down after the light emission is stopped. Such a light emission type heat treatment is usually performed two or more times.

When the workpiece which is, for example, a semiconductor wafer (single-crystal silicon wafer) is heated to 1050 degree Celsius or more, if temperature distribution of the semiconductor wafer does not become uniform, there is a possibility that a phenomenon called “slip” occurs in the semiconductor wafer, i.e., defect of crystal transformation, in which case the wafer is defective. Therefore, when the RTP is performed on the semiconductor wafer using a light emission type heating treatment apparatus, it is necessary to heat, maintain at high temperature, and cool down the semiconductor wafer, so that the temperature distribution of the whole semiconductor wafer surface may become uniform. Furthermore, even when heating the semiconductor wafer for film forming, in order to form a film having a uniform thickness, a precise heat treatment of the semiconductor wafer is required so that the temperature distribution of the semiconductor wafer may become uniform. That is, the highly precise temperature uniformity of the workpiece is required in the RTP.

(1) Example of the Structure of Conventional Light Emitting Apparatus

For example, as disclosed in Japanese Laid Open Patent No. S62-20308, a conventional light emission type heating apparatus has a light emission unit which is a heating unit, and the light emission unit is formed by arranging, in parallel, two or more straight-bulb filament lamps, so that light can be emitted onto a workpiece having a large area.

The schematic structure of a light emission type heating apparatus is shown in FIG. 30. As described above, in FIG. 30, the light emission unit 500 is formed by arranging, in parallel, two or more straight-bulb filament lamps 501. A wave-shaped mirror 502 which is a reflecting mirror, is provided above these lamps. The wave-shaped mirror 502 includes reflective face made up two or more concave portions arranged in parallel. The straight-bulb filament lamps 501 are partially surrounded by the respective concave portions. The shape of each concave portion of the wave type mirror 502 is designed so that light reflected by the concave portion may have a certain degree of directivity. That is, a spread of the light reflected by the concave portion of the wave type mirror 502 is smaller than that of the light which is directly irradiated onto the semiconductor wafer 506 from each lamp.

Generally, a workpiece such as a semiconductor wafer 506 etc. is placed in a processing chamber 504. Light emitted from the light emission unit 500 is irradiated onto the workpiece through a light transmission window member 503 for light transmission provided in the processing chamber 504. FIG. 30 illustrates a case where the semiconductor wafer 506 is used as a workpiece. Furthermore, a guard ring 505 is provided so as to surround the outer edge of the workpiece. Description of the guard ring will be given later.

Generally, in a conventional light emission type heating apparatus, the illuminance distribution of a workpiece surface is made uniform in many cases, thereby making heat treatment temperature of the workpiece uniform. Therefore, means for rotating the workpiece or the light emission unit is adopted. In case where the physical property of the whole semiconductor wafer surface is uniform, if light is emitted so that the illuminance on the whole semiconductor wafer surface may become uniform, it is considered that the temperature of the semiconductor wafer becomes uniform. However, even if, in fact, light is emitted to the semiconductor wafer on such irradiation conditions, the temperature of the edge portion of the semiconductor wafer becomes low, so that the temperature distribution of the semiconductor wafer does not becomes uniform. As described above, when the semiconductor wafer is heated to 1050 degree Celsius or more, if the temperature distribution of the semiconductor wafer does not become uniform, a phenomenon, “slip” in the semiconductor wafer occurs. Thus, the temperature of the edge portion of the semiconductor wafer becomes low, because heat is released from the edge portion of the semiconductor wafer, such as a side of the semiconductor wafer or near a side of the semiconductor wafer, etc. Therefore, in order to make temperature distribution of the semiconductor wafer uniform entirely, it is necessary to compensate the temperature fall due to the thermal radiation from the edge portion of the semiconductor wafer. For example, light is emitted, so that the surface illuminance of the edge portion of the wafer may become larger than that of a central part of the wafer.

On the other hand, as one of methods which prevent the temperature fall of the edge portion of the semiconductor wafer, conventionally, there is a proposed method of arranging an auxiliary member (material) having the heat capacity equivalent to the semiconductor wafer, so that an outer edge of the semiconductor wafer may be surrounded. Such an auxiliary member is generally called a guard ring (refer to FIG. 30). When the heat capacity of the guard ring which is arranged so as to surround the outer edge of the semiconductor wafer, is equivalent to that of the semiconductor wafer, the semiconductor wafer and the guard ring may be regarded as one member of integrated virtual plate-like member. In this case, since the edge portion of the semiconductor wafer does not, in fact, become the edge portion of the virtual plate-like member, heat is not released from the edge portion of the semiconductor wafer. Therefore, the temperature of the edge portion of the semiconductor wafer does not drop. That is, when the guard ring which is described above is used, the temperature fall due to the thermal radiation from the edge portion of the semiconductor wafer is compensated, so that it is possible to make the temperature of the semiconductor wafer uniform. In addition, since the guard ring is provided so that the outer edge of the semiconductor wafer may be surrounded, the guard ring may be used for serving as a semiconductor wafer holding member, by adding a function of holding the circumferential edge of the semiconductor wafer, to the guard ring.

However, in practice, it is difficult to form the guard ring and the semiconductor wafer as an integrated part (that is, the heat capacity of them becomes equivalent to each other). The reason thereof will be described below. In order to make the heat capacity of the guard ring and that of the semiconductor wafer the same, it is necessary to make the quality of the material of the guard ring and that of the material of the semiconductor wafer the same. For example, silicon (Si) may be selected as the material of the guard ring, when the semiconductor wafer is a silicon semiconductor wafer. When the silicon is repeatedly exposed to a state where there is a large temperature difference, the wafer is deformed so that it does not function as a guard ring. In order to avoid the problem of the deformation, the guard ring is generally made from silicon carbide (SiC) in many cases. Although the specific heat of silicon carbide is a little larger than that of silicon, it is not greatly different from each other. However, since processing of such silicon carbide is difficult, and the thickness thereof cannot be made thinner than 1 mm due to a matter of processing (yield), the thickness of the semiconductor wafer becomes thicker than 0.7-0.8 mm. Because of the difference in the specific heat of silicon and silicon carbide, and the difference between the thickness of the semiconductor wafer and that of the guard ring made from silicon carbide, the heat capacity of the guard ring increases approximately 1.5 times larger than that of the semiconductor wafer per unit area, when it is heated to a high temperature. Therefore, in order to operate the guard ring so that the temperature fall of the edge portion of the semiconductor wafer may be compensated, it is necessary to cancel the influence of the heat-capacity difference between the semiconductor wafer and the guard ring. Specifically, it is necessary to emit light onto the guard ring with illuminance larger than that of light emitted on the semiconductor wafer.

When the light emission type heating apparatus which has a light emission unit as shown in FIG. 30 is used, two or more lamps are divided into some control zones (lamp groups), and are respectively controlled, so that the illuminance distribution in an irradiated area is set so as to be a predetermined distribution. For example, in a light emission type heating apparatus which is disclosed in Japanese Laid Open Patent No. 62-20308, two or more straight-bulb halogen lamps which form a light emission unit, are divided into groups, each of which includes several lamps, and a heat output from each lamp group is controlled by independently controlling each lamp group as a unit to be controlled. For example, as shown in FIG. 31, when dividing the irradiated area of a workpiece (wafer 506) into a zone A (an edge portion of the workpiece) and a zone B (a central portion of the workpiece) workpiece, the two or more straight-bulb halogen lamps are also grouped into a lamp group LA which corresponds to the zone A, and a lamp group LB which corresponds to the zone B. And, for example, when the intensity of light emitted from the lamp group LA for the zone A is set up so as to be lager than that of the light emitted from the lamp group LB for the zone B, it becomes possible to make the illuminance on the zone A larger than the illuminance on the zone B.

In addition, such control becomes effective only to one dimension direction shown in FIG. 31. On the other hand, since one lamp corresponds to the both zones with respect to a tube axis direction of the straight-bulb halogen lamp (a direction perpendicular to the one dimension direction in FIG. 31), it is impossible to carry out zone control. Therefore, usually, in order to perform the zone control to the whole workpiece surface (namely, two dimension directions), the workpiece 506 is rotated, during a light emission in many cases. That is, when the workpiece is heated, using the light emission type heating apparatus disclosed in Japanese Laid Open Patent No. 62-20308, the zones which are set up on the workpiece, are concentrically divided.

When the workpiece 506 is rotated, in the predetermined area of the zone A thereof, there periodically exist a period when light from the lamp group LA for the zone A is mainly irradiated thereon by rotation of the workpiece 506, and a period when light from the lamp group LB for the zone B is mainly irradiated thereon. That is, a pulsed state of illuminance is averaged over the whole zone A. Therefore, when the workpiece is rotated, although illuminance will be averaged so that two dimensional zone control will be effectually performed, the accuracy of uniform temperature of the workpiece itself is low. Depending on cases, due to repetitions of a high illuminance period and a low illuminance period, the workpiece may be distorted.

On the other hand, such a semiconductor wafer may have a film made of metal oxide and nitride etc. by a sputtering method etc. on the surface thereof, and in general, an impurities additive is doped by ion implantation. A physical property of the semiconductor wafer surface varies, so that there is a local distribution of the semiconductor wafer. For example, as such a physical property, there are a surface state of the semiconductor wafer due to film formation, and density distribution of the impurities ion injected in an ion implantation process, etc.

Such distribution is not necessarily centrally symmetrical with respect to the center of the semiconductor wafer. Rather, in general, it is asymmetrical with respect to the center of the semiconductor wafer. If distribution of the surface state of the semiconductor wafer arises, the radiation rate (emmisivity or absorptivity) distribution of the semiconductor wafer surface will occur. The amount of light absorbed in the substance onto which light is emitted depends on the radiation rate of the substance. Therefore, for example, even if light is irradiated on the semiconductor wafer surface for heating, so that it may have uniform intensity distribution, the semiconductor wafer has local distribution in temperature. Therefore, although depending on cases, in case where the semiconductor wafer is heated to 1050 degree Celsius or more, a slip may occur in the semiconductor wafer.

As explained above, there are areas in the workpiece, where heating property/cooling property differ from one another. For example, when the workpiece is a wafer, since there is local distribution in the physical property of the semiconductor wafer surface, with respect to the shape of the semiconductor wafer in many cases, the wafer surface has specific distribution as to heating property/cooling property. Moreover, even when the physical property of the whole wafer surface is uniform, the edge portion of the wafer is affected by the thermal radiation from the side of the wafer, so that the heating property/cooling property in the central portion of the wafer and the edge portion of the wafer are differ from each other. Therefore, even if light is emitted on the wafer surface so that the illuminance on the whole wafer surface may become uniform, the temperature of the wafer does not become uniform. Therefore, in order to perform a heat treatment on the wafer by light emission while the temperature distribution of the wafer is maintained uniformly all over the wafer surface, it is necessary to adjust the illuminance on the areas of the surface of the wafer respectively, according to heating/cooling properties of these areas, which differ from one another.

The same is true even in the case where a guard ring is used so that a temperature fall of an edge portion of a workpiece (wafer) may be compensated. When the guard ring is used, the heat-capacity difference between the wafer and the guard ring should be taken into consideration, so that it is necessary to emit light with higher illuminance than that in the wafer area, to the guard ring area. That is, in the heat treatment of the workpiece by the light emission, the heating/cooling property of the workpiece should be taken into consideration, so that the workpiece surface is virtually divided into two or more zones (when using the guard ring, the guard ring surface is also included), and it is necessary to emit light with light intensity which is different from those in the zones. In addition, when the workpiece is heated, using the light emission type heating apparatus which is disclosed in Japanese Laid Open Patent No. S62-20308, the average illuminance distribution on the workpiece cannot set out except for the case of the concentric illuminance distribution. Therefore, for example, when the workpiece is a semiconductor wafer and distribution in the physical property of the semiconductor wafer surface, is uneven, in the light emission type heating apparatus which is disclosed in Japanese Laid Open Patent No. S62-20308, even if the workpiece is rotated, it is difficult to heat the workpiece uniformly.

(2) Use of Multi-Filament Lamp

The present inventors have proposed a light emission type heating apparatus which can realize a highly precise heat uniformity of the workpiece even when the physical property of the workpiece surface is asymmetrical with respect to the workpiece shape, or when the outer edge of the workpiece is surrounded by a guard ring. A lamp which is disclosed in Japanese Laid Open Patent No. 2006-279008 is used for the light emission type heating apparatus. As shown in FIG. 10 of Japanese Laid Open Patent No. 2006-279008, two or more filaments which are approximately arranged on the same axis along with the axial direction of the light emission bulb are arranged inside a light emission bulb of the lamp. These filaments are individually connected to the respective power supply apparatuses. Therefore, voltage supplied to the two or more filaments provided inside the light emission bulb can be controlled individually. A lamp having such a structure is hereafter referred to as a multi-filament lamp. A light emission type heating apparatus, which the present inventors have proposed, has light emission units, each of which is formed by arranging two or more multi-filament lamps in parallel.

According to the heating apparatus which has such a light emission unit, it is possible to precisely and arbitrarily set the illuminance distribution on the workpiece which is located apart from a lamp unit by only a predetermined distance. Therefore, it is possible to set up the illuminance distribution on the workpiece asymmetrically with respect to the workpiece shape. Thus, even in case where there is distribution in the workpiece, for example, a degree of a local temperature change is asymmetrical, it is possible to set up the illuminance distribution on the workpiece, according to the distribution, whereby it is possible to heat the workpiece uniformly. Moreover, when the workpiece is a semiconductor wafer, and a guard ring is used, it is possible to emit light, so that the illuminance on the guard ring may become higher than the illuminance on the semiconductor wafer.

Assuming that the physical property of the whole workpiece surface is uniform in order to facilitate understanding thereof, as disclosed in Japanese Laid Open Patent No. 2007-157780, the length and the number of filaments in the light emission unit which are formed by arranging two or more multi-filament lamps in parallel, is determined according to the irradiated area on the workpiece. For example, in an example shown in the FIG. 4 of Japanese Laid Open Patent No. 2007-157780, an irradiated area is divided into three zones, that is, a wafer area, a guard ring inner side area, and a guard ring outside area, wherein the length of two or more filaments arranged inside each multi-filament lamp which forms a light emission unit is set, according to each zone. Thus, voltage supplied to each set-up filament is controlled individually, whereby it is possible to emit light to each zone with arbitrary light intensity.

### SUMMARY

In recent years, with miniaturization of a semiconductor integrated circuit and high integration thereof, the circuit structure formed on a semiconductor wafer, in a depth direction of the semiconductor wafer, is shortened. That is, the film structuration of such a circuit is in progress. In order to shorten the gate length of an element, for example, formation of a shallow PN junction (formation of a shallow junction) with a low resistor is important. Moreover, thinning of a gate oxide film is required. A high temperature heating process in a process of forming a shallow PN junction with low resistor, i.e., a shallow impurity diffused layer, is carried out in an impurity ion activation process which follows an ion implantation process in which, for example, impurity (for example, boron (B), arsenic (As), etc.) ions are injected into a silicon substrate such as a semiconductor wafer. The attained temperature of the semiconductor wafer in this process is set to a temperature which exceeds 1000 degree Celsius. On the other hand, in an oxide film forming process (for example, a gate oxide film), a high temperature heating process is adopted. In case a silicon oxide film is formed, the attained temperature of the semiconductor wafer (silicon wafer) in the high temperature heating process is set up to 900 degree Celsius or more. As described above, in the high temperature heat treatment, in addition to the highly precise temperature uniformity of the workpiece at the time of heating, which is required in the prior art, speeding up of the workpiece temperature rising rate is required.

In the impurity ion activation processing in the case of forming a shallow impurity diffused layer, since the attained temperature of the semiconductor wafer in the heat treatment process is a high temperature which exceeds 1000 degree Celsius, the heat diffusion speed of impurities increases. Therefore, when the semiconductor wafer, which is a workpiece, is high in temperature for a long time, undesired impurity ion diffusion occurs in the depth direction of the semiconductor wafer, so that it becomes difficult to form the shallow PN junction with a low resistor. Therefore, in order to avoid such a problem in the high temperature heating process, a rapid heating/cooling process called a spike anneal is adopted. In the spike anneal, the temperature is not maintained at a constant value, but it will be cooled down, as soon as it reaches the target temperature (temperature required for activation). Thereby, a period in which the semiconductor wafer is high in temperature, is shortened as much as possible, whereby an advance of undesired impurity ion diffusion is suppressed. That is, in the impurity ion activation processing in the case of forming a shallow impurity diffused layer, in order to make the temperature of the workpiece, such as a semiconductor wafer, reach the target temperature for a short time, speeding up of the temperature rise of the workpiece is called for.

On the other hand, in the high temperature heat treatment of the oxide film forming process, there are three stages, that is, a workpiece temperature raising period, a constant temperature holding period, and a temperature lowering period. In case where a silicon oxide film is formed, if the temperature of the semiconductor wafer (silicon wafer) exceeds 900 degree Celsius, an oxidation rate exponentially increases. As thinning of the oxide film is in progress, there is a tendency that a period of the high temperature heat process is shortened according to the progress, and especially a constant temperature holding period is mainly shortened. In other words, in a high temperature heat treatment, a percentage of a period in which a temperature is rising and decreasing, relatively increases. In general, in the temperature control, constant temperature control is more precise than temperature raising control and temperature lowering control. Moreover, in general, the film quality of an oxide film is better at a high temperature. Therefore, in a period during which the workpiece is high in temperature such as 900 degree Celsius or more, film thickness control becomes highly precise by shortening a temperature raising control period, thereby increasing the percentage of the constant temperature control which is accurate. Moreover, by shortening a period during which the temperature of the workpiece (which is 900 degree Celsius or more) is not so high, as much as possible, it is possible to obtain the oxide film with a good film quality. Due to such demands, speeding up of a workpiece temperature rise is required in the oxide film forming process.

Moreover, in the process of forming a shallow impurity diffused layer, it is necessary to set up distribution of an impurity diffused layer with a high precision. Therefore, more accurate uniformity of the workpiece temperature may be demanded. Similarly, in the oxide film forming process (for example, a gate oxide film), a higher accuracy of uniformity of the workpiece temperature is demanded so that an oxide film thickness may have a desired distribution. In summary, in a manufacturing process of a semiconductor integrated circuit, such as a formation of a shallow junction and thinning of a gate oxide film, much higher temperature rising speed in the high temperature heating process is required. Moreover, due to the miniaturization and high performance of a semiconductor device, the highly precise uniformity in temperature of the workpiece is required in the high temperature heating process.

In order to meet both demands, that is, speeding up of the temperature rising speed in such a high temperature heating process and highly precise uniformity in temperature of the workpiece, conditions which are required for a light emission type heating apparatus, are set forth below.

Illuminance Increase on Workpiece Capable of Responding to High speed Temperature Rise

Generally, temperature rising speed has the relation set forth below. Temperature rising speed (S)=(Electric power applied to a filament (P)−Quantity of heat loss due to radiation from a workpiece (Q))/Heat Capacity of the workpiece (HC). That is, (S)=(P−Q)/(HC). The temperature of the workpiece can be raised at a high speed by applying large electric power to the filament of the filament lamp which is a light emitting member.

(2) High speed Response of Illuminance Control on Workpiece Capable of Responding to Highly Precise Uniformity Control of Workpiece Temperature

In order to control uniformity of the workpiece temperature highly precisely, it is desirable to suppress poor control, such as overshooting and undershooting, as much as possible in workpiece temperature control. Therefore, it is necessary to control the illuminance on the workpiece at a high speed. That is, as a result of the applied power control to the filament lamp, it is desirable for the light intensity emitted from the filament of the filament lamp to reach a predetermined value at a high speed (realization of a high speed response of the filament lamp).

(3) Local Illuminance Control for Highly Precise Uniformity of Temperature.

In order to make the temperature of the workpiece uniform all over the workpiece, it is desirable for the illuminance to be locally controlled on the light irradiation face of the workpiece.

According to the present light emission type heating apparatus using the multi-filament lamp which has been proposed by the present inventors, it is possible to precisely and arbitrarily set illuminance distribution on the workpiece which is apart from the lamp unit by only a predetermined distance. That is, the above mentioned condition (3), that is, the local illuminance control with highly precise uniformity in temperature is realized by using the light emission type heating apparatus which uses the multi-filament lamp(s).

In order to enable the large electric power application (corresponding to the above mentioned condition (1)) to the filament of the filament lamp which is a light emitting member, it is necessary to increase the diameter of the filament line. However, if the diameter of the filament line of the filament is increased, the heat capacity of the filament will increase. On the other hand, in order to realize a high speed response (corresponding to the above mentioned condition (2)) of the filament lamp, it is necessary to make the heat capacity of the filament as small as possible. When the heat capacity of the filament is large, even if power applied to the filament is rapidly changed at a high speed, change of the temperature of the filament (namely, change of the light intensity emitted from the filament) becomes slow by only part whose heat capacity is larger. Consequently, in the workpiece temperature control, it tends to cause poor control, such as overshooting and undershooting.

As described above, in the light emission type heating apparatus using a filament lamp, there is trade-off relationship between (1) the filament conditions for a workpiece temperature rise at a high speed and (2) the filament conditions for a high speed response of illuminance control, and it is difficult to reconcile both. Therefore, in order to reconcile (1) a workpiece temperature rise at a high speed and (2) a high speed response of illuminance control, it is necessary to set as set forth below. That is, in a light emission unit in which two or more straight-bulb filament lamps as shown in FIG. 30 are arranged in parallel, the heat capacity of the filament of each filament lamp is set so as to be small. Under such conditions, as described above, although “(2) a high speed response of illuminance control” can be realized but “high temperature rise of the workpiece at a high speed” cannot be realized.

Therefore, in order to realize the above mentioned condition “(1) a workpiece temperature rise at a high speed”, each of two or more light emission units (LU1, LU2, . . . , LUn) in the light emission type heating apparatus, comprises filament lamps 501. Each lamp has a filament whose heat capacity is set up to be small. The two or more light emission units are in parallel piled up (has two layer structure) at predetermined intervals. In such a structure, the total electric power applied to the light emission units becomes large. As a result, the illuminance on the workpiece can be increased so that the temperature rising speed in the workpiece may be increased. However, when adopting such a structure in which the two or more light emission units are piled up at a predetermined interval, the total thickness of the light emission units becomes large as a whole in the spatially piled direction. Therefore, the light emission unit LUn which faces the workpiece becomes far from a reflective mirror. Therefore, the directivity of light which is emitted from LUn and reflected by a reflective mirror becomes small, so that the light is diffused. Therefore, it becomes difficult to carry out the condition (3), that is, “local illuminance control”.

In order to perform the above mentioned condition (3), that is, “local illuminance control” well, substantially, the maximum number of the piled layers of the light emission units is two (layers). In a multilayer structure having more than two layers, a local controllability will be lost. On the other hand, since the heat capacity of the filaments of the lamps which form each light emission unit is set to be small when the number of piled up layers of the light emission unit is two (layers), the total electric power which can be applied to the light emission unit cannot be large. Therefore, it is difficult to realize the condition (1), that is, “high temperature rising at high speed”.

As described above, in the conventional light emission type heating apparatus, even if a multi-filament lamp(s) is adopted, it is very difficult to realize all of the conditions, that is, (1) high temperature rise at a high speed, (2) a high speed response of illuminance control, and (3) good local illuminance control. In view of the above problems, in the present invention, it is an object of the present invention to offer a light emission type heating method and light emission type heating apparatus capable of satisfying all of the conditions (1)-(3), that is, “a workpiece temperature rise at a high speed”, “a high speed response of illuminance control”, and “good local illuminance control.”

FIG. 1 is a diagram showing the schematic structure of a light emission type heating apparatus according to the present invention. A light emission unit in the light emission type heating apparatus shown in FIG. 1, has a structure in which two sets of lamp units (LU1, LU2) formed by arranging, in parallel, two or more straight-bulb filament lamps overlap each other at a predetermined interval. A reflecting mirror 2 is provided in an upper part of the lamp unit (LU2) which is arranged in an upper layer side. In an example shown in FIG. 1, a wave-shaped mirror is used as the reflecting mirror 2. In addition, the reflecting mirror 2 is not limited to the wave-shaped mirror, and may be a plane mirror. In FIG. 1, a workpiece 6 is shown as an example of a semiconductor wafer 600. Furthermore, a guard ring 5 is provided so as to surround an outer edge of the workpiece 6. The workpiece 6 and the guard ring 5 are arranged in a processing chamber S2. Light emitted from each of the filament lamps L1 and L2 which form the lamp units (light emission units) LU1 and LU2, is emitted onto the workpiece 6 and the guard ring 5 through a light transmission window member 4 for light transmission which is provided in the processing chamber S2.

The present light emission type heating apparatus differs from that of the prior art, in that the filament lamps L1 which form the lamp unit LU1, and the filament lamps L2 which form the lamp unit LU2, are respectively formed as set forth below. The diameter of a filament line of each filament lamp L2 is made large, so that the large electric power can be applied to the filament lamps L2. That is, if the lamp unit LU2 is used, “(1) a workpiece temperature rise at a high speed” become possible. On the other hand, the diameter of a filament of each filament lamp L1 is small so that the heat capacity of the filaments may become as small as possible, whereby the high speed response of the filament lamp L1 is attained. Moreover, it is possible to locally increase and decrease the intensity of light by using multi-filament lamps for some of the two or more filament lamps L1. That is, if the lamp unit LU1 is used, “(2) a high speed response of illuminance control” and “(3) Good local illuminance control” will become possible.

The light emission type heating apparatus according to the present invention is formed so that large electric power can be applied thereto, and further light emission unit comprises the lamp unit LU2 capable of “(1) a workpiece temperature rise at a high speed” and the lamp unit LU1 capable of (2) a high speed response of illuminance control” and “(3) good local illuminance control”. Thus, different roles are respectively assigned to the two lamp units LU1 and LU2, and furthermore, by appropriately controlling lighting of the two lamp units LU1 and LU2 in the light emission type heating apparatus according to the present invention, all of the conditions (1) a workpiece temperature rise at a high speed, (2) a high speed response of illuminance control, and (3) a good local illuminance control become possible.

Here, since the multi-filament lamps are used as the lamps L1 which form the lamp unit LU1, a filament provided in a certain lamp and filaments provided in other lamps are in block formed, so as to form two or more groups, and further these filament groups are respectively controlled as a unit in block according to a signal sent from an electric power control unit, electric power supply to the filaments of the lamp unit LU1 can be efficiently controlled with a comparatively simple structure. Moreover, the temperature of the workpiece is detected and electric power applied to the grouped two or more filaments which form the lamp unit LU1 is controlled in a feedback manner based on the detected temperature of the workpiece, so that the temperature of the workpiece can precisely controlled. Furthermore, sensors which correspond to irradiated areas of the lamps L1 of each group, are provided so as to detect the temperature of the workpiece 6, and power applied to the filament of each lamp belonging to each group is in block controlled in a feedback manner based on the workpiece temperature detected by each sensor, so that it can be more accurately controlled. In addition, depending on arrangement of these lamps etc., an illuminance at the central part of the workpiece may become large so that an illuminance distribution curve thereof may become a spike form. In such a case, a central part of at least some lamps of the lamps L2 which form the lamp unit LU2, does not emit light or an illuminance becomes low. Thus, illuminance distribution may be improved.

Next, the light emission type heating method (hereinafter referred to as a heating method) according to the present invention will be briefly described below. The heating method according to the present invention is performed, using the light emission type heating apparatus having the structure which is schematically shown in FIG. 1. FIG. 2 schematically shows relation between the workpiece temperature and light irradiation time in a general high temperature heat treatment. Here, as an example, a high temperature heat treatment which mainly comprises a step of raising the workpiece temperature, a step of maintaining constant temperature, and a step of lowering the temperature, will be described below.

(A) Temperature Rising Period

As described above, a temperature rising speed has a relation set forth below. Temperature Rising Speed=(Quantity of Heat Loss Due to Radiation from Workpiece−Quantity of Heat Loss Due to Radiation from Workpiece)/Heat Capacity of the Workpiece.

Here, the heat capacity of the workpiece stays constant, and the quantity of heat loss due to radiation from the workpiece is smaller than electric power applied to the filaments of all the lamps of the light emission unit. Therefore, the dominant parameter which determines the temperature rising speed, is the electric power applied to the filaments of all the filament lamps. In case where a semiconductor wafer (silicon wafer) with a diameter of 300 mm is heated, in order that the temperature may rise at a speed of 250 degree Celsius per second, approximately 250 kW, is needed for the total electric power applied to the filaments of all the lamps.

It is necessary to raise the temperature in a temperature raising period, while maintaining the temperature distribution of the entire workpiece surface (semiconductor wafer surface) uniformly. In order to realize the uniformity of the workpiece temperature in the temperature raising period, as described above, the difference of the heat capacity of the workpiece and that of the guard ring is taken into consideration, and local illuminance control is performed, so that the illuminance on the guard ring may become larger than that on the workpiece. Moreover, in order to deal with temperature variation resulting from manufacturing variation of the filament lamps and variation in the surface state of the guard ring, local illuminance control is performed. That is, the local illuminance control for correction of the temperature distribution of the workpiece or correction for the temperature thereof (compensation of a deviation between a target temperature and an actually measured temperature at a feedback point which corresponds to the workpiece temperature measuring point) is performed. From experiments of the present inventors, it turned out that electric power which is needed for the adjustment of the temperature distribution of the workpiece performed by such local illuminance control, and which is applied to the filaments, is approximately 20% of the total electric power applied to the filaments needed in the temperature raising period. That is, electric power (which is not power applied in a uniform workpiece temperature control but) which is applied to the filaments and which is simply needed to raise the workpiece temperature, becomes approximately 80% of the total electric power applied to the filaments needed in the temperature raising period.

Base on the above finding, the present inventors found that if a light emission unit comprises the lamp unit LU2 which consumes 80% of the total electric power applied in the temperature raising period to the filaments which mainly take charge of the raising of the workpiece temperature, and the lamp unit LU1 which consumes 20% of the total electric power needed in the temperature raising period and applied to the filaments which mainly takes charge of regulation of the temperature distribution of the workpiece, it is possible to meet the conditions of (1) the workpiece temperature rise at a high speed, (2) the high speed response of illuminance control, and (3) good local illuminance control. That is, when electric power which can be applied to the lamp unit LU1 is set to A1, and electric power which can be applied to the lamp unit LU2 is set to A2, if these lamp units LU1 and LU2 are formed so that A1/(A1+A2) is approximately 0.2, the above conditions (1)-(3) can be satisfied. When variation of the shape of the apparatus, variation of the distance between the lamps and the workpiece, variation of the heat capacity of the workpiece or the guard ring etc. is taken into consideration, if a value of A1/(A1+A2) falls within a range of 0.1-0.4, these conditions can be filled. In addition, since the electric power which can be applied to the lamp units LU1 and LU2 can also be considered to be the total of the rated power of the lamps which belong to the respective lamp units, the total of the rated power of the lamps which belong to the lamp unit LU1 may be represented as A1, and the total of the rated power of the lamps belonging to the lamp unit LU2 may be represented as A2.

Since the lamp unit LU1 consumes approximately 20% of the total electric power applied to the filaments needed in the temperature raising period, it is possible to make small the diameter of the filament line of the lamps L1. Therefore, the high speed response of the illuminance control can be realized by the filament lamp L1. Moreover, at least as some of the two or more filament lamps L1, a multi-filament lamp(s) is adopted, so that local illuminance can be controlled well. That is, the local illuminance control capable of responding at a high speed is possible by using the lamp unit LU1. On the other hand, since the lamp unit LU2 mainly takes charge of raising the temperature of the workpiece, and is not related to regulation of the temperature distribution of the workpiece, a high speed response is not required for the filament lamps L2. Therefore, it is possible to increase the diameter of the filament line. Thus, it is possible to form the filaments so that approximately 80% of the total electric power applied to the filaments, which is needed in the temperature raising period, can be applied thereto. In the above example, the electric power applied to the lamp unit LU1 is approximately 50 kW (250 kW×20%=50 kW), so that the electric power applied to the lamp unit LU2 comes to approximately 200 kW (250 kW×80%=200 kW). Moreover, taking into consideration ratio delay (for example, 10%), the rated power of the electric power applied to the lamp unit LU2 is set to 220 kW (200 kW×110%=220 kW).

In sum, the lamp units LU1 and LU2 are lighted during (A) the temperature raising period as set forth below.

(i) When electric power applied to the lamp unit LU1 (the group of filament lamps L1 which includes a multi-filament lamp) in a temperature raising period is represented as A1, and power applied to the lamp unit LU2 (the group of single filament lamps L2) is represented as A2, they are lighted under condition of A1<A2 (A1≠0, A2≠0).

(ii) Based on the temperature signal from a monitor for the temperature of the workpiece 6, which is not shown in FIG. 1, the lamp unit LU1 is controlled in a feedback manner so that the temperature of the whole workpiece surface may become uniform.

(iii) The lamp unit LU2, which is only used for raising the temperature of the workpiece, is lighted in a predetermined electric power pattern (a preset program).

That is, it is possible to meet the conditions of (1) a temperature rise at a high speed, (2) a high speed response of illuminance control, and (3) good local illuminance control, at time of a temperature rise, by lighting the lamp unit LU1 which is capable of a high speed response, and which is made up of a group of the filament lamps L1 including the multi-filament lamps, and the lamp unit LU2, to which a large electric power can be applied and which is made up of a group of the single filament lamps L2, in the manner ((i), (ii) and (iii)) which are described above. In addition, if both lighting of the lamp unit LU1 and that of the lamp unit LU2, is controlled in a feedback manner, they may interfere with each other, so that there is a possibility that the temperature may not be stabilized (may not converge). Therefore, if lighting of the lamp unit LU2 is controlled according to the preset program, and lighting of the lamp unit LU1 is controlled in a feedback manner, it is possible to carry out a temperature control without such interference.

(B) Constant Temperature Holding Period

The constant temperature holding period (B) is a period in which the workpiece temperature which has reached through the temperature raising period (A) is held constant for a certain period. The electric power applied to the filaments of all the filament lamps of the light emission unit may be smaller than the electric power applied in the temperature raising period (A). When the temperature of the semiconductor wafer (silicon wafer) with a diameter of 300 mm is controlled so as to be constant at 1150 degree Celsius, in case where attention is paid only to holding of the temperature, the required electric power which is applied to the filaments of all the lamps of the light emission unit may be approximately 30 kW. In fact, as well as the temperature raising period (A), when controlling the temperature of the wafer so as to be constant, in order to perform correction of the temperature distribution of the workpiece, or a temperature correction (compensation of the deviation between a target temperature and a measured temperature in a feedback point corresponding to a temperature measuring point of the workpiece), control of local illuminance is carried out.

It was found by inventors' experiment that electric power applied to the filaments, which is needed for regulation of the temperature distribution of the workpiece performed by such local illuminance control, is approximately 20% of the total electric power applied to the filament in order to maintain the temperature. In the above example, the electric power applied to the filament of the lamp needed for local illuminance control is set to approximately 6 kW (6 kW=30 kW×20%). Therefore, in the above example, the electric power applied to the filament of all the lamps of the light emission unit, which is needed for the constant temperature control of the workpiece (semiconductor wafer) in the constant temperature holding period (B), is approximately 36 kW.

Based on the above knowledge, it turns out that regulation of the temperature distribution of the workpiece performed by local illuminance control can be carried out, in the constant temperature holding period (B), by only the lamp unit LU1. That is, in the constant temperature holding period (B), a value of the electric power applied to the filaments of all the lamps of the light emission unit needed to hold the temperature and to perform local illuminance control, is sufficiently smaller than that in the temperature raising period (A). Therefore, not only the temperature of the workpiece can be maintained, but also the temperature distribution of the workpiece can be regulated, by using the lamp unit LU1. Since the filament lamps with specification in which the high speed response of illuminance control is possible, are used for the filament lamps L1 which form the lamp unit LU1, it is possible to perform the local illuminance control capable of a high speed response by using the lamp unit LU1.

In sum, the lamp units LU1 and LU2 are lighted in the constant temperature holding period (B) as forth below.

(i) When power applied to the lamp unit LU1 (a group of filament lamps L1 including the multi-filament lamps) in the constant temperature holding period is represented as B1 and power applied to the lamp unit LU2 (a group of single filament lamps L2) therein is represented as B2, in case of B2=0 and B1≠0, the lamp unit LU1 is lighted and the lamp unit LU2 turned off. In addition, the lamp unit LU2 may not be turned off, depending on conditions, and may be lighted very slightly. In this case, the relation between B1 and B2 is B1>B2 (B1≠0, B2≠0).

(ii) Based on the temperature signal from a monitor for the temperature of the workpiece, which is not shown in FIG. 1, the lamp unit LU1 is controlled in a feedback manner so that the temperature of the whole workpiece surface may become uniform.

(iii) Since the lamp unit LU2 does not contribute to local illuminance control when the lamp unit LU2 is lighted, the lamp unit LU2 is lighted in a predetermined electric power pattern (preset program).

That is, it is possible to meet the conditions of (2) a high speed response of illuminance control, and (3) good local illuminance control, in the constant temperature holding period, by lighting the lamp unit LU1 which is capable of a high speed response, and which is made up of a group of the filament lamps L1 including the multi-filament lamps, and the lamp unit LU2, to which a large electric power can be applied and which is made up of a group of the single filament lamps L2, in the manner ((i), (ii) and (iii)) which is described above. In addition, if both lighting of the lamp unit LU1 and that of the lamp unit LU2, is controlled in a feedback manner, they may interfere with each other, so that there is a possibility that the temperature may not be stabilized (may not converge). Therefore, if lighting of the lamp unit LU2 is controlled according to the preset program, and lighting of the lamp unit LU1 is controlled in a feedback manner, it is possible to carry out a temperature control without such interference.

In addition, by comparing the electric power applied to the lamp unit LU1 during the temperature raising period (A) and the electric power applied to the lamp unit LU1 during the constant temperature holding period (B) with each other, rated power of the electric power applied to the lamp unit LU1, may be adjusted so as to be the larger one. In the above example, since the electric power applied to the lamp unit LU1 during the temperature raising period (A) is approximately 50 kW (250 kW×20%=50 KW) and the electric power applied to the lamp unit LU1 during the constant temperature holding period (B) is approximately 36 kW, the rated power of the electric power applied to the lamp unit LU1 is set to 50 kW.

(C) Temperature Lowering Period

Since it is necessary to lower the temperature of the workpiece as soon as possible in a temperature lowering period (C), the both the lamp unit LU1 and the lamp unit LU2 are turned off.

As described above, the heating method using the light emission type heating apparatus according to the present invention is capable of high speed response as a light emission unit, and the light emission type heating apparatus comprises the lamp unit LU1 which is made up of a group of filament lamps L1 including the multi-filament lamps, and the lamp unit LU2 which is made up of a group of single filaments L2 to which a large electric power can be applied, wherein in the temperature raising period (A), the lamps are simultaneously lighted under the condition where (i) [power A1 applied to the lamp unit LU1]<[power A2 applied to the lamp unit LU2 (A1≠0, A2≠0)], and in the constant temperature holding period (B), (i)′ only the lamp unit LU1 is lighted with power B1 (B1≠0), or both lamps are lighted under condition where [the power B1 applied to the lamp unit LU1]>[the power B2 applied to the lamp unit LU2], and further in the temperature lowering period (C) both lamps are turned off. Therefore, in the high temperature heat treatment which mainly comprises three steps, that is a step of raising the temperature of the workpiece, a step of maintaining a constant temperature, and a step of lowering the temperature, it is possible to meet all the conditions of (1) a temperature rise at a high speed, (2) a high speed response of illuminance control, and (3) good local illuminance control.

In addition, when in the temperature raising period, the power A2 is applied to the lamp unit LU2, and the power A1 is applied to the lamp unit LU1, and in a constant temperature holding period, the power B2 is applied to the lamp unit LU2 and the power B1 is applied to the lamp unit LU1, the relation of A1, A2, B1, and B2 may be described as (A2/A1)>(B2/B1), wherein A1≠0, A2≠0, and B1≠0. As described above, (ii) the lamp unit LU1 is controlled in a feedback manner, based on a temperature signal from the monitor for the temperature of the workpiece, which is not shown in FIG. 1, so that the temperature of the whole workpiece surface may become uniform, and (iii) it is possible to carry out temperature control without interference by lighting the lamp unit LU2 in the predetermined electric power pattern (preset program).

FIG. 3 schematically shows a relation between the temperature of a workpiece and light irradiation time, in a high temperature heat treatment for a spike anneal. The high temperature heat treatment in the case of a spike anneal mainly comprises a stage of raising the temperature of a workpiece, and a stage of lowering the temperature. In this case, mainly, in each of the lamp units LU1 and LU2, lighting control is carried out in a temperature raising period (A) which is described above, and then the lamps may be turned off in a temperature lowering period (C). A light emission unit capable of a high speed response comprises a lamp unit LU1 which is made up of a group of filament lamps L1 including the multi-filament lamps, and a lamp unit LU2 which is made up of a group of single filaments L2 to which a large electric power can be applied.

Furthermore, in a heating method, during the temperature raising period (A), (i) the lamps are lighted at the same time under condition of [power A1 applied to the lamp unit LU1]<[power A2 applied to the lamp unit LU2], wherein A1≠0 and A2≠0. The high temperature heat treatment mainly comprises a stage of raising the temperature of a workpiece, and a stage of lowering temperature thereof, whereby it is possible to meet all the conditions of (1) a workpiece temperature rise at a high speed, (2) a high speed response of illuminance control, and (3) good local illuminance control. As described above, (ii) the lamp unit LU1 is controlled in a feedback manner based on a temperature signal from a monitor for the temperature of the workpiece, which is not shown in FIG. 1, so that the temperature of the whole workpiece surface may become uniform, and (iii) the lamp unit LU2 is lighted in a predetermined control pattern (preset program), whereby it is possible to carry out temperature control without an interference.

In view of the above, according to the present invention, the above-mentioned problems are solved as set forth below.

In a light emission type heating method in which a workpiece is heated according to a predetermined heating pattern, using a light emission type heating apparatus, comprising a first lamp unit which includes two or more straight-bulb lamps, in which at least one of the lamps includes two or more filaments in its light emission bulb, and intensity of light emitted from each filament can be independently controlled, and a second lamp unit which is made up of two or more straight-bulb lamps, each of which has a filament. The two or more straight-bulb lamps of the first lamp unit are grouped, in each of which a filament of at least one of the lamps and a filament of another one of the lamps are arranged so as to form a group, whereby as a whole, two or more groups of filaments are formed. The lamp emission type heating method comprising a step of detecting a temperature of the workpiece, and a step of controlling electric power to be applied to each of the groups of filaments which form the first lamp unit, based on the detected temperature of the workpiece.

(2) In the light emission type heating method, a heat capacity of each filament in each of the lamps which form the first lamp unit is smaller than that of the filament in each of the lamps which form the second lamp unit, electric power to be individually applied to the each group of the filaments of the lamps which form the first lamp unit, may be controlled so that a temperature of a workpiece surface becomes approximately uniform, and electric power to be applied to the filaments of the lamps which form a second lamp unit may be controlled in a predetermined heating pattern.

(3) In the light emission type heating method, in the step of detecting the temperature of the workpiece, the temperature of the workpiece may be detected as to each group, and electric power to be applied to the filaments of the lamps belonging to each group may be controlled in block.

(4) In the light emission type heating method, the predetermined heating pattern may include a workpiece temperature raising period, and a relation of a total electric power A1 to be applied to the filaments of the lamps forming the first lamp unit in the workpiece temperature raising period, and a total electric power A2 to be applied to the filaments of the lamps forming the second lamp unit in the workpiece temperature raising period is 0.1≦A1/(A1+A2)≦0.4.

(5) A light emission type heating treatment apparatus for heating a workpiece according to a predetermined heating pattern by emitting light, has a first lamp unit including two or more of straight-bulb lamps, wherein at least one of the lamps has two or more filaments arranged in an axis direction of its light emission bulb, and the two or more filaments are connected to respective lead wires from which electric power is applied to the two or more filaments, and a second lamp unit including two or more straight tube type lamps, wherein the first lamp unit and the second lamp unit form a two layer structure, and the first lamp unit is provided so as to directly face the workpiece. The light emission type heating treatment apparatus has a first driving section which applies electric power to the filaments of the two or more lamps which form the first lamp unit, a second driving section which applies electric power to filaments of the two or more lamps which form the second lamp unit, a first electric power controller which controls the first driving section, a second electric power controller which controls the second driving section, and a temperature sensor which detects a temperature of the workpiece, wherein the filaments of the lamps which form the first lamp unit are divided into two or more groups, in each of which a filament of at least one of the lamps and a filament of another lamp are formed so as to be a group, wherein the first electric power controller is provided for each of the two or more groups, and wherein the first electric power controller controls the first driving section based on the detected temperature of the workpiece by the temperature sensor.

(6) In the light emission type heating treatment apparatus, a heat capacity of the filament of each of the lamps which form the first lamp unit is smaller than that of the filament of each of the lamps which form the second lamp unit, wherein a predetermined electric power supply control pattern is set in the second electric power controller, wherein the second electric power controller controls the second driving section based on the predetermined electric power supply control pattern.

(7) In the light emission type heating treatment apparatus, the temperature sensor may be provided at a position corresponding to each group, in which the first electric power controller which is provided for each group, controls the first driving section for each group in block, based on the detected temperature of the workpiece detected by each temperature sensor.

(8) In the light emission type heating treatment apparatus, the first electric power controller and the second electric power controller may control the first driving section and the second driving section, respectively, according to a predetermined heating patter which includes a period during which the workpiece temperature is raised to a predetermined temperature, so that a relation of a total electric power A1 to be applied to the filaments of the lamps forming the first lamp unit in the workpiece temperature raising period, and a total electric power A2 to be applied to the filaments of the lamps forming the second lamp unit in the workpiece temperature raising period is 0.1≦A1/(A1+A2)≦0.4.

(9) In the light emission type heating treatment apparatus, at least one of the lamps which form the second lamp unit may have a center portion where light is not emitted therefrom or light intensity thereof is lower than other portions.

The effects set forth below can be acquired in the present invention.

The first lamp unit includes two or more straight-bulb lamps, in which at least one of the lamps includes two or more filaments in its light emission bulb, and intensity of light emitted from each filament can be independently controlled, and a second lamp unit is made up of two or more straight-bulb lamps, each of which has a filament. Since the first lamp unit mainly takes charge of regulation of the temperature distribution of a workpiece, and the second lamp unit mainly takes charge of the raising temperature of the workpiece, it is possible to meet the conditions of (1) a workpiece temperature rise at a high speed, (2) a high speed response of illuminance control, and (3) good local illuminance control.

(2) Two or more groups of filaments of the lamps are formed, in each of which a filament provided in a certain lamp and a filament provided in another lamp are in block formed, so as to form a group, wherein the temperature of the workpiece is detected, and then, based on the detected temperature of the workpiece, power applied to the filaments of each of the two or more groups which form the first lamp unit is controlled, whereby electric power supply control of the filaments of the lamp unit LU1 can be performed efficiently with a relatively simple structure, and the temperature of the workpiece can be controlled with sufficient accuracy.

(3) The heat capacity of the filament of each of the lamps which form the first lamp unit is smaller than that of the filament of each of the lamps which form the second lamp unit, so that a high speed response of the first lamp unit is attained, and the large electric power can be applied to the second lamp unit.

(4) The workpiece temperature for each group is detected, and, based on the detected temperature of the workpiece, power applied to the filaments of the lamps belonging to each group is in block controlled for every group, so that more highly precise temperature control is attained.

(5) When a total electric power to be applied to the filaments of the lamps forming the first lamp unit in the workpiece temperature raising period, is represented as A1 and a total electric power to be applied to the filaments of the lamps forming the second lamp unit in the workpiece temperature raising period is represented as A2, the lamps are formed so as to satisfy a relation of 0.1≦A1/(A1+A2)≦0.4, whereby it is possible to realize (1) a workpiece temperature rise at a high speed, (2) a high speed response of illuminance control, and (3) good local illuminance control.

(6) If at least one of the lamps which form the second lamp unit has a center portion where light is not emitted therefrom or light intensity thereof is lower than other portions, it is possible to uniformize illuminance distribution even if applied power becomes large.

### BRIEF DESCRIPTION OF THE DRAWINGS

Other features and advantages of the present light emitting type heating method and light emitting type heating apparatus will be apparent from the ensuing description, taken in conjunction with the accompanying drawings, in which:

FIG. 1 is a diagram showing the schematic structure of a light emitting type heating apparatus according to the present invention;

FIG. 2 is a diagram schematically showing the relation between the temperature of a workpiece and light irradiation time in a general high temperature heat treatment;

FIG. 3 schematically shows a relation between the temperature of a workpiece and light irradiation time in a high temperature heat treatment for a spike anneal;

FIG. 4 is an explanatory diagram showing the structure of a light emitting type heating apparatus according to the present invention;

FIG. 5 is a diagram showing an example of the detailed structure of a multi-filament lamp;

FIG. 6 is a control block diagram of a light emitting type heating apparatus according to the present invention;

FIG. 7 is a diagram showing an example of zone division in an irradiated area on the workpiece, and an example of the structure and arrangement of a lamp unit LU1;

FIG. 8 is a diagram showing an example of the structure and arrangement of a lamp unit LU2;

FIGS. 9A and 9B are diagrams showing an example of the structure and arrangement of lamp units LU1 and LU2 and a wafer;

FIGS. 10A, 10B, 10C, and 10D are diagrams showing an irradiance distribution on a wafer when changing the distance between a unit comprising the lamp units LU1 and LU2, and a wafer;

FIGS. 11A and 11B are diagrams showing an arrangement of a lamp L2 in which light is not emitted from a central part thereof, and lamps L2 in a lamp unit LU2;

FIG. 12 is a diagram showing the structure of a first power supply section in a light emitting type heating apparatus according to the present invention;

FIG. 13 is a diagram showing an example of detailed structure of a drive section which drives lamps L1 of a lamp unit LU1;

FIG. 14 is a diagram showing the structure of a second power supply section in a light emitting type heating apparatus according to the present invention;

FIG. 15 is a diagram showing the detailed structure of the drive section which drives lamps L2 of a lamp unit LU2;

FIG. 16 is a configuration diagram of a first power supply section, for explaining a workpiece heat treatment process;

FIG. 17 is a diagram showing an example of temperature change of the workpiece at time of heat treatment, and applied power;

FIG. 18 is a diagram in which electric power applied to a lamp unit LU1 is compared with that applied to a lamp unit LU2, in the temperature raising period and a temperature holding period, and a temperature lowering period of FIG. 17;

FIGS. 19A-19D show a flow chart (1) of a procedure of heat treatment of a workpiece;

FIGS. 20A-20D show a flow chart (2) of a procedure of heat treatment of a workpiece;

FIGS. 21A and 21B show a flow chart (3) of a procedure of heat treatment of a workpiece;

FIG. 22 is a diagram showing temperature change of a workpiece at time of the heat treatment for a spike anneal process, and an example of applied power;

FIG. 23 is a diagram in which electric power applied to a lamp unit LU1 is compared with that applied to a lamp unit LU2 in a temperature raising period and a temperature lowering period of FIG. 22;

FIGS. 24A-24D show a flow chart (1) of a procedure of heat treatment of a workpiece for a spike anneal process;

FIGS. 25A-25D show a flow chart (2) of a procedure of heat treatment of a workpiece for a spike anneal process;

FIG. 26 is a flow chart (3) which shows a procedure of heat treatment of a workpiece for a spike anneal process;

FIG. 27 is a diagram showing an example of the structure of a first power supply section in case of performing electric power control supplied to a first lamp unit LU1 based on a predetermined control pattern;

FIG. 28 is a diagram showing a temperature change of a workpiece at time of the heat treatment in case of performing electric power control based on a predetermined regular control pattern, and an example of applied power;

FIG. 29 is a diagram in which electric power applied to a lamp unit LU1 is compared with that applied to a lamp unit LU2 in a temperature raising period, a temperature holding period, and a temperature lowering period of FIG. 28;

FIG. 30 is a diagram showing the schematic structure of a light emitting type heating apparatus of prior art;

FIG. 31 is a diagram showing an arrangement of lamps and a workpiece in a light emitting type heating apparatus of prior art; and

FIG. 32 is a diagram showing an example of a two or more layer structure of light emission unit in which filament lamps are arranged in parallel in a light emitting type heating apparatus.

### DETAILED DESCRIPTION

A description of embodiments of the present light emission type heating method and light emission type heating apparatus will now be given below, referring to drawings. While the claims are not limited to such embodiments, an appreciation of various aspects of the present incandescent lamp apparatus and the heating apparatus are best gained through a discussion of various examples thereof.

Hereafter, a light emission type heating apparatus (hereinafter referred to as a heating apparatus) according to the present invention will be described below.

### (1) Configuration Example of Light Emission Type Heating Apparatus

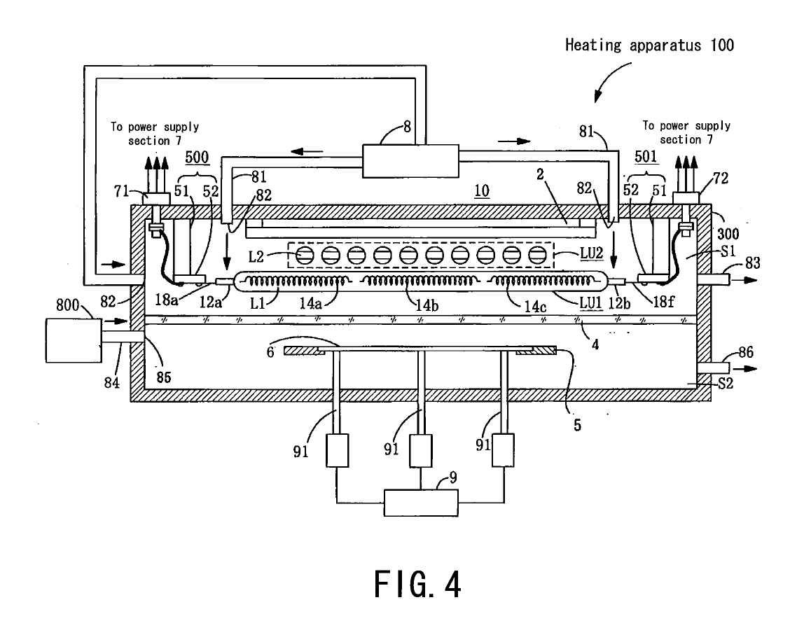

FIG. 4 is an explanatory diagram of the structure of the heating apparatus 100 according to the present invention. As shown in FIG. 4, the heating apparatus 100 has a chamber 300. The inside of the chamber 300 is divided into a lamp unit placing space S1 and a heat treatment space S2 by a quartz window member 4. A workpiece is heat-treated by irradiating a workpiece 6 placed in the heat treatment space S2, through the quartz window member 4, with light emitted from lamp units LU1 and LU2 placed in the lamp unit placing space S1.

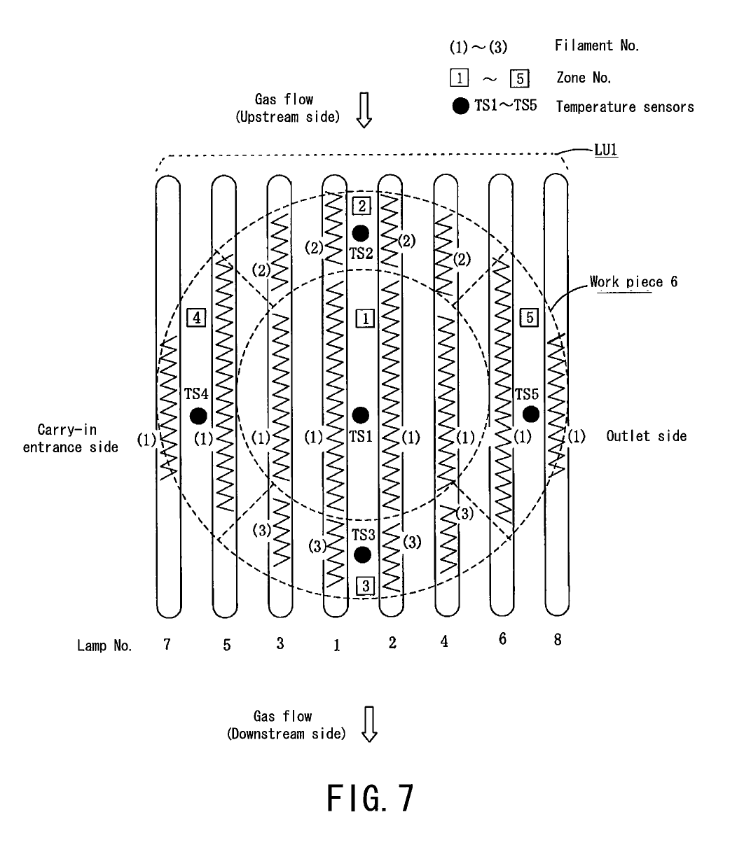

The lamp unit LU2 placed in the lamp unit placing space S1 is formed by arranging, for example, eight straight tube shaped single filament lamps L2 in parallel with one another at predetermined intervals. Similarly, the lamp unit LU1 is formed by arranging, for example, eight straight tube shaped filament lamps L1 in parallel with one another at predetermined intervals. In this embodiment, for example, four multi-filament lamps are used for four of the eight filament lamps L1 (refer to FIG. 7 described later). Both the lamp units LU1 and LU2 are arranged so as to face each other. The axial direction of the single filament lamps L2 which form the lamp unit LU2 intersects with the axial direction of the filament lamps L1 which include the multi-filament lamps and which form the lamp unit LU1. In addition, it is not necessary for these axial directions to intersect with each other. For example, they may be arranged so that these directions are in parallel with each other.

Two or more filaments are arranged inside a light emission bulb of each of the multi-filament lamps L1 which form part of the lamp unit LU1 so as to be arranged one by one in the axial direction of the light emission bulb, and so that electric power is independently supplied to each of the divided filaments. It is possible to adjust the illuminance distribution on the workpiece 6 arbitrarily with high precision, by making light emission portions of each filament of multi-filament lamp L1 emit light individually, and/or by adjusting voltage supplied to each filament of the multi-filament lamp L1 individually. In FIG. 4, the multi-filament lamp L1 which has three filaments 14a, 14b, and 14c, is shown as an example thereof. A detailed configuration example of the multi-filament lamp L1 will be described later. In addition, the order in the up-down direction of the lamp units LU1 and LU2 can be determined arbitrarily. It is, however, more desirable to arrange the lamp unit LU1 which is made up of two or more multi-filament lamps L1, closer to the workpiece 6 (namely, below the lamp unit LU2).

Light from the lamp, which is emitted to the workpiece, consists of light which is directly emitted to the workpiece (hereinafter referred to as direct light) and light (hereinafter referred to as reflected light) which is reflected by a reflecting mirror 2 (which is described later) and then emitted to the workpiece. The direct light has intensity higher than that of the reflected light, since the direct light is not reflected by the reflecting mirror 2. As described above, if the lamp unit LU1 is arranged in a side near the workpiece 6, the direct light with the large intensity, which is emitted from each filament of the filament lamps L1 including the multi-filament lamps reaches the workpiece, without much spreading of light. Therefore, the light irradiation separateness (also referred to as zone separateness) of the irradiated area of each filament becomes excellent on the workpiece, so that it is possible to adjust the illuminance distribution on the workpiece 6 with high precision.

The reflecting mirror 2 is arranged above the lamp unit LU2. The reflecting mirror 2 has the structure in which gold is coated on a base metal made of oxygen free high conductivity copper or aluminum. A reflective face has a shape of, such as part of circle, part of ellipse, part of parabola, or a plate, in a section cross sectional view. The reflecting mirror 2 reflects light emitted upward from the lamp units LU1 and LU2 to the side of the workpiece 6. That is, in the heating apparatus 100, light which is emitted from the lamp units LU1 and LU2 and with which irradiates the workpiece 6, as described above, consists of the direct light and the reflected light which is reflected on the reflecting mirror 2.

In addition, as described above, the lamp unit LU2 mainly takes charge of raising the temperature of the workpiece, and comprises the single filament lamps L2 to which a large electric power can be applied. Therefore, the illuminance of the irradiation light on the surface of the workpiece which is emitted from the lamp unit LU2 is large. When the amount of the electric power which can be applied thereto is relatively small, in order to increase the illuminance of the irradiation light on the surface of the workpiece, it is necessary to make small the intervals between the single filament lamps L2. In this case, it is desirable to adopt a plane mirror as the reflecting mirror 2. This is because, if a wave-shaped mirror is adopted as the reflecting mirror 2, it may be difficult to narrow the intervals between these lamps.

Cooling air which flows from a cooling air unit 8 is introduced in the lamp unit placing space S1, from a supply opening 82 of cooling air supply nozzles 81 provided in into the chamber 300. The cooling air introduced into the lamp unit placing space S1, is blown to each of the single filament lamps L2 of the lamp unit LU2 and each of the filament lamps L1 of the lamp unit LU1, so that the light emission bulbs of these filament lamps are cooled down. Here, sealing portions (for example, in FIG. 4, sealing portions 12a and 12b of one of the multi-filament lamp L1 are shown) which are end portions of each filament lamp, have low thermal resistance as compared with the other parts. Therefore, it is desirable that the supply opening(s) 82 of the cooling air supply nozzle 81 face the sealing portions (12a, 12b) of each filament lamp, so that the sealing portions (12a, 12b) of each filament lamp may be preferentially cooled. The cooling air which is blown to each filament lamp becomes high in temperature due to heat exchange, and then is discharged from a cooling air exhaust port 83 provided in the chamber 300. In addition, it is configured that each filament lamp may not be heated by the flow of the cooling air which becomes high in temperature due to the heat exchange.

The air flow is adjusted so that the cooling air may also cool the reflecting mirror 2 simultaneously. In addition, when the reflecting mirror 2 is water-cooled by water-cooling mechanism (not shown in the figures), the air flow may not necessarily be adjusted so that the reflecting mirror 2 may also be cooled simultaneously. By the way, heat is accumulated in the quartz window member 4 due to radiant heat from the heated workpiece 6. The workpiece 6 may receive an undesired heating action due to heat rays secondarily emitted from the quartz window member 4 by the heat accumulation. In this case, there is a problem of the redundant temperature controllability of the workpiece (for example, overshoot in which the temperature of the workpiece becomes higher than the preset temperature), or a problem that the temperature uniformity of the workpiece decreases due to a temperature variation of the quartz window member 4 which accumulates the heat. Moreover, improvement of speed of lowering the temperature of the workpiece 6 becomes difficult. Therefore, in order to suppress such problems, it is desirable to provide the supply opening 82 of the cooling air supply nozzle 81 near the quartz window member 4, so as to cool the quartz window member 4 by the cooling air from the cooling air unit 8.

Each filament lamp L1 of the lamp unit LU1 is supported by a pair of first fixed stands 500 and 501. The first fixed stand consists of an electric conduction stand 52 formed by a conductive material, and a holding stand 51 made from an insulating material, such as ceramics. The holding stand 51 is provided on an inner wall of the chamber 300, and holds the electric conduction stand 52. Here, when the total number of the filaments of all the filament lamps L1 including the multi-filament lamps which form the lamp unit LU1 is represented as N, and electric power is supplied independently to each of all the filament, the number of pairs of the first fixed stands 500 and 501 is N. On the other hand, each single filament lamp L2 of the lamp unit LU2 is supported by a second fixed stand (not shown). The second fixed stand is made up of an electric conduction stand and a holding stand as in the first fixed stand. When the total number of the single filament lamps L2 which form the lamp unit LU2 is represented as M, the number of pairs of the second fixed stands is M.

A pair of power supply ports 71 and 72 which is connected to the power supply apparatus of the power supply section 7 through power feeders is provided in the chamber 300. In addition, although, in FIG. 4, one pair of power supply ports 71 and 72 is shown, the number of pairs of the power supply ports is determined according to the total number N of the filaments of all the multi-filament lamps L1 and the total number M of the single filament lamps L2, etc. In the example of FIG. 4, the power supply port 71 is electrically connected with the electric conduction stand 52 of the first lamp fixed stand 500. Moreover, the power supply port 72 is electrically connected with the electric conduction stand 52 of the first lamp fixed stand 501. On the other hand, the electric conduction stand 52 of the first lamp fixed stand 500 and the electric conduction stand 52 of the first lamp fixed stand 501 are, respectively, electrically connected with a pair of external leads for supplying power to, for example, the multi-filament lamp L1 shown in FIG. 4. A pair of external leads is connected to the filament 14a of the multi-filament lamp L1, so that electric power is supplied to the filament 14a from power supply apparatus.

The other filaments 14b and 14c of the multi-filament lamp L1, the respective filaments of the multi-filament lamps other than the multi-filament lamp L1 of the lamp unit LU1, the respective filaments of the single filament lamps L2 of the lamp unit LU2, are electrically connected with other pairs of power supply ports 71 and 72, respectively. In addition, although, in FIG. 4, the power supply ports 71 and 72 are provided on an upper part of the chamber 300, they may be provided on portions other than the upper part. For example, they may be provided on side faces of the chamber 300 which sealing portions of each filament lamp face respectively.

As described above since, the number of pairs of the first fixed stands 500 and 501 is N, and the number of pairs of the second fixed stands 500 and 501 is M, in case where the axis direction of the lamps L1 and that of the lamps L2 are in parallel to each other, “N+M” wires (“M+N” is the number of wires) are connected to these pairs of power supply ports 71 and 72, respectively. Therefore, the structure of these pairs of power supply ports 71 and 72 becomes large. Therefore, as described above, in the case where the axial direction of the single filament lamps L2 which form the lamp unit LU2 is set so as to intersect with the axial direction of the filament lamps L1 which form the lamp unit LU1, specifically, in case where these axes intersect approximately at right angles with each other, a pair of first side faces of the chamber 300 which the sealing portions of the single filament lamps L2 face, is different from a pair of second side faces of the chamber 300 which the filament lamps L1 face. In this case, simply, these pairs of power supply ports 71 and 72 to which “M” wires (“M” is the number of wires) are connected, can be provided on the first side faces, and these pairs of power supply ports 71 and 72 to which “N” wires (“N” is the number of wires) are connected, can be provided on the second side face. Therefore, it is possible to miniaturize the structure of these pairs of power supply ports 71 and 72.

On the other hand, a processing stand 5 to which the workpiece 6 is fixed, is provided in the heat treatment space S2. For example, when the workpiece 6 is a semiconductor wafer, the processing stand 5 is a thin annular member made of high melting point metal material such as molybdenum, tungsten and tantalum, ceramic material such as silicon carbide (SiC), quartz or silicon (Si). It is desirable that the processing stand 5 have a guard ring structure where a step portion for supporting a semiconductor wafer is formed in an inner circumferential portion of a circular opening. The semiconductor wafer is placed so as to be inserted in the circular opening of the circular-ring-shaped guard ring, and is supported in the step portion. Also the guard ring itself becomes high in temperature due to light emitted thereto, so that an outer circumference edge of the semiconductor wafer which the guard ring faces is radiationally-heated supplementally, whereby the thermal radiation from the outer circumference edge of the semiconductor wafer is compensated. Thereby, the temperature fall in the semiconductor wafer circumference edge which attributes to thermal radiation etc. from the outer circumference edge of the semiconductor wafer is suppressed.

On a back side of the light irradiation face of the workpiece 6 which is placed in the processing stand (hereinafter referred to as a guard ring) 5, temperature measuring sections 91 are provided in contact with or close to the workpiece 6. The temperature measuring sections 91 monitor the temperature distribution of the workpiece 6, and arrangement thereof and the number thereof is determined according to the size of the workpiece 6. Each of the temperature measuring section 91 is made up of a thermocouple or an optical fiber. The temperature information, monitored by the temperature measuring sections 91, is sent out to a thermometer 9. The thermometer 9 computes the temperature at measurement points of the respective temperature measuring sections 91 based on the temperature information sent from by the respective temperature measuring sections 91. Moreover, according to types of heat treatment, a process gas unit 800 which introduces process gas in the heat treatment space S2 and discharges it may be connected to the chamber 300. For example, when a thermal oxidation process is carried out, the process gas unit 800 which introduces oxygen gas and purge gas (for example, nitrogen gas) for purging the heat treatment space S2 in the heat treatment space S2 and exhausts it therefrom, is connected to the chamber 300. The process gas and purge gas is introduced into the heating space S2 from a supply opening 85 of the gas supply nozzle 84 of the process gas unit 800, which is connected to the chamber 300. Moreover, an exhaust gas is discharged from an exhaust port 86.

### (2) Configuration Example of Multi-Filament Lamp

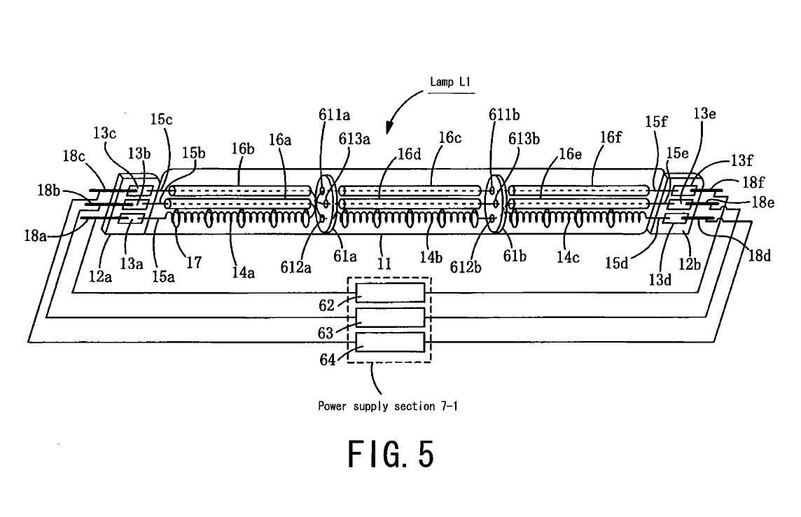

FIG. 5 shows, in detail, an example of the structure of the multi-filament lamp L1. The multi-filament lamp L1 shown in FIG. 5 has, for example, three filaments 14a, 14b, and 14c. As shown in FIG. 5, a light emission bulb 11 of the multi-filament lamp L1 is sealed by pinch-sealing, so that a sealing portion 12a is formed in one end side, and a sealing portion 12b is formed in another end side, thereby forming an airtight inner space in the light emission bulb 11. Here, in the pinch-sealing, metallic foils 13a, 13b, and 13c are buried in the sealing portion 12a, and metallic foil 13d, 13e, and 13f is buried in the sealing portion 12b. External leads 18a, 18b, 18c, 18d, 18e, and 18f are electrically connected to the metallic foils 13a, 13b, 13c, 13d, 13e, and 13f, respectively.

These three filaments 14a, 14b, and 14c are provided in order approximately along the same axis inside the light emission bulb 11. An insulator 61a is provided between the filaments 14a and 14b, and an insulator 61b is provided between the filaments 14b and 14c. A power feeder 15a is electrically connected to one end of the filament 14a, and furthermore, a power feeder 15a is connected to the metallic foil 13a. On the other hand, a power feeder 15f is electrically connected to the other end of filament 14a, and furthermore, the power feeder 15f is connected to the metallic foil 13f. Here, the power feeder 15f is provided so as to, in order, pass through a penetration hole 611a provided in the insulator 61a, an insulation tube 16c which faces the filament 14b, a penetration hole 611b provided in the insulator 61b, and an insulation tube 16f which faces filament 14c may be passed.

A power feeder 15b is electrically connected to one end of the filament 14b, and furthermore, the power feeder 15b is connected to the metallic foil 13b. On the other hand, a power feeder 15e is electrically connected to the other end of the filament 14b, and furthermore, the power feeder 15e is connected to the metallic foil 13e. Here, the power feeder 15b is provided so as to pass through a penetration hole 612a provided in the insulator 61a, and an insulation tube 16a which faces the filament 14a. Moreover, the power feeder 15e, is provided so as to pass through a penetration hole 612b provided in the insulator 61b, and an insulation tube 16e which faces the filament 14c.

A power feeder 15c is electrically connected to one end of the filament 14c, and furthermore, the power feeder 15c is connected to the metallic foil 13c. On the other hand, a power feeder 15d is electrically connected to the other end of the filament 14c, and furthermore, the power feeder 15d is connected to the metallic foil 13d. The power feeder 15c is provided so as to pass through a penetration hole 613b formed in the insulator 61b, an insulation tube 16d which faces the filament 14b, a penetration hole 613a provided in the insulator 61a, and an insulation tube 16b which faces the filament 14a. These filaments 14a, 14b, and 14c are supported by two or more supports 17 which are provided in the axial direction of the light emission bulb 11. These supports 17 are respectively inserted and held between the inner wall of a light emission bulb 11, and the insulation tubes 16a, 16d or 16e.

In the multi-filament lamps L1, a first power supply apparatus 62 is connected between the external leads 18a and 18f, a second power supply apparatus 63 is connected between the external leads 18b and 18e, and a third power supply apparatus 64 is connected between the external leads 18c and 18d. That is, electric power is supplied to these filaments 14a, 14b, and 14c, by the individual power supply apparatuses 62, 63, and 64, respectively. The power supply apparatuses 62, 63, and 64 are variable sources, and the amount of electric supply can be adjusted if needed. In addition, each power supply apparatus may supply DC electric power to the filaments, but may supply AC electric power thereto.

That is, since in the multi-filament lamps L1 shown in FIG. 5, these three filaments 14a, 14b, and 14c are approximately provided, in order, along the same axis thereof, and electric power can be independently supplied to these filaments 14a, 14b, and 14c by the respective power supply apparatuses 62, 63, and 64, it is possible to adjust the light intensity emitted from the respective filaments individually. Therefore, in the lamp unit having such multi-filament lamps L1, it is possible to adjust the illuminance distribution on the workpiece 6 arbitrarily and with high precision. In addition, instead of individually providing power supply apparatuses for all the filaments which are included in each multi-filament lamp L1 of the lamp unit LU1, a single power supply apparatus may be connected to two or more filaments, depending on desired illuminance distribution. In addition, a power supply section 7-1 comprises two or more power supply apparatus 62, 63, and 64, and corresponds to a first power supply section 7-1 described later.

### (3) Configuration Example of Regulating System

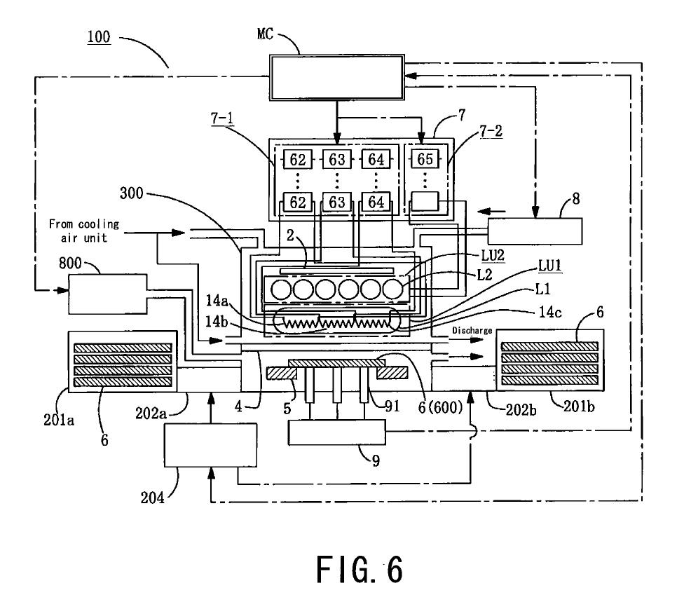

FIG. 6 shows a control block diagram of the light emission type heating apparatus according to the present invention. A heating apparatus 100 is the same as that shown in FIG. 4. Since the heating apparatus 100 is shown in FIG. 4 in detail, description thereof is simplified here. In addition, in FIG. 6, portions which are omitted in FIG. 4 are disclosed. That is, the heating apparatus 100 has a feeding mechanism 202a which feeds one of workpieces 6 stored in a cassette 201a (for example, a semiconductor wafer) before a heat treatment, and places it onto the guard ring 5 of the chamber 300, a cassette 201b which stores heat-treated workpieces 6, and a transporting mechanism 202b which transports the workpiece 6 placed in the guard ring 5 after the heat treatment, to the cassette 201b and place it therein.

In FIG. 6, the power supply section 7 has a first power supply section 7-1 which supplies electrical energy to the lamp unit LU1 formed by arranging in parallel at predetermined intervals, the two or more straight-bulb filament lamps L1 including the multi-filament lamps, and a second power supply section 7-2 which supplies electrical energy to the lamp unit LU2 formed by arranging in parallel at predetermined intervals, two or more straight-bulb single filament lamps L2. An operation of the first power supply section 7-1 and that of the second power supply section 7-2 are controlled by the main control unit MC. Similarly, the main control unit MC controls an operation of the cooling air unit 8 which supplies a cooling air to the lamp unit placing space S1, and an operation of the process gas unit 800 which introduces process gas and purge gas in the heat treatment space S2 and discharges it therefrom. Moreover, the main control unit MC sends an actuating signal for controlling driving of the feeding and transporting mechanisms 202a and 202b, to a feeding and transporting mechanism control unit, and receives a temperature signal from the thermometer 9.

### (4) Example of Configuration and Arrangement of Light Emission Unit

Next, description of a configuration example of a light emission unit and an example of arrangement thereof with respect to a workpiece will be given below.

(a) Lamp Unit LU1

As described above, the lamp unit LU1 is formed by arranging the two or more straight pipe filament lamps L1 including the multi-filament lamps in parallel at predetermined intervals, wherein the heat capacity of each filament of each of the filament lamps L1 including the multi-filament lamps is set small. That is, the lamp unit LU1 can realize (2) a high speed response of illuminance control, and (3) good local illuminance control. The lamp unit LU1 may be formed by arranging the multi-filament lamps L1 in parallel, in which the two or more filaments with the same length are provided. However, as described above, there are areas of a workpiece where heating/cooling properties differ from one another. Therefore, it is desirable to set up the length and the number of the filaments for each of such areas where the heating/cooling property differs from one another. Thus, a light emission type heating treatment with the good uniform temperature distribution can be realized by such configuration. For example, in an example shown in FIG. 4 of Japanese Laid Open Patent No. 2007-157780, an irradiated area is divided into three zones, that is, a wafer area, a guard ring inner side area, and a guard ring outside area, wherein the length of two or more filaments arranged inside each multi-filament lamp which forms the light emission unit is set, according to each zone.

Especially, the above example corresponds to the case where the heating/cooling property of a central area of the workpiece differs from that of an edge portion area of the workpiece, due to influence of the thermal radiation from an edge portion of the workpiece, that is, it corresponds to a case where the physical property of the workpiece surface is almost uniform, and the irradiated area of the workpiece is concentrically divided into two or more zones. Also in the present invention, the thermal radiation from an edge portion of the workpiece is taken into consideration, so that an irradiated area of the workpiece is concentrically divided into two or more zones. In order to facilitate understanding of the present embodiment, an example where the workpiece is a semiconductor wafer, and a guard ring is not used, will be described below. Specifically, a wafer central zone (zone 1) and a wafer edge portion zone are first set up in the irradiated area of the workpiece (semiconductor wafer). Both zones are arranged concentrically, and an inner side of the wafer is the wafer central zone, and an outer thereof is the wafer edge portion zone.

A case where process gas and purge gas is introduced into the heat treatment space S2 when a light emission type heat treatment is carried out, is considered below. For example, when a thermal oxidation process is performed, the process gas is oxygen, and the purge gas is nitrogen. Moreover, in case of film growth on the workpiece surface, for example, silane based gas is used as the process gas. In addition, in order to make an understanding of the present embodiment easy, a case where the physical property of the workpiece surface is almost uniform, is considered. In this case, since introduction and exhaust of gas is frequently performed in the heat treatment space S2, the atmosphere in the heat treatment space S2 is changed dynamically. That is, when a flow of gas, such as the process gas and purge gas, exists in the heat treatment space S2, the heating/cooling property of the workpiece surface area located in the upstream side of the gas flow and that of the workpiece surface area located in the downstream side of the gas flow differ from each other. In particular, in a wafer edge portion zone, the difference between the heating/cooling property of the upstream side of the gas flow and that of the downstream side of the gas flow, becomes remarkable.

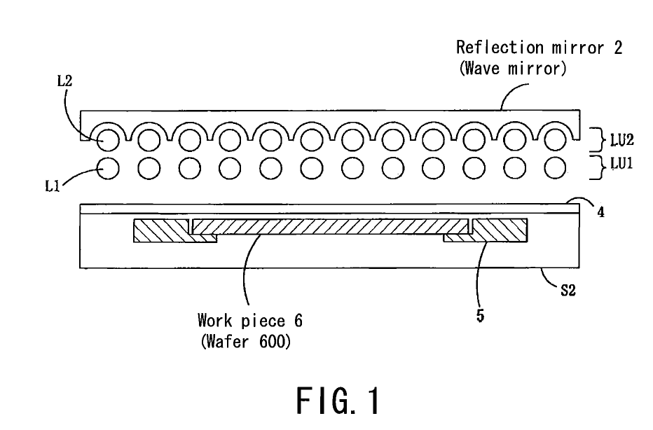

Moreover, although omitted in FIGS. 1, 4, and 6, in part of a wall of the heat treatment space S2, a carrying-in mouth for carrying in a workpiece and a taking-out mouth for taking out the workpiece are provided in the heat treatment space S2. Certainly, the surfaces of the carrying-in mouth and the taking-out mouth are not so flat as the other wall section, that is, they are concavo-convex. When, in such a configuration, light is emitted to a workpiece placed in the heat treatment space S2, part of light emitted from the light emission unit is intricately reflected by the above concavo-convex portions of the carrying-in mouth and the taking-out mouth. That is, there are such light reflection faces whose light reflective conditions are not uniform near the edge portion of the wafer. Thus, the heating/cooling property of the wafer edge portion zone becomes less uniform.

As described above, when there is a flow of gas in the heat treatment space S2, or, even if it is in a state where a flow of the gas stops, when there are the concavo-convex portions on the wall face structure of the heat treatment space S2, it is difficult to perform a light emission type heat treatment of a wafer, while uniformly maintaining temperature distribution all over the wafer, by simply setting the areas to be irradiated with light on the workpiece concentric. Then, in order to deal with the influence of a flow of gas, and the influence of the light reflex property of the wall face section of the heat treatment space S2, it is desirable to subdivide each zone further. The influence of a flow of gas, and the influence of the light reflex property of the wall face section of the heat treatment space S2 notably act with respect to the wafer edge portion zone. That is, the heating/cooling property of the wafer edge portion zone does not become uniform due to these influences. Therefore, the wafer edge portion zone is subdivided.

FIG. 7 shows an example of zone division of area of a workpiece, to be irradiated with light, and a configuration example of the lamp unit LU1 and arrangement thereof which corresponds to the zone division. A semiconductor wafer is shown as an example of the workpiece. In addition, in order to make an understanding of the present embodiment easy, in FIG. 7, a case where process gas or purge gas flows from an upper part of the figure to a lower part thereof, is shown. Moreover, the carrying-in mouth of the workpiece and the taking-out mouth are arranged in a direction perpendicular to the flow of gas. That is, the carrying-in mouth is provided in the left-hand side of FIG. 7, and the taking-out mouth is provided in the right-hand side of FIG. 7. Moreover, although, in FIGS. 1, 4, and 6, the guard ring 5 is shown, in this embodiment, a case where a guard ring 5 is not used, is shown below.

In such a structure, the heating/cooling property in a gas upstream side of the circular ring wafer edge portion zone, that in a gas downstream side thereof, that in a side thereof adjacent to the carrying-in mouth, and that in a side thereof adjacent to the taking-out mouth differ from one another. Then, the circular ring wafer edge portion zone is virtually divided into zones 2, 3, 4, and 5. That is, a zone in the side of the gas upstream, a zone in the side of a gas downstream, a zone in the side thereof adjacent to the taking-out mouth, and a zone in the side thereof adjacent to the carrying-in mouth are respectively set as the zones 2, 3, 4, and 5 (in FIG. 7, areas surrounded by broken lines show the above zones, and numerals 1-5 which are respectively surrounded by squares represent zone numbers). As described above, by dividing the area of the workpiece to be irradiated with light, into the zone 1, 2, 3, 4, and 5, and individually adjusting the illuminance in each zone, respectively, it is possible to perform a light emission type heat treatment of the wafer, uniformly maintaining temperature distribution all over the wafer.

The length of each filament of the lamp unit LU1 which is made up of the two or more lamps including multi-filament lamps, and the position of each filament are determined so as to correspond to these five zones which are set as described above. In the example shown in FIG. 7, the lamp unit LU1 is formed of four multi-filament lamps (a lamp No.1, a lamp No.2, a lamp No.3, and a lamp No.4) and four single filament lamps (a lamp No.5, a lamp No.6, a lamp No.7, and a lamp No.8). The four multi-filament lamps are arranged at the respective positions corresponding to the center of the workpiece, and two of the four single filament lamps are respectively arranged in both (outer) sides of the four multi-filament lamps.

That is, a filament (1) of the lamp No.1, a filament (1) of the lamp No.2, a filament (1) of the lamp No.3 arranged on the outside of the lamp No.1, and a filament (1) of the lamp No.4 arranged on the outside of the lamp No.2 are arranged, in order to correspond to the zone 1 which is a wafer center zone (numerals with parentheses shows filaments in FIG. 7). Hereafter, in order to simplify the notation, a filament B of a lamp No. A will be referred to as a filament A-B. For example, the filament (1) of the lamp No.1 is referred to as a filament 1-1. That is, a filament 3-1, a filament 1-1, a filament 2-1, and a filament 4-1 are in order arranged from the left-hand side of FIG. 7, as the filaments corresponding to the zone 1. In addition, these filaments may be referred to as filaments 14, below. Moreover, the length of each filament is also set so as to correspond to the circular zone 1. That is, the length of the filament 3-1 and 4-1 are shorter than the length of the filament 1-1 and 2-1.

Similarly, a filament 3-2, a filament 1-2, a filament 2-2, and a filament 4-2 are arranged in that order from the left-hand side of FIG. 7, so as to correspond to the zone 2 which is located in the gas upstream side. The lengths of these filaments are set, corresponding to the shape of the zone 2. Moreover, a filament 3-3, a filament 1-3, a filament 2-3, and a filament 4-3 are arranged in that order from the left-hand side of FIG. 7, so as to correspond to the zone 3 which is located in the gas downstream side. The lengths of these filaments are set, corresponding to the shape of the zone 3. Furthermore, a filament 7-1 and a filament 5-1 are arranged in that order, from the left-hand side of FIG. 7, so as to correspond to the zone 4 which is located in the carrying-in mouth side. The lengths of these filaments are set, corresponding to the shape of the zone 4. Furthermore, a filament 6-1 and a filament 8-1 are arranged in that order from the left-hand side of FIG. 7, so as to correspond to the zone 5 which is located in the outlet side. The lengths of these filaments are set, corresponding to the shape of the zone 5.

That is, when the lamp No.7, the lamp No.5, the lamp No.3, the lamp No.1, the lamp No.2, the lamp No.4, the lamp No.6, and the lamp No.8 are arranged in that order from the left-hand side of FIG. 7, the lengths of the filaments of the respective lamps are set as set forth below. The lengths of the filaments 3-1, 1-1, 2-1, and 4-1 are set so as to form a circle which corresponds to the zone 1, when the respective lamps are put in parallel in the above described order. Moreover, the lengths of the filaments 3-2, 1-2, 2-2, 4-2, 3-3, 1-3, 2-3, 4-3, 7-1, 5-1, 6-1, and 8-1 are set so as to form a concentric circle which corresponds to the wafer edge portion zone (the zones 2, 3, 4, and 5) when the respective lamps are put in parallel in the above described order.

In addition, when a guard ring 5 is used, the zone division in the area to be irradiated with light on the workpiece is made, for example, as set forth below. First, the area to be irradiated with light is concentrically divided into three zones. These three zones are a wafer central zone, a wafer edge portion zone, and a guard ring zone. In addition, the workpiece edge portion zone is determined, taking into consideration, diffraction of light emitted to the workpiece central zone toward the workpiece edge portion and diffraction of light emitted to the guard ring zone toward the workpiece edge portion. Next, the influence of a flow of gas and the light reflex property in the wall section of the heat treatment space S2 is taken into consideration, and the workpiece edge portion zone and the guard ring zone are divided into four zones, respectively. That is, when the guard ring 5 is used, in the zone division, the area to be irradiated with light on the workpiece is divided into nine zones. The lengths of the respective filaments in the lamp unit LU1 which is made up of two or more lamps including multi-filament lamps, and arrangement of these filaments are determined so as to correspond to these nine zones set in this way. In addition, the number of divided areas of the workpiece edge portion zone and the guard ring zone is not limited to four (4), and the number of the divided areas may be determined according to the heating/cooling property of the workpiece. Moreover, the number of divided areas of the concentric circle zones which is determined at first, is not limited to three (3), and the number of the divided areas may be determined according to the heating/cooling property of the workpiece.

(b) Lamp Unit LU2

As described above, the lamp unit LU2 is formed by arranging the two or more straight-bulb single filament lamps L2 in parallel at predetermined intervals. The diameter of a filament line of each single filament lamp L2 is made large, so that large electric power can be applied to the filament lamps L2. That is, the lamp unit LU2 is set up so that (1) a workpiece temperature rise at a high speed can be realized. In case of the lamp unit LU1, in order to heat the workpiece so that the temperature of the workpiece, whose heating/cooling property is not uniform, may become uniform, the length and the number of the filaments are determined for each of the areas (zones 1, 2, 3, 4, and 5) whose heating/cooling properties differ from one another. On the other hand, the lamp unit LU2 mainly takes charge of (1) a workpiece temperature rise at a high speed. Therefore, the workpiece is irradiated with light from the lamp unit LU2 so that the illuminance on the workpiece may become large. That is, the zones 1, 2, 3, 4, and 5 are not taken into consideration, and the number of the single filament lamps L2 and the length of the filaments thereof are determined so that light can be emitted to the whole workpiece.

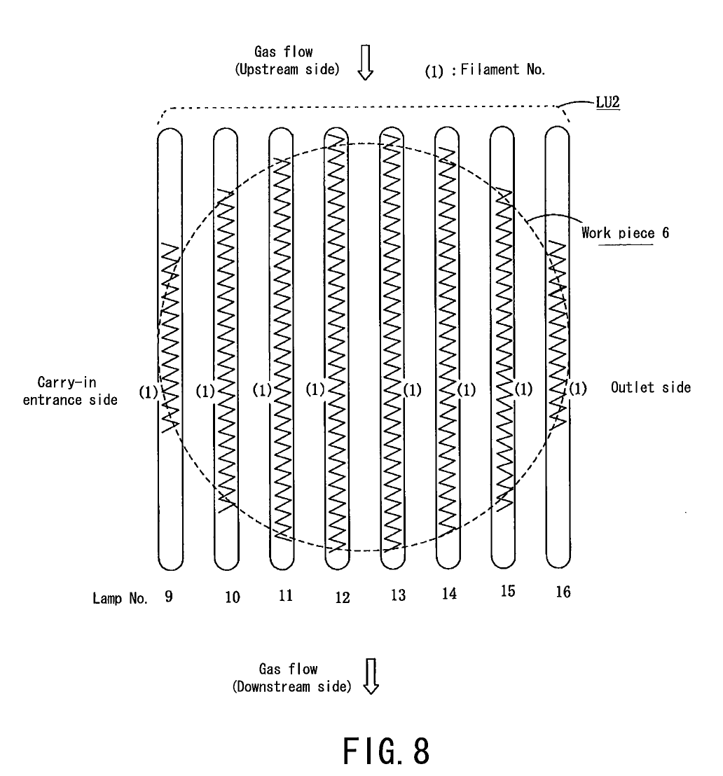

In FIG. 8, an example of configuration and arrangement of the lamp unit LU2 is shown. A semiconductor wafer is shown as an example of a workpiece. In addition, in order to make an understanding of the present embodiment easy, a guard ring 5 is omitted. In the example shown in FIG. 8, the lamp unit LU2 is formed of eight single filament lamps L2 (a lamp No.9, a lamp No.10, a lamp No.11, a lamp No.12, a lamp No.13, a lamp No.14, a lamp No.15, and a lamp No.16). In addition, a filament B of a lamp No. A will be referred to as a filament A-B. For example, the filament (1) of the lamp No.9 is referred to as a filament 9-1.

The lamps 12 and 13 with the longest filament length(s) are arranged at a center part of the workpiece so as to correspond to the circular shape of the workpiece. The lamps 11 and 14 are respectively arranged outside the lamps 12 and 13, wherein the length(s) of the filaments 11-1 and 14-1 of the lamps 11 and 14 is (are) shorter than the length(s) of the filaments 12-1 and 13-1. Similarly, the lamps 10 and 15 are respectively arranged outside the lamps 11 and 14, wherein the length(s) of the filaments 10-1 and 15-1 of the lamps 10 and 15 is (are) shorter than the length(s) of the filaments 11-1 and 14-1. The lamps 9 and 16 are arranged outside the lamps 10 and 15, wherein the length(s) of the filaments 9-1 and 16-1 of the lamps 9 and 16 is (are) shorter than the length(s) of the filaments 10-1 and 15-1.

In addition, it is also possible to make the length(s) of all the filaments of the lamps 9, 10, 11, 12, 13, 14, 15, and 16 the same as that (those) of the length(s) of the filaments of the lamps 12 and 13. However, since, in this case, light is also emitted to portions other than the workpiece within the heat treatment space S2, the use efficiency of the light emitted from the lamp unit LU2 is low. In addition, undesired heating to components other than the workpiece may also be generated. Therefore, as shown in FIG. 8, it is desirable to set the lengths of the filaments of the lamps 9, 10, 11, 12, 13, 14, 15, and 16, so as to correspond to the shape of the workpiece.

In addition, although in the examples shown in FIGS. 7 and 8, in order to make an understanding of the present invention easy, the axial direction of the two or more filament lamps L1 including the multi-filament lamps which forms the lamp unit LU1, is shown so as to be in parallel with the axial direction of the two or more single filament lamps L2 which form the lamp unit LU2, these directions thereof are not limited thereto. As shown in FIGS. 4 and 6, they may intersect each other. Moreover, when such a guard ring 5 is used, the lengths and arrangement of the filaments of the respective lamps are set up so as to correspond to the shape of an object which is made up of the workpiece and the guard ring surrounding the workpiece and which is irradiated with light.

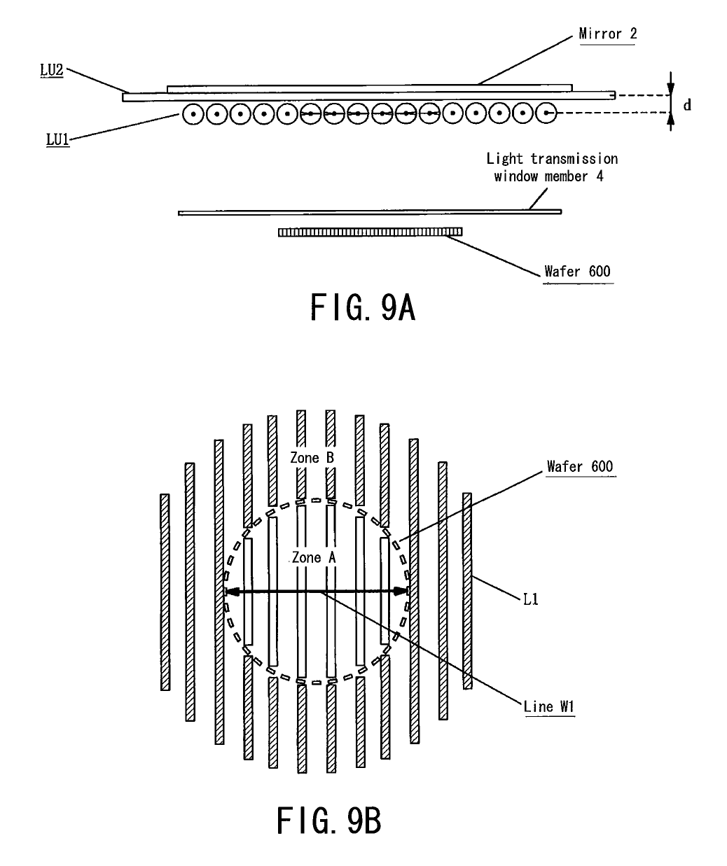

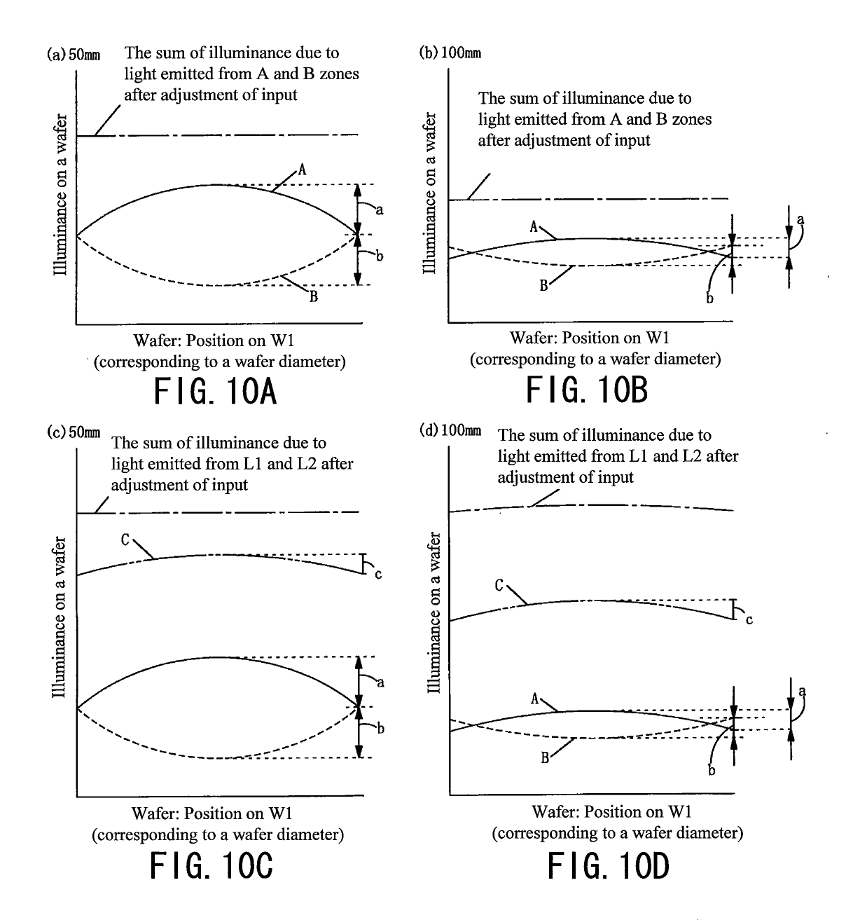

A case where the lamp unit LU1 and the lamp unit LU2 are arranged as shown in FIG. 9A and the position relation of the wafer 600 and each filament of a group of the lamps L1 of the lamp unit LU1 is shown in FIG. 9B, will be described below. In addition, as shown in FIG. 9B, these filaments are arranged approximately in a circular area. In this circular area, a central zone where the filaments are arranged, corresponding to the wafer 600, is referred to as a zone A, and an edge portion zone of the circular area which is located outside the zone A is referred to as a zone B. In case where only the light unit UL1 is lighted without lighting the lamp unit LU2, the illuminance distribution on the wafer 600 is shown in FIGS. 10A and 10B, wherein a distance of a unit of the lamp units LU1 and LU2 and the wafer 600 was changed. In the case, these lamps were lighted with rated power. The distance (50 mm and 100 mm in the figures) means a distance between the center (axes) of the lamps L1 of the lamp unit LU1 and the wafer 600. Hereafter, this distance is referred to as an irradiation distance. In addition, specifically, FIGS. 10A, 10B, 10C and 10D show the illuminance distribution on a straight line W1 which is perpendicular to the axis direction of the group of the lamps L1 shown in FIG. 9B and which passes through the center of the wafer (on the wafer). FIGS. 10A and 10B show a case where only the lamp unit LU1 is lighted, and FIGS. 10C and 10D show a case where the lamp units LU1 and LU2 described later are lighted. A solid line shown in each of the figures is illuminance distribution on the straight line W1 (on a wafer) due to light emitted from each filament arranged in the zone A (hereinafter referred to as illuminance distribution A). A dotted line shows illuminance distribution on the straight line W1 due to light emitted from each filament arranged in the zone B (hereinafter referred to as illuminance distribution B). A dot-dashed line shows illuminance distribution on the straight line W1 due to light emitted from each filament arranged in the zones A and B (namely, all filaments belonging to the lamp unit LU1) after input adjustment, wherein the it is equivalent to the sum of the illuminance distribution A and illuminance distribution B after input adjustment. In the illuminance distribution A, illuminance at the central part is largest on the straight line W1 (corresponding to the wafer central part). The illuminance distribution A shows a gentle ascending and descending curve wherein the illuminance becomes gradually low towards the both ends of the line W1 (corresponding to the wafer edge portion). On the other hand, in the illuminance distribution B, the illuminance at a central part is the lowest on the straight line W1 (corresponding to a wafer central part), and the illuminance distribution shows a gentle descending and ascending curve wherein the illuminance becomes gradually large towards the both ends of the straight line W1 (corresponding to the wafer edge portion). In the case (a) shown in FIG. 10A where the irradiation distance is short, it is possible to attain good light irradiation separateness between an area which is irradiated with light emitted from each filament arranged in the zone A in order to heat the wafer central area, and an area which is irradiated with light emitted from each filament arranged in the zone B in order to compensate the temperature fall of the wafer edge portion. On the other hand, in the case (b) shown in FIG. 10B where the irradiation distance is long, since light emitted from each lamp L1 spreads before the light reaches the wafer 600, the light irradiation separateness on the respective areas which are irradiated with the light, becomes worse, and the illuminance distribution on each straight line W1 (on the wafer) shows approximately even distribution.

In this case, when temperature distribution on a face of the wafer 600 is adjusted by the lamp unit LU1 including the multi-filament lamps, since the illuminance distribution A and the illuminance distribution B show the symmetrical distribution property, if an input of electric power applied to the filaments arranged in each zone is adjusted so that a value of a illuminance difference a in the illuminance distribution A may become approximately the same as a value of a illuminance difference b in the illuminance distribution B, the illuminance distribution within the wafer face becomes good. Thus, the illuminance distribution, after the input is adjusted, is shown in the dot-dashed line in FIGS. 10A and 10B. When the input is adjusted, in the case where the irradiation distance shown in FIG. 10A is 50 mm, A:B=0.8:1, and in the case where the irradiation distance shown in FIG. 10B is 100 mm, A:B=0.45:1, wherein power applied to the filaments arranged in the zone A is shown as A and power applied to the filaments arranged in the zone B is shown as B. Since the light irradiation separateness on each irradiated area worsens as the irradiation distance becomes long, and the degree of flatness of the curve of the illuminance distribution B becomes high, it is necessary to make small the ratio of the power applied to the filaments arranged in zone A to the power applied to the filaments arranged in the zone B.

Next, in the arrangement shown in FIG. 9, the illuminance distribution on the straight line W1 in case where a group of the lamps L2 of the lamp unit LU2 is lighted in order to raise the temperature of a wafer at a high speed, will be described below. In FIGS. 10C and 10D, the illuminance distribution is shown in case where the lamp unit LU2 is lighted and the distance between the lamp units LU1 and LU2 and a wafer 600 is changed. In addition, the distance (50 mm and 100 mm in the figures) means a distance between the center (axes) of the lamps L1 of the lamp unit LU1 and the wafer 600. These filaments of a group of the lamps L2 are arranged in a circular area whose shape is the almost same as that of the arrangement area of the filaments of the lamps L1 in the lamp unit LU1 (zones A and B). Moreover, a distance d between the center of the lamp L2 of the lamp unit LU2 and the center of the lamp L1 of the lamp unit LU1 which are shown in FIG. 9A, is 18 mm. A solid line shown in FIGS. 10C and 10D is illuminance distribution on the straight line W1 (on the wafer) due to light emitted from each filament arranged in the zone A (illuminance distribution A). A dotted line shows illuminance distribution on the straight line W1 due to light emitted from each filament arranged in the zone B (illuminance distribution B). A two dot-dashed line shows illuminance distribution on the straight line W1 due to light emitted from the lamp unit L2 (hereinafter referred to as illuminance distribution C). A dot-dashed line shows illuminance distribution on the straight line W1 due to light emitted from the lamp units LU1 and LU2 after an input is adjusted, wherein it is equivalent to the sum of the illuminance distribution A, the illuminance distribution B, and the illuminance distribution C after the input adjustment. Moreover, “a” shows an illuminance difference (maximum minus minimum) of the illuminance distribution A, “b” shows an illuminance difference (maximum minus minimum) of the illuminance distribution B, and “c” shows an illuminance difference (maximum minus minimum) of the illuminance distribution C due to light emitted from the lamp unit L2. The group of the lamps L2 of the lamp unit LU2 are the single filament lamps, and since some of the filaments of a group of the lamps L2 are arranged above the wafer 600 as well as each filament arranged in the zone A of the lamp unit LU1, as shown in FIG. 10C, the illuminance distribution C on the straight line W1 shows a gentle ascending and descending curve, wherein a peak of the illuminance is at a central part of the curve, and the illuminance becomes gradually low towards the both ends of the line W1. In order to perform a temperature raising process at a high speed, as the power applied to a group of the lamps L2 of the lamp unit LU2 is increased, the illuminance difference c in the illuminance distribution C becomes large, compared with the case where only the group of the lamps L1 is lighted, so that the illuminance distribution (which is equivalent to the sum of the illuminance distribution A, the illuminance distribution B, and the illuminance distribution C) on the straight line W1 (on the wafer face) comes under the large influence of the illuminance distribution A and the illuminance distribution C which respectively show an ascending and descending illuminance curve having a peak at the central part of the wafer. Therefore, in order to make the temperature of the wafer 600 uniform, it is necessary to perform an input adjustment of the electric power applied to each filament belonging to the lamp units LU1 and LU2 so that the sum of a value of an illuminance difference a in the illuminance distribution A having the ascending and descending curve and a value of the illuminance difference c in the illuminance distribution C may become approximately the same as a value of the illuminance difference b in the illuminance distribution B. Specifically, it is necessary to make still smaller, power applied to each filament arranged in the zone A of the group of the lamps L1, and to make high the ratio of the illuminance distribution B to the above illuminance distribution. On the other hand, if the electric power applied to the group of the lamps L2 of the lamp unit LU2 is increased further, as shown in FIG. 10D, it becomes impossible to realize uniform illuminance distribution (a doted line in this figure) on the straight line W1 (on the wafer face) even though the power applied to the zone A of the group of the lamps L1 is set to zero (0). Therefore, when the power applied to the zone A of the group of the lamps L1 is set to zero (0), and the illuminance distribution on the straight line W1 (on the wafer face) becomes uniform, the value of the power applied to the group of the lamps L2 substantially becomes the maximum of the power applied to the group of the lamps L2, so that there is a problem that a temperature rising speed cannot be increased more than the temperature rising speed at this time.

Then, the lamp unit LU2 in which two or more lamps L2 are in order arranged in parallel may be formed, so that in the illuminance distribution on the wafer face due to the light emitted from the lamp unit LU2, an illuminance is high in the wafer edge portion, and the shape thereof becomes a concentric circle. That is, in some of the group of the lamps L2 arranged in the central part of the lamp unit LU2, a lamp(s) having a central part which does not emit light or the intensity of light emitted therefrom is low, may be used, so that, when the lamps L2 are put in parallel to one another, the area where light is not emitted, or the intensity of light becomes low, may be arranged so as to correspond to the shape of the wafer 600.

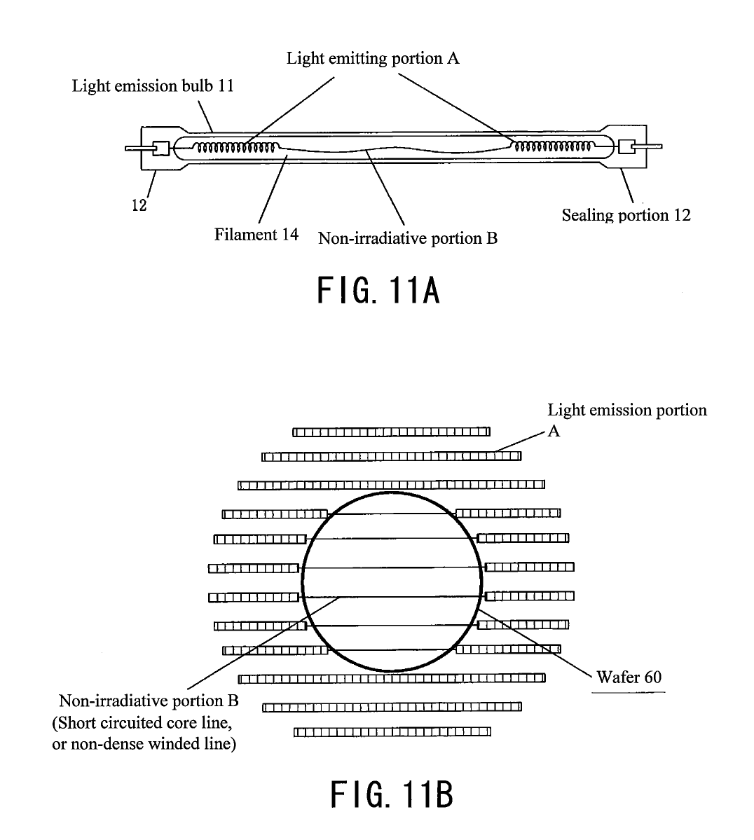

FIG. 11A shows an example of a lamp having a central part where light is not emitted or the intensity of light is low. FIG. 11B shows an arrangement of the lamps L2 of the lamp unit LU2 in which such a lamp(s) is built. As shown in FIG. 11A, in the lamp having a central part which does not emit light or the intensity of light emitted therefrom is low, a tungsten filament 14 is arranged along the tube axis inside the straight-bulb light emission bulb 11 which is made of quartz glass and which has sealing portions 12 at both ends thereof. The filament 14 comprises light emission portions A which are made from a densely winded filament wire, and a non-irradiative portion B (or a low irradiative portion) which is made from a short circuited core wire or a non-densely winded filament wire. As shown in FIG. 11B, the non-irradiative portions of such lamps L2 are arranged so as to correspond to the shape of the wafer 600. In addition, when the non-irradiative portion B is made from such a short circuited core wire, the non-irradiative portion does not emit light. On the other hand, when the non-irradiative portion is made from non-densely winded filament wire, depending on the conditions of electric power to be applied, the non-irradiative portion may not be lighted, or may be lighted so that the intensity of light is lower than that of light emitted from the light emission portions A. The “non-irradiative portion B” means an area from which light is not emitted or an area where the intensity of light emitted, is smaller than the light intensity in the light emission portions A even though light is emitted.

In the apparatus shown in FIG. 9, an experimentation was conducted in which a distance between the center of a lamp L1 and the wafer 600 was set to 100 mm, and a distance between the center of a lamp L2 and the wafer 600 was set to 118 mm, and further electric power density of the lamp L1 was 80 W/cm and lamp pitch thereof was 16 mm and electric power density of the lamp L2 was 120 W/cm and lamp pitch thereof was 16 mm. The experimentation was conducted for a temperature holding period which was 60 seconds, at a processing temperature of 1100 degree Celsius in dry oxygen. The input ratio of power A applied to the filaments arranged in the zone A of the lamp unit LU1, power B applied to the filaments arranged in the zone B, power C applied to the filaments of the group of the lamp L2 of the lamp unit LU2, in the temperature holding period, was changed, and the ratio of the applied powers A, B and C and film thickness uniformity, at time which the thickness distribution of a oxide film on a wafer 600 was good, was examined. Uniformity was compared, based on a value obtained by dividing a value of 3σ of the film thickness of the oxide film on each wafer 600 by the average value of the film thickness of the oxide film on each wafer 600. The experimentation was conducted as to three conditions set forth below,

(1) The lamp L2 was not lighted. (2) Single filament lamps were used for the lamp L2. (3) Lamps L2 having non-irradiative portion at a center thereof were used for the lamps L2. Consequently, the following results were obtained.

Case (1)

### Ratio A:B:C=0.45:1:0 3 σ/ave: 4.84%

Attained temperature: 1080 degree Celsius

Case (2)

### Ratio A:B:C=0.45:1:0.24 3 σ/ave: 5.20%

Attained temperature: 1100 degree Celsius

Case (3)

### Ratio A:B:C=0.60:1:0.50 3 ∝/ave: 3.71%

Attained temperature: 1100 degree Celsius

As described above, in the case (1) where the lamps were not lighted, it turned out that the processing temperature did not reach a desired temperature. Moreover, in the case (2) where the single filament lamps were used, uniformity 3 σ/ave value got the worst. Furthermore, in the case (3) where the lamps having the non-irradiative central part were used, it tuned out that the processing speed reached a desired speed, and the uniformity was also improved.

### (5) Configuration Example of Power Supply Section 7

Next, a configuration example of the power supply section 7 will be described below. As described above, the light emission unit of the light emission type heating apparatus according to the present invention comprises the lamp unit LU2 capable of “(1) a workpiece temperature rise at a high speed,” in which the two or more straight-bulb single filament lamps L2 are arranged in parallel to one another, and large electric power can be applied to the filaments of these lamps, and the lamp unit LU1 capable of “(2) a high speed response of illuminance control” and “(3) good local illuminance control”, in which the two or more straight-bulb filament lamps L1 including the straight-bulb multi-filament lamps are arranged in parallel to one another, wherein the heat capacity of these filaments is made small. Thus, different roles are respectively assigned to these two lamp units LU1 and LU2, and furthermore, by appropriately controlling lighting of the two lamp units LU1 and LU2 in the light emission type heating apparatus according to the present invention, all of the conditions (1) a workpiece temperature rise at a high speed, (2) a high speed response of illuminance control, and (3) a good local illuminance control become possible. Therefore, the power supply section 7 comprises first and second power supply sections 7-1 and 7-2, in which the first power supply section 7-1 individually supplies electrical energy to the first lamp unit LU1 and the second power supply sections 7-2 individually supplies electrical energy to the lamp unit LU2, and in which the lamp units LU1 and LU2 share the roles different from each other. Hereafter, a configuration example of the first power supply section 7-1 and the second power supply section 7-2 will be described below.

(a) Configuration Example of First Power Supply Section 7-1

The lamp unit LU1 to which the first power supply section 7-1 supplies electrical energy, has the structure in which the two or more straight-bulb filament lamps including the straight-bulb multi-filament lamps L1 are arranged in parallel to one another. Since the heat capacity of each filament of each multi-filament lamp L1 is set up small, the intensity of light emitted from these filaments changes at a high speed in response to change of electric power supplied to these filaments. That is, the lamp unit LU1 can adjust the illuminance on a workpiece at a high speed. Moreover, by individually adjusting power supply to each filament of each multi-filament lamp L1, the lamp unit LU1 can arbitrarily adjust the illuminance distribution on the workpiece 6 and with high precision. For such a function, the power supplied to the two or more filaments inside the multi-filament lamps L1, is controlled individually. Therefore, basically, what is necessary is just to configure the first power supply section 7-1, so as to have the structure in which independent control systems whose number is the number of filaments are provided.

If the filaments inside the multi-filament lamps L1 increase in number as the size of a workpiece becomes large, the number of control systems is required so as to correspond to the number of the multi-filament lamps L1. Therefore, the light emission type heating treatment apparatus itself becomes large in size and increases in cost. Therefore, when the number of the filaments inside the multi-filament lamps L1 becomes large, for example, the filaments in the two or more multi-filament lamps L1 which form the lamp unit LU1 are grouped so as to form a filament group, corresponding to each zone. Each filament is individually connected to a drive section which supplies power in electrical energy, and a group of the drive sections are in block controlled by the same control signal from the electric power control unit, which is provided for each filament group. Thus, by configuring the structure thereof as described above, it is possible to control electric power, which is supplied to the filaments belonging to the same group, in block by one control signal. For this reason, it becomes possible to efficiently control electric power supplied to the filaments of each multi-filament lamp L1 by a comparatively simple structure.

Hereafter, such a structure will be described in detail. For convenience of explanation, a configuration example of the first power supply section 7-1 corresponding to the lamp unit LU1 shown in FIG. 7 is used. In addition, a workpiece is a semiconductor wafer as described above, and a guard ring is not used in the description set forth below. In the structure and arrangement of the lamp unit LU1 shown in FIG. 7, the filaments 3-1, 1-1, 2-1, and 4-1 which correspond to the zone 1 (a wafer central zone) are configured as a first filament group. Similarly, the filaments 3-2, 1-2, 2-2, and 4-2 which correspond to the zone 2 are configured as a second filament group, the filaments 3-3, 1-3, 2-3, and 4-3 which correspond to the zone 3 are configured as a third filament group, the filaments 7-1 and 5-1 which correspond to the zone 4, are configured as a fourth filament group, and the filaments 6-1 and 8-1 which correspond to the zone 5, are configured as a fifth filament group. The first power supply section 7-1 controls electric power supplied to the respective filaments belonging to each filament group in block. That is, the respective filaments which correspond to the wafer edge portion zone which is the same concentric circle, are further divided so that the second, third, fourth, and fifth filament groups may be formed, and the first power supply section 7-1 controls electric power supplied to the respective filaments belonging to each of the groups in block.

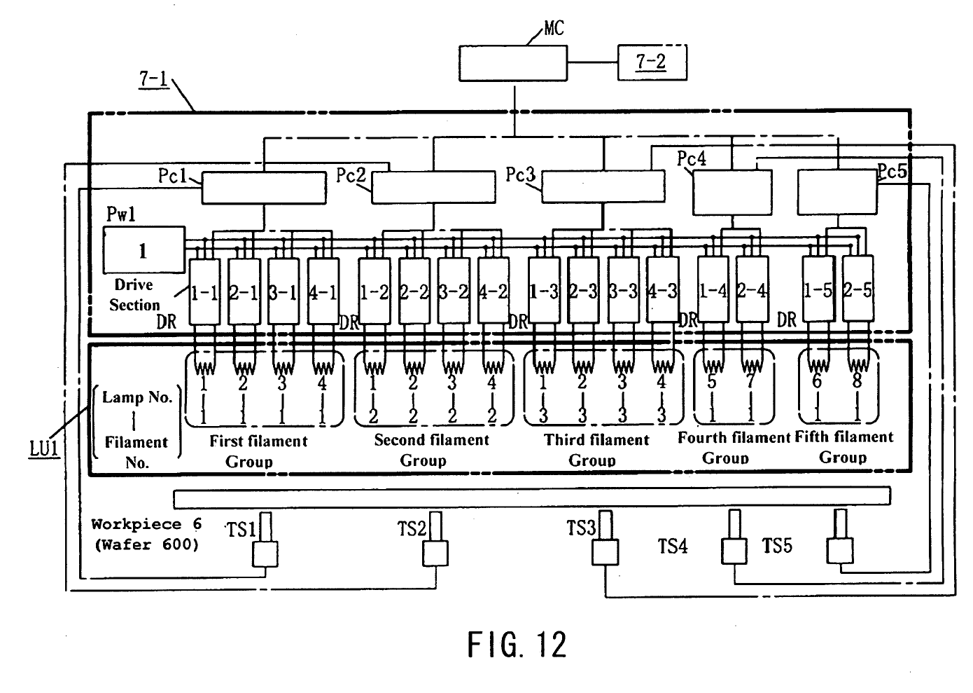

FIG. 12 is a diagram showing the structure of the first power supply section 7-1. As shown in FIG. 12, electric power is supplied to the filaments by drive sections DR1-1 to DR2-5 which are individually and respectively connected to the respective filaments. The drive sections DR1-1 to DR2-5 adjust electrical energy supplied from an electric power supply Pw1, and supplies the electric power to the respective filaments, based on instructions from electric power control units Pc1-Pc5.

Electric power is supplied to the filament 1-1 of the first filament group corresponding to the zone 1 which is the wafer central zone, by the drive section DR1-1. Similarly, the electric power is supplied to the filaments 2-1, 3-1, and 4-1 by the drive sections DR2-1, DR3-1, and DR4-1, respectively. Here, the drive section DR1-1 adjusts electrical energy supplied from the electric power supply Pw1, so that the intensity of light emitted from the filament 1-1 when power is supplied, may be a predetermined value, and the adjusted electric energy is supplied to the filament 1-1. Similarly, the drive sections DR2-1, DR3-1, and DR4-1 adjust electrical energy supplied from the electric power supply Pw1, so that the intensity of light emitted from the filaments 2-1, 3-1, and 4-1 may be a predetermined value(s), and the adjusted electric energy is respectively supplied to the filaments 2-1, 3-1, and 4-1. In addition, when the drive sections are generically referred to as a drive section DR, and the electric power control units are also generically referred to as an electric power control unit Pc, below.

In this case, it is necessary to set the illuminance so as to be approximately uniform at a predetermined value in the zone 1. The intensity of light emitted from each of the filaments 1-1, 2-1, 3-1, and 4-1, is adjusted to a predetermined value respectively, so that the illuminance on the zone 1 may become approximately uniform with a predetermined value. In this case, in order to make an understanding of the present embodiment easy, it is assumed that, in the zone 1, there is no diffraction of light emitted from filaments corresponding to other zones. In such a case, it is necessary to adjust the intensity of light emitted from each of the filaments 1-1, 2-1, 3-1, and 4-1 so as to become the approximately same value. Therefore, electrical energy supplied to each of the filaments 1-1, 2-1, 3-1, and 4-1, is adjusted so that the intensity of light emitted from each of the filaments 1-1, 2-1, 3-1, and 4-1 may become approximately the same with a predetermined value.

The electric power control unit Pc1 sends, to the drive sections DR1-1, DR2-1, DR3-1, and DR4-1, a command signal with which the illuminance of the zone 1 becomes approximately uniform with a predetermined value. The command signal to each drive section is the same signal. When the command signal is inputted into each of the drive sections DR1-1, DR2-1, DR3-1, and DR4-1, electrical energy supplied to each of the filaments 1-1, 2-1, 3-1, and 4-1 is adjusted, so that the intensity of light emitted from each of the filaments 1-1, 2-1, 3-1, and 4-1 may become approximately the same with a predetermined value. The intensity of light emitted from each of the filaments 1-1, 2-1, 3-1, and 4-1, which is adjusted, is the light intensity by which the illuminance of the zone 1 becomes approximately uniform with a predetermined value. That is, operations of the drive sections DR1-1, DR2-1, DR3-1, and DR4-1 for supplying electric power to the respective filaments 1-1, 2-1, 3-1, and 4-1 which form the first filament group corresponding to the zone 1, is controlled in block by the same command signal from the electric power control unit Pc1.

Similarly, it is necessary to set the illuminance on each of the zones 2, 3, 4, and 5 with a predetermined value so as to be approximately uniform. Therefore, it is necessary to set up the intensity of the light emitted from each of the filaments which form the second filament group corresponding to the zone 2, each of the filaments which form the third filament group corresponding to the zone 3, each of the filaments which form the fourth filament group corresponding to the zone 4, and each of the filaments which form the fifth filament group corresponding to the zone 5, so as to become approximately the same as the respective predetermined values. In order to realize such a setup, each of the drive sections corresponding to the second filament group, each of the drive sections corresponding to the third filament group, each of the drive sections corresponding to the fourth filament group, and each of the drive sections corresponding to the fifth filament group, individually adjust electrical energy which is supplied to each of the filaments belonging to each filament group. In addition, as described above, it is assumed that, in each zone, there is no diffraction of light emitted from filaments corresponding to other zones.

Operations of the drive sections DR1-2, DR2-2, DR3-2, and DR4-2 for supplying electric power to the respective filaments 1-2, 2-2, 3-2, and 4-2 which form the second filament group corresponding to the zone 2, are controlled in block by the same command signal from the electric power control unit Pc2. Operations of the drive sections DR1-3, DR2-3, DR3-3, and DR4-3 for supplying electric power to the respective filaments 1-3, 2-3, 3-3, and 4-3 which form the third filament group corresponding to the zone 3, are controlled in block by the same command signal from the electric power control unit Pc3. Further, operations of the drive sections DR1-4 and DR2-4 for supplying electric power to the respective filaments 5-1 and 7-1 which form the fourth filament group corresponding to the zone 4, are controlled in block by the same command signal from the electric power control unit Pc4. Moreover, operations of the drive sections DR1-5 and DR2-5 for supplying electric power to the respective filaments 6-1 and 8-1 which form the fifth filament group corresponding to the zone 5, are controlled in block by the same command signal from the electric power control unit Pc5.

On the other hand, each of the filament lamps L1 including the multi-filament lamps, which form the lamp unit LU1, as described above, is configured so as to be able to deal with a high speed respond of the illuminance control on a workpiece, and is subject to feedback control based on the temperature signal from the temperature sensor of the workpiece, so that the temperature of the whole workpiece surface may become uniform. As shown in FIG. 7, the temperature sensors which measure the temperatures of the respective zones are arranged at the respective zones 1-5. That is, the temperature sensors TS1, TS2, TS3, TS4, and TS5 are arranged approximately at respective central parts of the zones 1, 2, 3, 4, and 5.

Temperature patterns corresponding to workpiece heat treatments are set in each electric power control unit Pc in advance. The temperature patterns correspond to, for example, three periods, that is, a temperature raising period of a workpiece, a constant temperature holding period, and a temperature lowering period, in time line. And the zone temperature information from the temperature sensors TS1-TS5 is compared with the temperature patterns which are in advance set in each electric power control unit Pc. Each electric power control unit Pc controls the drive section DR so that the temperature information of each zone may be in agreement with the temperature pattern.

As described above, in the first power supply section 7-1, the drive section DR which supplies electric power in electrical energy to filaments belonging to each filament group, is in block controlled by the same control signal (command signal) from the electric power control unit Pc provided for each filament group. Moreover, this control signal turns into a feedback signal based on the temperature information of each zone. That is, the first power supply section 7-1 controls power supply to each filament group in a feed back manner, based on the temperature information of each zone, so that the illuminance in each zone is controlled and the temperature of the workpiece in a heat treatment is held to be approximately uniform. In addition, each of the power supply apparatuses 62-64 shown in FIG. 6 is equivalent to the electric power supply Pw1 and each drive section DR. Moreover, the first power supply section 7-1 shown in FIG. 6 is equivalent to all of the electric power control unit Pc, the electric power supply Pw1 and each drive section DR, shown in FIG. 12.

Next, the structure for in block carrying out, in a feedback manner, a control of an operation of a drive section which supplies power in electrical energy to the filaments belonging to a filament group corresponding to one of the zones will be descried below in detail. Hereafter, an example of control of the first filament group corresponding to the zone 1 shown in FIG. 7 will be described. The filaments 3-1, 1-1, 2-1, and 4-1 belonging to the first filament group corresponding to the zone 1 are arranged in order from the left-hand side of the figure as shown in FIG. 7. Moreover, the length of each filament is also set up so as to correspond to the circular zone 1. That is, the length(s) of the filaments 3-1 and 4-1 are shorter than that (those) of the filaments 1-1 and 2-1. As described above, in order to make the illuminance in the zone 1 approximately uniform at a predetermined value, it is necessary to set the intensity of light emitted from each of the filaments 3-1, 1-1, 2-1, and 4-1 when power is supplied, so as to be approximately uniform.

When the illuminance on the zone 1 is set to a predetermined value, the radiation density (W/cm²) which is radiant energy per unit time and unit area in the zone 1 is determined. When an interval(s) (cm) of the bulbs (light emission bulb) of the lamps are determined, electric power per unit length of a filament is determined. The electric power per unit length is referred to as electric power density (W/cm). The electric power density (W/cm) is expressed by the product of radiation density (W/cm2) and an interval (cm) of the bulbs (light emission bulb). The rated power of a filament is expressed by the product of electric power density (W/cm) and the length (cm) of the filament. If rated power is consumed in the filaments, the illuminance on the zone 1 will be set as a predetermined values.

On the other hand, in general, a filament is usually formed in the shape of a coil by winding a filament wire in a predetermined winding pitch. The resistance of a filament is determined by values of the diameter of a filament wire, the diameter of the coil, and a winding pitch of the coil. Since, in each lamp, the diameter of the filament wire, the diameter of the coil, and the winding pitch of the coil are identically designed, the resistance of each of the filaments has a predetermined value (same value). When voltage impressed to the filament is referred to as rated voltage in case where rated power is consumed in the filament, the rated voltage is determined from the rated power of the filament and resistance thereof. Since, as described above, all the lengths of the filaments 3-1, 1-1, 2-1, and 4-1 belonging to the first filament group are not the same as one another, values of rated power respectively expressed by the product of electric power density (W/cm) and the lengths (cm) of the respective filaments are not the same as one another.

An example in which the rated voltage of each filament is set up identically will be described below. As described above, the rated voltage is determined based on the rated power of each filament and a resistance thereof. Since, as described above, values of rated power of the filaments 3-1, 1-1, 2-1, and 4-1 are different from one another, in order to identically set values of the rated voltage of the filaments 3-1, 1-1, 2-1, and 4-1, it is necessary to set values of the resistance of the filaments 3-1, 1-1, 2-1, and 4-1 to a predetermined value. However, since, in each lamp, the values of the diameter of a wire of the filament, the diameter of a coil, and the winding pitch of a coil are usually identically designed as described above, the values of resistance of the filaments 3-1, 1-1, 2-1, and 4-1 are different from one another. Therefore, the rated voltage of these filaments cannot be identically set up. That is, it is necessary to impress predetermined rated voltages having values different from one another, to the filaments having the lengths different from one another. By impressing the predetermined values of rated voltage to the respective filaments 3-1, 1-1, 2-1, and 4-1, the illuminance on the zone 1 is set to a predetermined value. Since, in general, the electric power supply Pw1 is commercial power supply, voltage impressed to a load by the electric power supply Pw1 is constant. In order to impress the predetermined values of rated voltage to these filaments 3-1, 1-1, 2-1, and 4-1 respectively, the drive section DR needs to respectively adjust the voltage applied to these filaments which are the load.

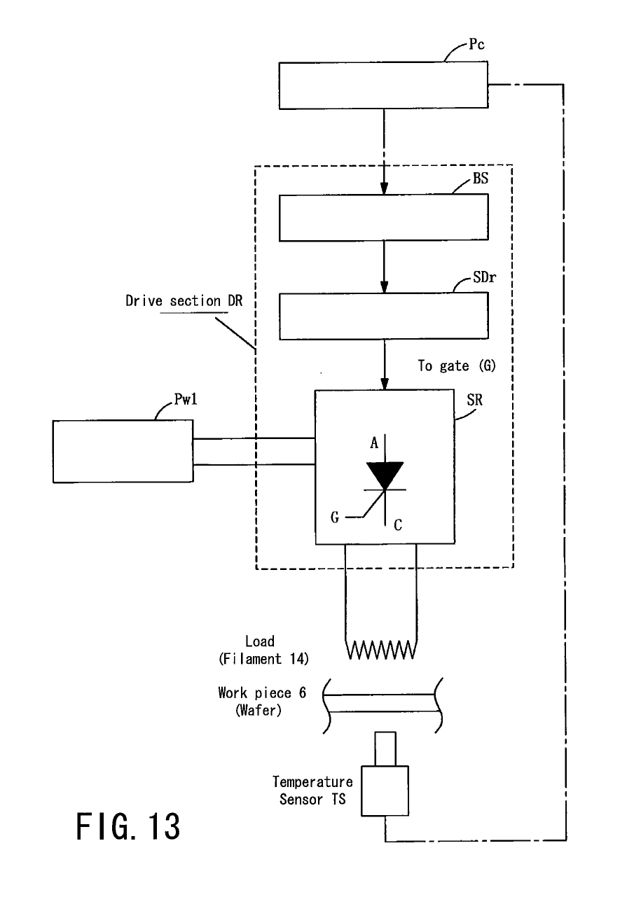

Description of a detailed configuration example of the drive section will be given below, referring to FIG. 13. FIG. 13 shows a detailed block diagram of the drive section DR. As shown in FIG. 13, the drive section DR includes a bias setting section BS, a thyristor driver section SDr, and a thyristor SR. A filament 14 which is a load is connected to the electric power supply Pw1 through the thyristor SR. In this structure, voltage applied to the filament 14 which is load is adjusted by the drive section DR.

As described above, the electric power control unit Pc transmits, to the drive section DR, a command signal, by which the illuminance of a certain zone is made approximately uniform with a predetermined value. For example, the bias setting sections BS for the drive sections DR1-1 to DR4-1 set respective biases to voltages impressed from the electric power supply Pw1 to the filaments 3-1, 1-1, 2-1, and 4-1 which are a load, based on the command signal, so that values of the intensity of light emitted from these filaments 3-1, 1-1, 2-1, and 4-1, are approximately the same as one another, whereby rated voltages are impressed to the respective filaments 3-1, 1-1, 2-1, and 4-1. Since, as described above, the values of the rated voltages impressed to the respective filaments are not the same as one another, the bias values respectively set in the bias setting sections BS for the drive sections DR1-1 to DR4-1 which are connected to the respective filaments are not the same as one another, either. Since each bias setting section BS can individually set the bias, independent of the others, it is possible to set values of the rated voltages impressed to these filaments 3-1, 1-1, 2-1, and 4-1 so as to be the respective predetermined values, by the same command signal from the electric power control unit Pc1.

When the bias is set in each bias setting section BS, the bias setting section BS transmits a drive signal to the thyristor drive section SDr. The thyristor drive section SDr applies the predetermined bias to voltage impressed to the load (filament 14) from the electric power supply Pw1, based on the drive signal from the bias setting section BS, whereby the thyristor SR is operated so that the voltage impressed to the filament 14 may become rated voltage. For example, a negative value is set to the bias. By configuring the drive section DR as described above, predetermined rated voltages are impressed to these filaments, respectively, by the same signal from the electric power control unit Pc, so that it is possible to control them in block. In addition, although FIG. 13 shows an example where the thyristor SR is used for the drive section DR, the structure of the drive section is not limited thereto. For example, a PWM control system which uses a switching element may be adopted for the drive section DR.

As described above, the command signal transmitted from each electric power control unit Pc to the drive section DR is based on a comparison operation of the temperature information from each of the temperature sensors TS1-TS5 formed in the respective zones, and the temperature patterns set in advance in the electric power control unit Pc. That is, the command signal in block transmitted to each of the drive sections DR1-1, DR2-1, DR3-1, and DR4-1 from the electric power control unit Pc1, is set by the comparison operation of the temperature patterns set in advance in the electric power control unit Pc1, with the temperature information of the zone 1 from the temperature sensor TS1. In detail, the command signal is set so that a difference between the temperature pattern and the temperature information of the zone 1 may become small. The command signal in block transmitted to each of the drive sections DR1-2, DR2-2, DR3-2, and DR4-2 from the electric power control unit Pc2 is set by the comparison operation of the temperature patterns set in advance in the electric power control unit Pc2, with the temperature information of the zone 2 from the temperature sensor TS2.

Similarly, the command signal in block transmitted to each of the drive sections DR1-3, DR2-3, DR3-3, and DR4-3 from the electric power control unit Pc3, is set by the comparison operation of the temperature patterns set in advance in the electric power control unit Pc3 with the temperature information of the zone 3 from the temperature sensor TS3. The command signal in block transmitted to each of the drive sections DR1-4 and DR2-4 from the electric power control unit Pc4, is set up by the comparison operation of the temperature patterns set in advance in the electric power control unit Pc4, with the temperature information of the zone 4 from the temperature sensor TS4. The command signal in block transmitted to each of the drive sections DR1-5 and DR2-5 from the electric power control unit Pc5, is set up by the comparison operation of the temperature patterns set in advance in the electric power control unit Pc5, with the temperature information of the zone 5 from the temperature sensor TS5. By configuring the structure thereof as described above, the predetermined rated voltage is respectively impressed to each filament, based on the temperature information on each of the zones from each of the temperature sensors TS1-TS5, by the same signal from the electric power control unit Pc, whereby it is possible to carry out a feedback control.

(b) Configuration Example of Second Power Supply Section 7-2

The lamp unit LU2 to which the second power supply section 7-2 supplies electrical energy is configured by arranging the two or more straight-bulb single filament lamps L2 in parallel at predetermined intervals, wherein the filament of each single filament lamp L2 has a large diameter of filament line, so that large electric power can be applied to each filament lamp L2. Moreover, without taking into consideration the zones 1, 2, 3, 4, and 5, the number of the single filament lamps L2 and the length(s) of these filaments thereof are determined so as to irradiate the whole workpiece with light. That is, the lamp unit LU2 has a function of raising the temperature of the whole workpiece at a high speed.

The second power supply section 7-2 supplies electrical energy to the lamp unit LU2 so that, for example, the illuminance distribution on an irradiation area to be irradiated with light emitted from the lamp unit LU2 may become approximately uniform. In addition, the illuminance distribution on the irradiated area to be irradiated with light emitted from the lamp unit LU2 may not necessarily be approximately uniform. When the lamp unit LU2 emits light together with the lamp unit LU1, if the temperature distribution on the surface of a workpiece can be set uniform, the illuminance distribution attributed to the light emitted from the lamp unit LU2 may be even specific illuminance distribution. The length of each of the filaments of the two or more single filament lamps L2 which form the lamp unit LU2 as shown in FIG. 8, is adjusted so as to be able to emit light to the whole workpiece. Therefore, the length of each filament is not necessarily the same. As explained approximately the first power supply section 7-1 above, the rated voltage impressed to each single filament lamp L2 is not necessarily the same due to the length of the filament.

An electric power control unit is provided for every single filament lamp L2 whose rated voltage values differ from one another so that each single filament lamp L2 may be controlled. However, it is necessary to provide a plurality of such electric power control units, and the structure thereof becomes complicated. In the configuration example of the second power supply section 7-2 which is described below, the second power supply section 7-2 is configured to have the drive section which is individually connected to each of filaments of two or more single filament lamps L2 which form the lamp unit LU2 and which supplies electric power to each filament in electrical energy, and the electric power control unit which controls the drive section in block.

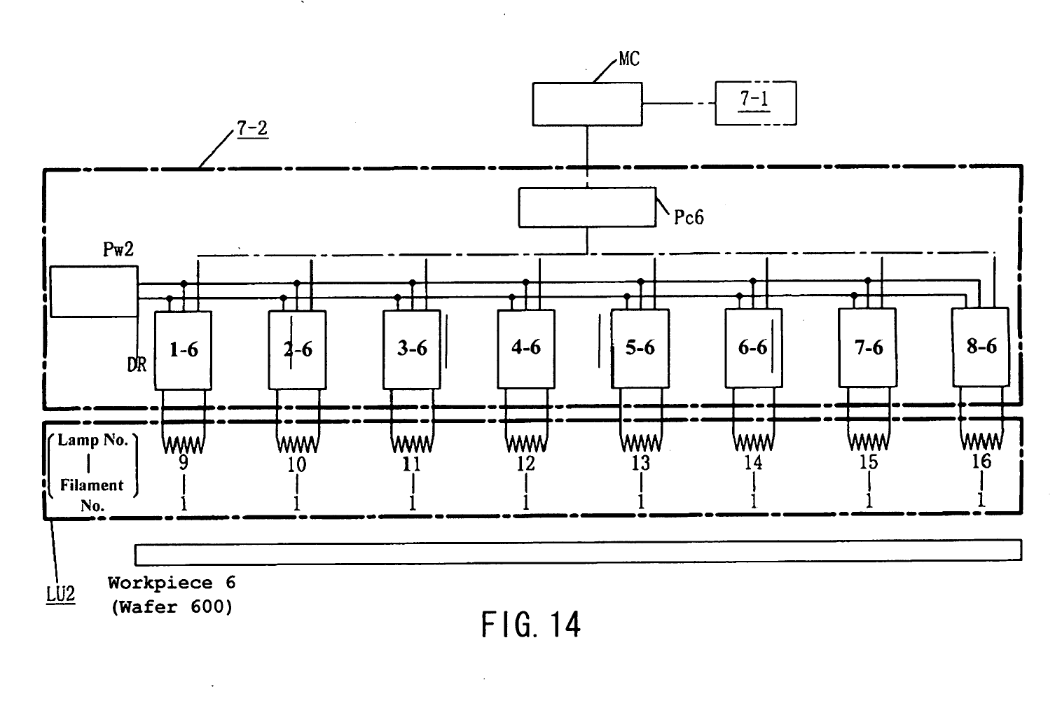

By configuring the structure thereof as described above, it is possible to efficiently control supply of electric power to the filaments of the two or more single filament lamps L2 whose rated voltage values differ from one another by a comparatively simple structure. Hereafter, such a structure will be described below. For convenience of explanation, described below is a configuration example of the second power supply section 7-2 corresponding to the lamp unit LU2 in which the guard ring 5 shown in FIG. 8 is not taken into consideration. In addition, a semiconductor wafer is used as a workpiece as an example. FIG. 14 is a diagram showing the structure of the second power supply section 7-2. As shown in FIG. 14, electric power is supplied to each filament by a corresponding one of drive sections DR1-6 to DR8-6 which are individually connected to of the respective filaments. By instructions from the electric power control unit Pc6, the drive sections DR1-6 to DR8-6 adjust electrical energy supplied from the electric power supply Pw2, and supply the adjusted electric power to the respective filaments.

That is, electric power is supplied to the filament 9-1 by the drive section DR 1-6. Similarly, electric power is supplied to filaments 10-1, 11-1, 12-1, 13-1, 14-1, 15-1, and 16-1 by the respective drive sections DR2-6, DR3-6, DR4-6, DR5-6, DR6-6, DR7-6, and DR 8-6. The drive section DR 1-6 adjusts electrical energy supplied from the electric power supply Pw2, and supplies the adjusted electrical energy to a filaments 9-1, so that a value of the intensity of light emitted from the filament 9-1 may become a predetermined value at time of power distribution. Similarly, the drive sections DR2-6, DR3-6, DR4-6, DR5-6, DR6-6, DR7-6, and DR8-6 adjust electrical energy supplied from the electric power supply Pw2, and respectively supply the adjusted electrical energy to filaments 10-1, 11-1, 12-1, 13-1, 14-1, 15-1, and 16-1, so that the intensity of light emitted from filaments 10-1, 11-1, 12-1, 13-1, 14-1, 15-1, and 16-1 at time of power distribution may become a predetermined value. In addition, hereinafter, the drive sections are generically referred to as a drive section DR.

In this case, the illuminance distribution on the wafer (workpiece) surface is set so as to be a predetermined value, and approximately uniform. That is, the intensity of light emitted from each of the filament 9-1, 10-1, 11-1, 12-1, 13-1, 14-1, 15-1, and 16-1, is adjusted to approximately the same value, so that the illuminance distribution on the wafer surface may become approximately uniform with a predetermined value. Therefore, electrical energy supplied to each of the filaments 9-1, 10-1, 11-1, 12-1, 13-1, 14-1, 15-1, and 16-1, is adjusted so that the intensity of light emitted from each of the filaments 9-1, 10-1, 11-1, 12-1, 13-1, 14-1, 15-1, and 16-1 may become approximately the same with a predetermined value. In addition, as described above, when the lamp unit LU1 emits light together with the lamp unit LU2, if the temperature distribution on the surface of a workpiece can be set uniform, the illuminance distribution attributed to light emitted from the lamp unit LU2 may be specific illuminance distribution. Therefore, the light intensity is also suitably adjusted according to the illuminance distribution on the wafer surface which has been set. Hereinafter, as an example, a case where the illuminance distribution on an area to be irradiated with light emitted from the lamp unit LU2 is made approximately uniform, will be described.

The electric power control unit Pc6 respectively transmits a command signal by which the illuminance on the surface of the wafer becomes approximately uniform with a predetermined value, to the drive sections DR 1-6, DR 2-6, DR 3-6, DR 4-6, DR 5-6, DR 6-6, DR 7-6, and DR 8-6. Here, the command signal sent to each drive section DR turns into the same signal. When the command signal is inputted in each of the drive sections DR 1-6, DR 2-6, DR 3-6, DR 4-6, DR 5-6, DR 6-6, DR 7-6, and DR 8-6, the electrical energy supplied to each of the filaments 9-1, 10-1, 11-1, 12-1, 13-1, 14-1, 15-1, and 16-1 is adjusted, so that the intensity of light emitted from each of the filament 9-1, 10-1, 11-1, 12-1, 13-1, 14-1, 15-1, and 16-1 may become approximately the same with a predetermined value. The intensity of light emitted from each of the filaments, 9-1, 10-1, 11-1, 12-1, 13-1, 14-1, 15-1, and 16-1, which is adjusted to be approximately the same, is the intensity of light by which the illuminance on the surface of the wafer becomes approximately uniform with a predetermined value. Operations of the drive sections DR1-6, DR2-6, DR3-6, DR4-6, DR5-6, DR6-6, DR7-6, and DR8-6, which supplies electric power to the respective filaments 9-1, 10-1, 11-1, 12-1, 13-1, 14-1, 15-1, and 16-1, are in block controlled by the same command signal from the electric power control unit Pc6.

As described above, the single filament lamps L2 which form the lamp unit LU2 are capable of raising a workpiece temperature at a high speed, and do not take charge of local illuminance control. That is, the single filament lamps L2 are lighted in a predetermined control pattern (preset program). The temperature pattern corresponding to a heat treatment of a workpiece is in advance set in the electric power control unit Pc6. The temperature pattern corresponds to, for example, three periods, that is, a temperature raising period of a workpiece, a constant temperature holding period, and a temperature lowering period, in time line, and also is set as the temperature pattern in the electric power control units Pc1, Pc2, Pc3, Pc4, and Pc5 of the first power supply section 7-1. The electric power control unit Pc6 controls the drive section drive sections DR1-6, DR2-6, DR3-6, DR4-6, DR5-6, DR6-6, DR7-6, and DR8-6, based on this temperature pattern.

As described above, in the second power supply section 7-2, the drive section DR which supplies electric power in electrical energy to each filament, is controlled in block by the same control signal from the electric power control unit Pc6 (command signal). This control signal is set according to the control pattern (preset program) based on the temperature pattern set in advance in the electric power control unit Pc6. That is, in the respective periods which each temperature pattern sets, the second power supply section 7-2 controls the lamp unit LU2 so that the illuminance on the surface of the wafer is, for example, approximately uniform. In addition, as described above, it is not necessary to set the illuminance distribution on the surface of the wafer, which is caused by irradiating the wafer with light emitted from the lamp unit LU2, to be approximately uniform. The illuminance distribution may be set so as to be a predetermined illuminance distribution. The power supply apparatus 65 shown in FIG. 6 corresponds to the electric power supply Pw6 and each drive section DR. Moreover, the second power supply section 7-2 corresponds to the electric power control unit Pc6, the electric power supply Pw2, and each drive section DR, shown in FIG. 14.

Next, the structure for controlling, in block, an operation of each drive section which supplies electrical energy to each filament of two or the more single filament lamps L2 which form the lamp unit LU2 will be described below in detail. The filaments of the two or more single filament lamps L2 which form the lamp unit LU2 as shown in FIG. 8 are arranged in order of filaments 9-1, 10-1, 11-1, 12-1, 13-1, 14-1, 15-1, and 16-1 from the left-hand side of FIG. 8. Moreover, in order to irradiate the entire workpiece with light, the length of each filament is also set according to the shape of the workpiece. In order to make an understanding of the present embodiment easy, the lengths of filaments 12-1 and 13-1 are equal to each other. Similarly, the lengths of filaments 11-1 and 14-1, the lengths of filaments 10-1 and 15-1, and the lengths of filament 9-1 and 16-1, are also respectively equal to each other. That is, the length of the filaments 12-1 and 13-1 are longer than that of the other filaments. Hereafter, the length of the filaments 9-1 and 16-1 is shorter than that of the filaments 10-1 and 15-1, which is shorter than that the filaments 11-1 and 14-1.

Thus, the lamp unit LU2 has four kinds of single filament lamps L2 whose filament lengths differ from one another. Therefore, as described above, it is necessary to impress to them, rated voltages which are in advance respectively determined according to (the lengths) of the filaments whose lengths are different from one another. By impressing the predetermined rated voltage to each of the filaments 9-1, 10-1, 11-1, 12-1, 13-1, 14-1, 15-1, and 16-1, it is possible to adjust the intensity of light emitted from each filament at time of power distribution to be, for example, approximately uniform, whereby the illuminance distribution on the zone 1 of the surface of the wafer is set to, for example, a predetermined value so as to be approximately uniform. Since, in general, the electric power supply Pw2 is commercial power supply, voltage impressed to a load by the electric power supply Pw2 is constant. In order to impress the rated voltages with the predetermined values to these filaments 9-1, 10-1, 11-1, 12-1, 13-1, 14-1, 15-1, and 16-1, respectively, the drive section DR needs to respectively adjust the voltage applied to these filaments which are the load.

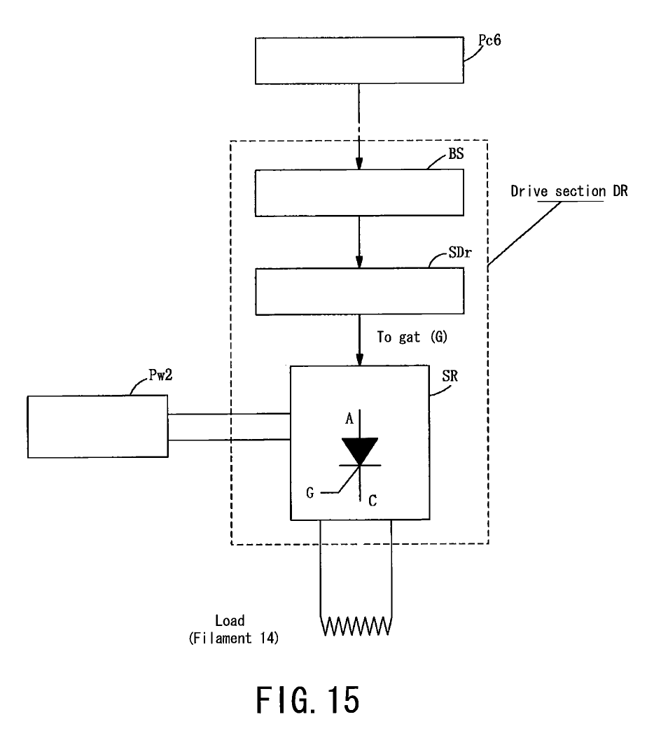

FIG. 15 shows a detailed configuration example of the drive section. FIG. 15 is a detailed block diagram of the drive section DR. As shown in FIG. 15, the drive section DR consists of a bias setting section BS, a thyristor driver section SDr, and a thyristor SR. The filaments which form a load are connected to the electric power supply Pw2 through the thyristor SR. In this structure, voltages applied to the respective filaments which form a load are adjusted by the drive section DR. As described above, an electric power control unit Pc6 transmits, to the drive section DR, a command signal by which the illuminance on the surface of a wafer becomes approximately uniform with a predetermined value. Based on the command signal, the bias setting sections BS of the drive sections DR1-6 to DR8-6, set biases to the voltages impressed, from the electric power supply Pw2, to the filaments 9-1 to 16-1 which are a load so that the intensity of light emitted from each of the filaments 9-1 to 16-1 may become the approximately same value, whereby the rated voltage is impressed to each of the filaments 9-1 to 16-1.

As described above, since the rated voltage impressed to each filament is not the same as one another, the settings of the bias setting sections BS for the respective drive sections DR1-6 to DR8-6 which are connected to the respective filaments are not the same, either. Since each of the bias setting sections BS can set bias individually, by the same command signal from the electric power control unit Pc6, it is possible to set these biases so that values of the rated voltage respectively impressed to the filaments 9-1 to 16-1 may be predetermined values.

When the bias is set in each bias setting section BS, the bias setting section BS transmits a drive signal to the thyristor drive section SDr. The thyristor drive section SDr applies the predetermined bias to voltage impressed to the load (filament 14) from the electric power supply Pw2, based on the drive signal from the bias setting section BS, whereby the thyristor SR is operated so that the voltage impressed to the filament may become the rated voltage. For example, a negative value is set to the bias. By configuring the drive section DR as described above, the predetermined rated voltages are respectively impressed to these filaments, by the same signal from the electric power control unit Pc6, so that it is possible to control them in block. In addition, although FIG. 15 shows an example where the thyristor SR is used for the drive section DR, the structure of the drive section is not limited thereto. For example, a PWM control system which uses a switching element may be adopted for the drive section DR.

### (6) First Embodiment of Heating Method

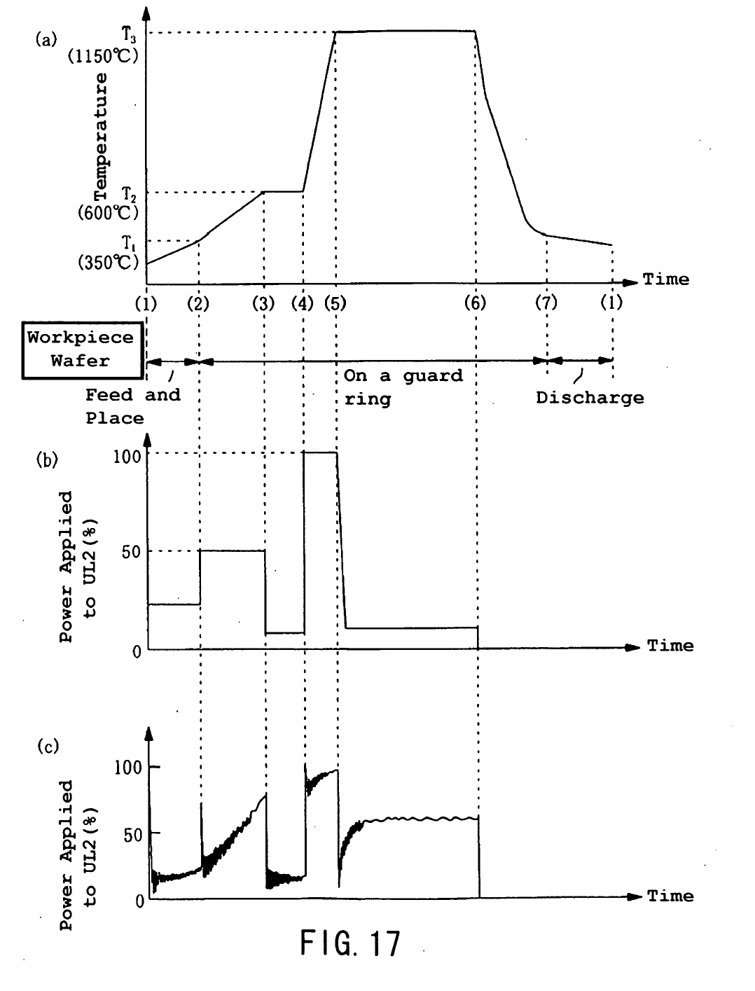

Next, an embodiment of the light emission type heating method according to the present invention will be described. FIG. 17 (a) shows an example of a temperature change (temperature pattern) of the workpiece at time of a heat treatment. Here, the workpiece is a semiconductor wafer (silicon wafer) with a diameter of 300 mm. An example of heat treatment which holds attained temperature of the wafer for a fixed period after raising the temperature of the wafer to 1150 degree Celsius will be described below. A heat treatment process including a process of holding the temperature of the wafer for a fixed period, is applied, for example, when an oxide film forming process is performed as described above. During a period (1)-(2), a wafer (workpiece) is heated to a temperature T1 which is in a range of from a room temperature to approximately 350 degree Celsius. In the period, lighting of each lamp L1 of the lamp unit LU1 and that of each lamp L2 of the lamp unit LU2 starts, and the period is, for example, 10 to 20 seconds. In addition, when large electric power is supplied to each lamp at time of lighting, the power supply section 7 may receive damage under an influence of rush current. Therefore, in order to control the influence of the rush current, small electric power is supplied to each lamp at time of lighting of each lamp. That is, in this period, the wafer is heated from a room temperature to the temperature T1.

In a period (2)-(3), the temperature of the wafer is raised (for example, for 30 seconds) so that an attained temperature may be set between the temperature T1 and a temperature T2. In a period (3)-(4), the wafer is held at the temperature T2. The temperature T2 is in a range of 500 degrees Celsius to 700 degree Celsius, for example, 600 degree Celsius. On the other hand, the temperature holding time is, for example, a couple of seconds to tens of seconds. One of reasons for providing this temperature holding time, is to stabilize operations of filaments of each lamp L1 of the lamp unit LU1 and a filament of each lamp L2 of the lamp unit LU2 before heat treatment, and another reason therefor is to attain stabilization of heat treatment atmosphere (the heat treatment space S2: refer to FIG. 4). In addition, when the radiation thermometer which can measure a high temperature region of more than 1000 degree Celsius with sufficient accuracy, is used as the temperature measuring section 91, the temperature detection limit (minimum temperature which can be measured highly precisely) is approximately 500 degree Celsius, and a temperature measurement error becomes large at the detection limit or lower. Therefore, the wafer in a state of a pre-heat-treatment is comparatively gently raised to the temperature T2 which is approximately 500 degrees C. to 700 degree Celsius. In addition, if a measurement system, such as a thermocouple, in which a temperature can be measured with sufficient accuracy in a comparatively low temperature range, is used as the temperature measuring section 91, in combination with the radiation thermometer in which a high temperature range can be measured with sufficient accuracy, the temperature of the workpiece can be controlled with sufficient accuracy over the entire temperature range.

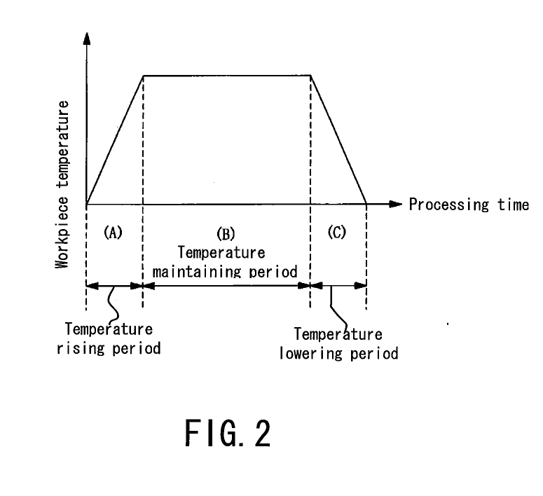

After the heat treatment atmosphere is stabilized, in a period (4)-(5), the temperature of the workpiece is raised until the temperature of the workpiece itself reaches 1150 degree Celsius (shown as T3 in FIG. 17), wherein, for example, the temperature raising time is approximately 5 seconds, and the temperature rising speed is 200 to 400 degree Celsius/sec. This period (4)-(5) is equivalent to the temperature raising period (A) shown in FIG. 2. In a period (5)-(6), the workpiece is held at 1150 degree Celsius. In addition, this period during which it is held at 1150 degree Celsius, is set suitably according to kinds of heat treatments (for example, approximately 60 seconds). This period (5)-(6) is equivalent to the temperature holding period (B) in FIG. 2. After a time point (6), the temperature of the workpiece is lowered. The period after the time period (6) is equivalent to the temperature lowering period (C) shown in FIG. 2. This period is approximately 60 seconds. In order to realize the temperature pattern shown in FIG. 17 (a), a control pattern of electrical energy (applied power) supplied to the lamp unit LU1 and the lamp unit LU2 is determined. That is, the control pattern set in advance in the electric power control unit Pc of the first power supply section 7-1, and the electric power control unit Pc6 of the second power supply section 7-2, are based on the above-mentioned temperature pattern.

A pattern of power applied to the lamp unit LU2 is shown in FIG. 17 (b). As described above, the lamp unit LU2 takes charge only of (1) a workpiece temperature rise at a high speed. A lighting control of each of the lamps L2 which form the lamp unit LU2, is carried out by the control pattern set in advance in the electric power control unit Pc6. Therefore, the power applied to the lamp unit LU2, basically, forms a stairs-like pattern. As shown in FIG. 17 (b), the applied power at the heating-up time of the workpiece (the periods (1)-(2), (2)-(3) and (4)-(5)), is larger than the applied power of the temperature holding period (period (3)-(4) and (5)-(6)) of the workpiece. Moreover, the power applied to the lamp unit LU2 becomes large, as the attained temperature in the temperature raising period is large.

The pattern of the power applied to the lamp unit LU1 is shown in FIG. 17 (c). As described above, the lamp unit LU1 take charge of (2) a high speed response of illuminance control, and (3) good local illuminance control. The lighting of each of lamps L1 which form the lamp unit LU1, is controlled in a feedback manner, based on the control pattern set in advance in the electric power control unit Pc and the temperature information of the workpiece. Therefore, the pattern of power applied to the lamp unit LU1 does not turn into such a stairs-like pattern. In a macroscopic view, the applied power in the temperature raising period of the workpiece (period (1)-(2), (2)-(3) and (4)-(5)), is larger than the applied power of the temperature holding period (the periods (3)-(4) and (5)-(6)) of the workpiece. Moreover, the power applied to the lamp unit LU1 becomes large, as the attained temperature in the temperature raising period is large. However, since the applied power control is the feedback control based on the temperature information, the applied power pattern forms a fine oscillatory wave form, near these turning points (2), (3), (4), and (5) of the temperature pattern.

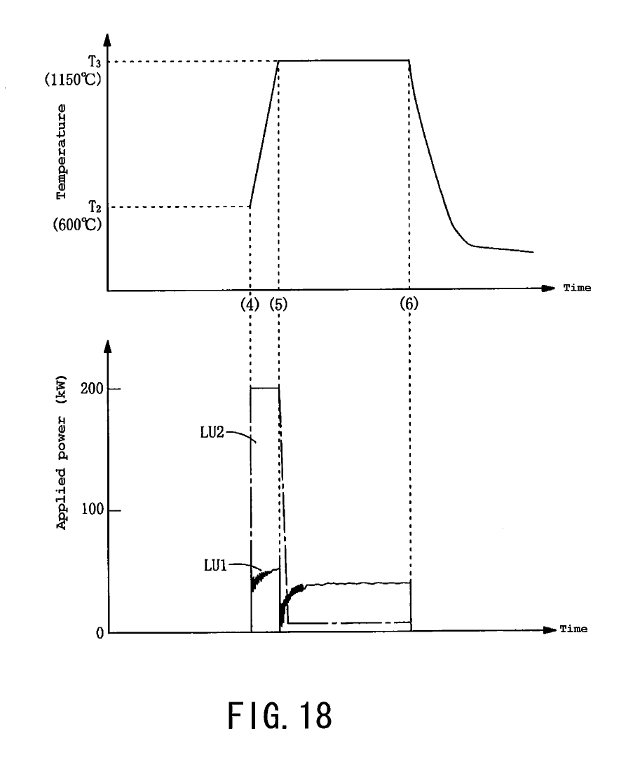

FIG. 18 shows a graph of power applied to the lamp units LU1 and LU2 in the period of (4)-(5) (temperature raising period) and the period (5)-(6), (temperature holding period), so as to compare the size of power applied to the lamp unit LU1 with that of the lamp unit LU2. For example, when the temperature of the workpiece (wafer) is raised to 1150 degree Celsius in the period (4)-(5), the total power applied to the lamp units LU1 and LU2 is approximately 250 kW. The power applied to the lamp unit LU1 is set to 50 kW, and the power applied to the lamp unit LU2 is set to 200 kW. That is, when the power applied to the lamp unit LU1 is represented as A1 and the power applied to the lamp unit LU2 is represented as A2, they are lighted simultaneously under condition of A1<A2 (A1≠0, A2≠0).

Next, when the temperature of the workpiece (wafer) is held at 1150 degree Celsius in the period (5)-(6), the total power applied to the lamp units LU1 and LU2 is approximately 36 kW. As described above, when constant temperature control of the semiconductor wafer (silicon wafer) with a diameter of 300 mm is carried out at 1150 degree Celsius, if its attention is paid only to temperature maintenance, the required electric power which is applied to the filaments of all the filament lamps of the light emission unit is approximately 30 kW. On the other hand, it turned out by experiment of inventors that it was approximately 20% of the total electric power which is applied to the filaments and which is needed for temperature maintenance, in order to perform local illuminance control for maintaining the temperature distribution of the workpiece or a target temperature. Therefore, the electric power applied to the filaments of the filament lamps needed for local illuminance control is set to approximately 6 kW (=30 kW×20%).

Although the temperature of the workpiece (wafer) can be controlled so as to be constant by lighting only the lamp unit LU1, in this case, as shown in FIG. 18, the lamp units LU1 and LU2 are lighted simultaneously. In this embodiment, the power applied to the lamp unit LU1 is set to approximately 30 kW, and power applied to the lamp unit LU2 is set to approximately 6 kW. That is, when the power applied to the lamp unit LU1 in the constant temperature holding period is represented as B1, and the power applied to the lamp unit LU2 in the period is represented as B2, they are lighted simultaneously under condition of B1>B2 (B1≠0, B2≠0). In addition, in case where only the lamp unit LU1 is used, the condition is B2=0 and B1≠0. Since it is necessary to lower the temperature of the workpiece as soon as possible in the temperature lowering period after the time period (6), both of the lamp unit LU1 and the lamp unit LU2 are turned off.

As described above, in the heating method using the present light emission type heating apparatus which, as a light emission unit, has the lamp unit LU1 made up of a group of the lamps L1 including the multi-filament lamps capable of a high speed response, and the lamp unit LU2 made up of a group of the single filaments L2 to which large electric power can be applied, (A) in the temperature raising period, the lamp units LU1 and UL2 are simultaneously lighted under condition of “power applied to the lamp unit LU1 A1”<“power applied to the lamp unit LU2 A2” (A1≠0, A2≠0), (B) in the constant temperature holding period, as described above, (i) only the lamp unit LU1 is lighted when power applied to the lamp unit LU1 is represented as B1 (B1≠0), or both of the lamp units LU1 and LU2 are lighted under condition of “power applied to the lamp unit LU1” B1>“power applied to the lamp unit LU2” B2, and (C) in the temperature lowering period, both of the lamp units LU1 and LU2 are turned off. Therefore, in the high temperature heat treatment mainly comprising three steps, that is, a step of raising a workpiece temperature, a step of maintaining a constant temperature, and a step of lowering the temperature, it is possible to meet all of the conditions, that is, (1) a temperature rise at a high speed, (2) a high speed response of illuminance control, and (3) good local illuminance control.

In addition, in the temperature raising period, the power applied to the lamp unit LU2 is represented as A2 and the power applied to the lamp unit LU1 is represented as A1, and in the constant temperature holding period, the power applied to the lamp unit LU2 is represented as B2 and the power applied to the lamp unit LU1 is represented as B1, the relation of A1, A2, B1, and B2 can be expressed as A2/A1>B2/B1 (A1≠0, A2≠0, B1≠0). As described above, (ii) the lamp unit LU1 performs a control in a feed back manner, so that the temperature of the whole workpiece surface may become uniform, based on a temperature signal from the temperature monitor for a workpiece, which is not shown in FIG. 4, and (iii) since the lamp unit LU2 is lighted in a predetermined electric power pattern (preset program), it is possible to carry out a temperature control without an inference.

Hereafter, steps of a heat treatment of a workpiece in the light emission type heat treatment method according to the present invention, will be described below, referring to FIGS. 4, 6, 16, 17, 19A-19D, 20A-20D, and 21A-21B. Here, the workpiece is a semiconductor wafer (silicon wafer) with a diameter of 300 mm. An example where a thermal oxidation process is carried out as the heat treatment will be described below, as an example. Specifically, the heat treatment during which attained temperature is held for a fixed period after the temperature of the wafer is raised to 1150 degree Celsius, is explained.

The light emission type heating apparatus shown in FIGS. 4 and 6 is used in the present embodiment. In addition, although the guard ring 5 is used in these figures, in order to make an understanding of the present invention easy, the zone division of a guard ring 5 to be irradiated with light is not taken into consideration. As shown in FIG. 7, it is divided into five zones. When the guard ring 5 is used, the number of division of the zone is nine as described above, and the filaments of the respective lamps L1 which form the lamp unit LU1 are also grouped into nine filament groups. Moreover, in the first power supply section 7-1 shown in FIG. 12, the number of the electric power control units Pc is also nine.

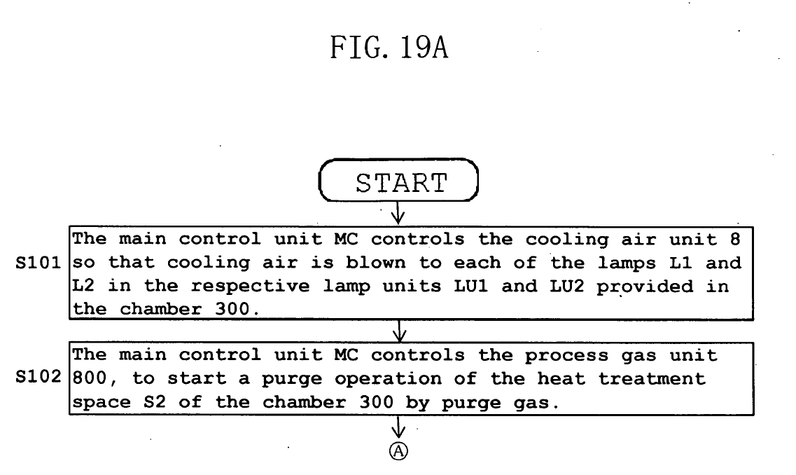

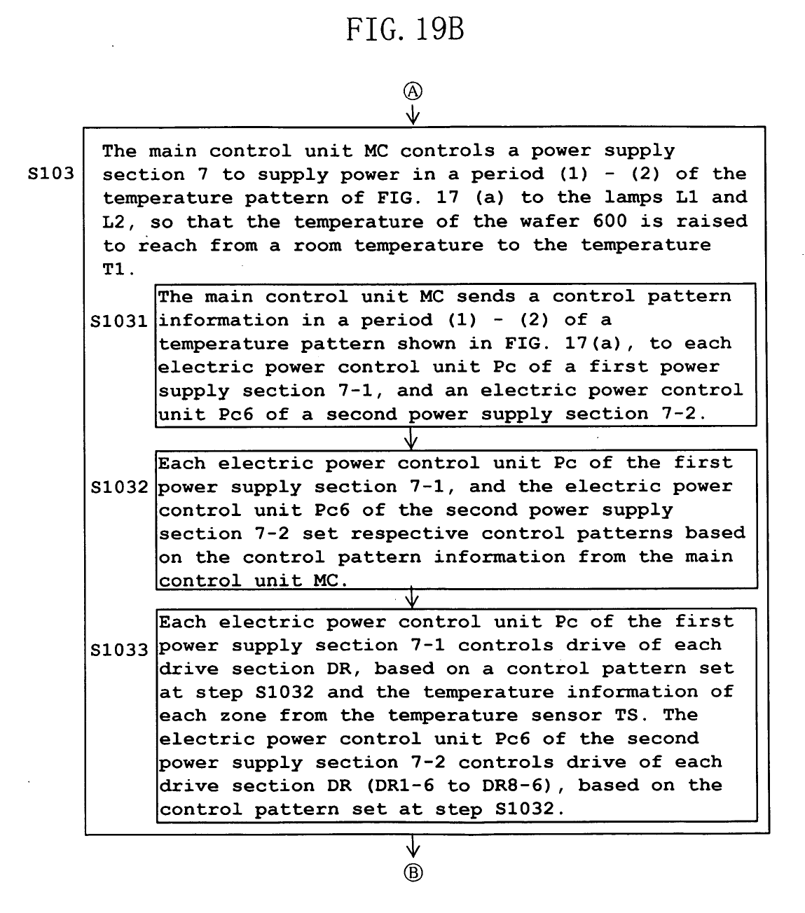

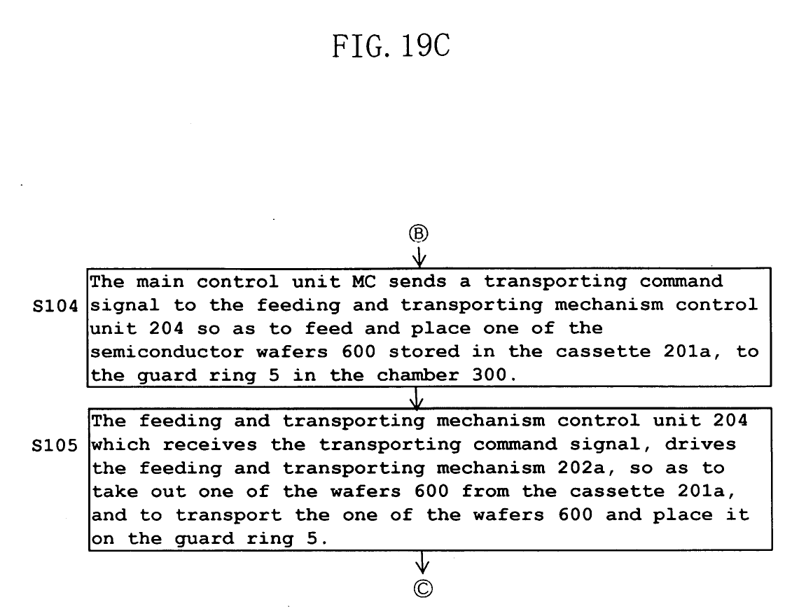

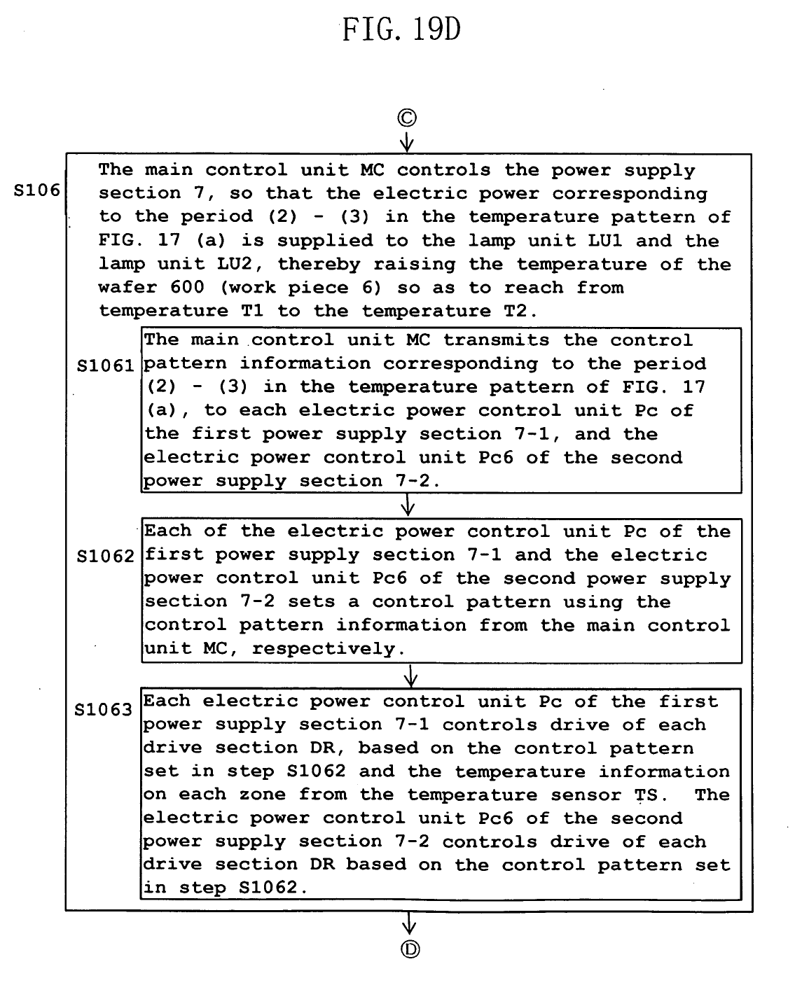

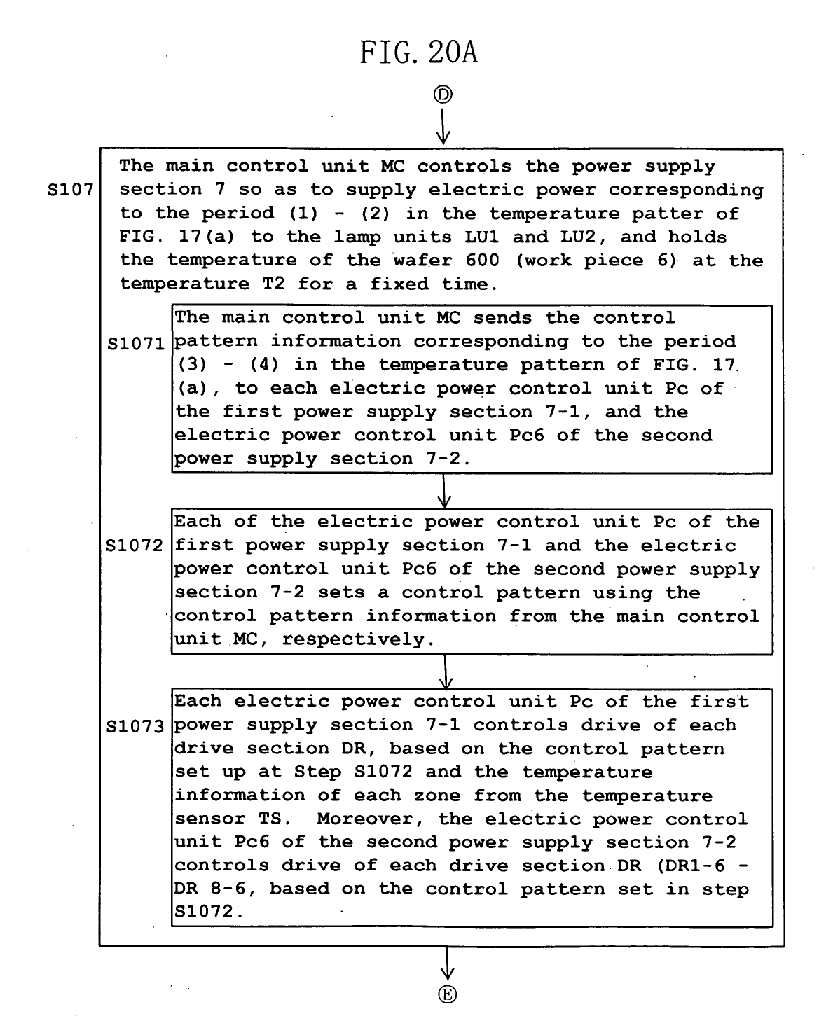

In FIGS. 4 and 6, the main control unit MC controls the cooling air unit 8 so that cooling air is blown to each of the lamps L1 and L2 in the respective lamp units LU1 and LU2 provided in the chamber 300 (Step S101 in FIG. 19A). Moreover, the main control unit MC controls the process gas unit 800 to start a purge operation of the heat treatment space S2 of the chamber 300 by purge gas (for example, nitrogen gas) (Step S102 of FIG. 19A). At this time, the purge gas pressure and the purge gas flow rate of the heat treatment space S2 are controlled by the process gas unit 800 by a predetermined value.

Next, the main control unit MC controls the power supply section 7 connected to each of the lamps L1 which form the lamp unit LU1, and each of the lamps L2 which form the lamp unit LU2, so as to supply electric power corresponding to the period (1)-(2) of the temperature pattern shown in FIG. 17 (a) to the filaments of each lamp L1 of the lamp unit LU1 and the filament of each lamp L2 of the lamp unit LU2, whereby the temperature of the wafer 600 (workpiece 6) is raised so as to reach from a room temperature to the temperature T1 (for example, approximately 350 degree Celsius) (Step S103 in FIG. 19B). In addition, the period (1)-(2) of the temperature pattern is set so that the wafer 600 (workpiece 6) may be taken out from the cassette 201a, and set in the guard ring 5 which is a holding stand.

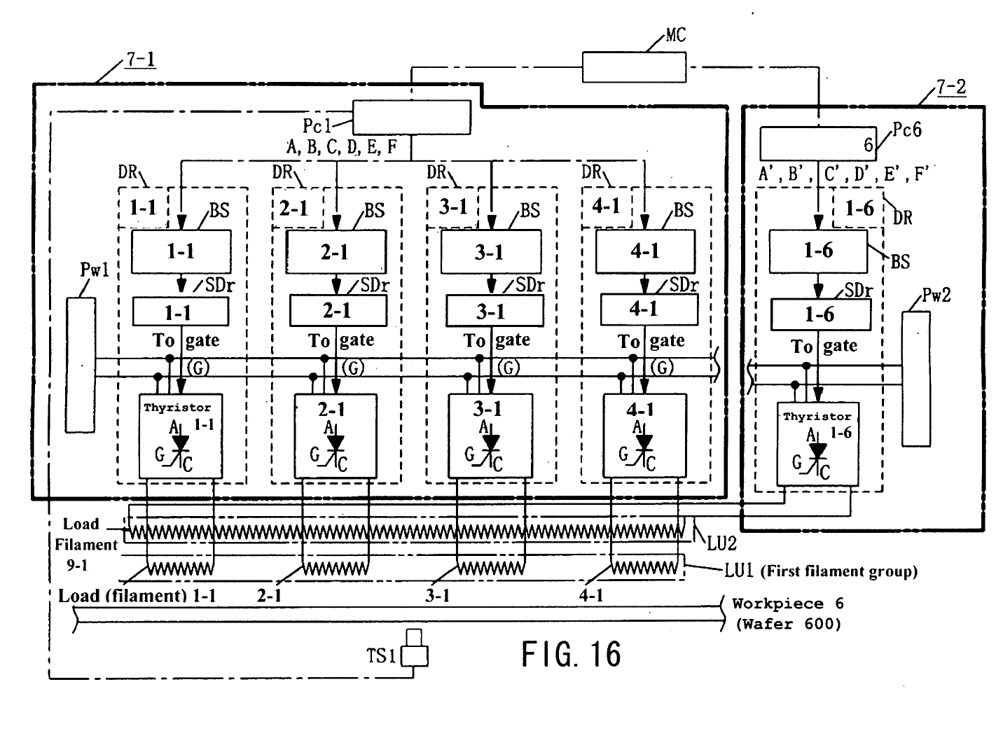

An example of supply of electric power from the power supply section 7 to each filament will be explained below, referring to FIG. 16 which shows the first filament group as to the lamp unit LU1, and the filament 9-1 as an example of the lamp unit LU2. In addition, in order to simplify an understanding of the resent embodiment, as shown in FIG. 7, in this embodiment, the lengths of the filaments 1-1 and 2-1 are equal to each other, and the lengths of the filament 3-1 and 4-1 are equal to each other. In addition, detailed description of the electric power supply to the second, third, fourth and fifth filament group in the lamp unit LU1, and the filaments 10-1, 11-1, 12-1, 13-1, 14-1, 15-1, and 16-1 of the lamp unit LU2 is omitted, since description thereof is the same as that of the first filament group and the filament 9-1.

In Step S103, the main control unit MC sends a control pattern information corresponding to the period (1)-(2) of the temperature pattern shown in FIG. 17 (refer to FIG. 17 (a)), to each electric power control unit Pc of the first power supply section 7-1, and the electric power control unit Pc6 of the second power supply section 7-2 (Step S1031 of FIG. 19B). Each electric power control unit Pc of the first power supply section 7-1, and the electric power control unit Pc6 of the second power supply section 7-2 set respective control patterns based on the control pattern information from the main control unit MC (Step S1032 of FIG. 19B).

For example, in FIG. 16, by the control pattern set in the electric power control unit PC 1, the illuminance on the zone 1 shown in FIG. 7 is set so as to turn into a predetermined value so that illuminance distribution is approximately uniform. On the other hand, by the electric power control unit PC 6, the illuminance on the whole surface of the wafer 600 (workpiece 6) is set so as to turn into a predetermined value. In addition, as described above, in order that the temperature distribution of the workpiece may be approximately uniform under the heat treatment, the first power supply section 7-1 respectively adjusts the illuminance for each zone (zones 1, 2, 3, 4, and 5 shown in FIG. 7) which is set in the irradiated area of the wafer 600. Therefore, in the control pattern set in each electric power control unit PC (PC1, PC2, PC3, PC4, and PC5 which are shown in FIG. 12), the parameter (for example, electric power density of each filament group) about the intensity of light emitted from the filaments belonging to each filament group is different in each electric power control unit Pc.

Each electric power control unit Pc of the first power supply section 7-1 controls drive of each drive section DR, based on a control pattern set at Step S1032 and the temperature information of each zone from the temperature sensor TS. Moreover, the electric power control unit Pc6 of the second power supply section 7-2 controls drive of each drive section DR (DR1-6 to DR8-6: refer to FIG. 14), based on the control pattern set at Step S1032 (Step S1033 of FIG. 19B). Each drive section DR of the first power supply section 7-1 individually adjusts the electric supply impressed to each filament, and, for example, adjusts rated voltage to each filament belonging to the filament group of the lamp unit LU1. On the other hand, each drive section DR of the second power supply section 7-2 adjusts electric supply to each filament belonging to the filament group of the lamp unit LU2, and, for example, individually adjusts the rated voltage impressed to each filament.

For example, first, in FIG. 16, the electric power control unit Pc1 transmits a control signal A to each drive section DR1-1, DR2-1, DR3-1, and DR4-1, based on the control pattern set up at Step S1032. The drive sections DR1-1, DR2-1, DR3-1, and DR4-1 which receive the control signal A, impress predetermined rated voltages to the respective filaments 1-1, 2-1, 3-1, and 4-1, based on the control signal A.

In general, the electric power supply Pw1 is commercial power supply, and voltage impressed to a load by the electric power supply is constant. In order to impress the predetermined rated voltages to the respective filaments, bias is individually set for each of the bias setting sections BS1-1, BS2-1, BS3-1, and BS4-1 of the respective drive sections DR1-1, DR2-1, DR3-1, and DR4-1 and then each bias setting section BS transmits a drive signal to each of the thyristor drive section SDr1-1, SDr2-1, SDr3-1, and SDr4-1. Each thyristor drive section SDr adds the predetermined bias to the voltage impressed to each of the filaments 1-1, 2-1, 3-1, and 4-1 which are load, from the electric power supply Pw1, based on the drive signal from the bias setting section BS, whereby each of the thyristors SR1-1, SR2-1, SR3-1 and SR4-1 is operated so that the voltage impressed to each filament may turn into the rated voltage. That is, an operation of each drive section DR1-1, DR2-1, DR3-1, and DR4-1 is in block controlled, so that the predetermined rated voltage is impressed to each of the filaments 1-1, 2-1, 3-1, and 4-1, respectively by the same control signal A from the electric power control unit Pc1. In addition, the rated voltage impressed to the filaments 1-1 and 2-1 is, by longer part in filament length, larger than that impressed to the filaments 3-1 and 4-1.

The temperature information of the zone 1 from the temperature sensor TS1 is inputted into the electric power control unit Pc1. The electric power control unit Pc1 repeats a comparison operation of the temperature pattern and the temperature information of the zone 1 from a temperature sensor TS1 at predetermined intervals (for example, 10 ms interval) in the period (1)-(2), and the control signal A is updated based on the result of the operation. That is, each drive section DR1-1, DR2-1, DR3-1, and DR4-1 is controlled by the electric power control unit Pc1 in a feedback manner based on the temperature information of the zone 1. In addition, each drive section DR is controlled in a feedback manner, by the electric power control units Pc2, Pc3, Pc4, and Pc5 which are not shown in FIG. 16, based on the temperature information of each of the zones 2, 3, 4, and 5 from each of the temperature sensors TS2, TS3, TS4, and TS5.

At the same time when the electric power control unit Pc1 transmits the control signal A, the electric power control unit Pc6 transmits a control signal A′ to the drive section DR 1-6 based on the control pattern set in Step S1032. The drive section DR1-6 which receives the control signal A′ impresses predetermined rated voltage to the filament 9-1 based on the control signal A′. In addition, the structure of each drive section DR of the second power supply section 7-2 is the same as that of each drive section DR in the first power supply section 7-1. Further, similarly, an operation of each of the drive section DR1-6, and the drive sections DR2-6 to DR8-6 which are not shown in FIG. 16 (refer to FIG. 14), is controlled in block so that rated voltage which is respectively predetermined for each filament, is impressed to each of the filaments 9-1 to 16-1, by the same control signal A′ from the electric power control unit Pc6. In addition, the rated voltages impressed to the respective filaments 9-1 to 16-1 are different from one another, according to the filament lengths thereof.

That is, in the period (1)-(2) of FIG. 17, electric power in the applied power pattern which is shown in (b) and (c) of FIG. 17 is supplied to the lamp units LU1 and LU2, according to the drive control of each drive section DR in the first power supply section 7-1 and the drive control of each drive section DR of the second power supply section 7-2. Consequently, the temperature of the wafer 600 (workpiece 6) is raised so as to reach a room temperature to the temperature T1 (for example, 350 degree Celsius), by light which is emitted from the lamp units LU1 and LU2. In addition, when the wafer 600 (workpiece 6) is irradiated with light, electric power which is supplied to the lamp units LU1 and LU2 in the period (1)-(2) of FIG. 17, is small, so as to satisfy the condition (refer to the temperature pattern of FIG. 17 (a)) that the temperature of the wafer reaches from a room temperature to the temperature T1 (for example, 350 degree Celsius). If large electric power is suddenly supplied to the lamp units LU1 and LU2 at time of the heat treatment of the wafer 600, great rush current will flow, so that damage may be caused to the power supply section 7 (the first power supply section 7-1, second power supply section 7-2). Therefore, at time of lighting of each of the lamps L1 and L2 which respectively form the lamp units LU1 and LU2, small electric power is supplied thereto and the influence of the rush current is suppressed.

The main control unit MC sends a transporting command signal to the feeding and transporting mechanism control unit 204 so as to feed and place one of the semiconductor wafers 600 stored in the cassette 201a, to the guard ring 5 in the chamber 300 (Step S104 of FIG. 19C). The feeding and transporting mechanism control unit 204 which receives the transporting command signal, drives the feeding and transporting mechanism 202a, so as to take out one of the wafers 600 from the cassette 201a, and to transport the one of the wafers 600 and place it on the guard ring 5 (Step S105 of FIG. 19C). The above Steps S101-S105 are performed in the periods (1)-(2) of FIG. 17. In addition, as described above, after the time point (1), small electric power, in order to satisfy the condition that the temperature of the wafer 600 reaches from a room temperature to the temperature T1, is supplied to the filaments of the lamps L1 and L2 of the respective lamp units LU1 and LU2. Therefore, the feeding and transporting mechanism 202a is heated when the wafer 600 is put on the guard ring 5. The condition of the small electric power is equivalent to condition that attained temperature becomes a heat-resistant temperature of the feeding and transporting mechanism 202a or lower when the feeding and transporting mechanism 202a is heated.

Next, the main control unit MC controls the power supply section 7 connected to each of the lamps L1 which form the lamp unit LU1, and each of the lamps L2 which forms the lamp unit LU2, so that the electric power corresponding to the period (2)-(3) in the temperature pattern of FIG. 17 (a) is supplied to the filaments of each lamp L1 of the lamp unit LU1, and the filament of each lamp L2 of the lamp unit LU2, thereby raising the temperature of the wafer 600 (workpiece 6) so as to reach from temperature T1 to the temperature T2 (for example, 600 degree Celsius) (Step S106 of FIG. 19D). In addition, since the temperature of the wafer 600 is raised, as shown in FIGS. 17 (b) and (c), in the period (2)-(3), the electric power supplied to the lamp units LU1 and LU2 is larger than that supplied in the period (1)-(2). Moreover, in Step S105, in case the wafer 600 is put on the guard ring 5, air from the outside gets mixed to the air in the heat treatment space S2. The period (2)-(3) is set so that this mixed air may fully be removed from the heat treatment space S2 by purge gas.

In Step S106, the main control unit MC transmits control pattern information (refer to FIG. 17 (a)) corresponding to the period (2)-(3) in the temperature pattern of FIG. 17, to each electric power control unit Pc of the first power supply section 7-1, and the electric power control unit Pc6 of the second power supply section 7-2 (Step S1061 of FIG. 19D). Each of the electric power control unit Pc of the first power supply section 7-1 and the electric power control unit Pc6 of the second power supply section 7-2 set a control pattern using the control pattern information from the main control unit MC, respectively (Step S1062 of FIG. 19D). Each electric power control unit Pc of the first power supply section 7-1 controls drive of each drive section DR, based on the control pattern set in Step S1062 and the temperature information of each zone from the temperature sensor TS. Moreover, the electric power control unit Pc6 of the second power supply section 7-2 controls drive of each drive section DR (DR1-6 to DR8-6: refer to FIG. 14) based on the control pattern set in Step S1062 (Step S1063 of FIG. 19D).

In FIG. 16, first, the electric power control unit Pc1 transmits a control signal B to each of the drive sections DR1-1, DR2-1, DR3-1, and DR4-1 based on the control pattern set in Step S1062. The drive sections DR1-1, DR2-1, DR3-1, and DR4-1 which receive the control signal B respectively impress the predetermined rated voltages to the respective filaments 1-1, 2-1, 3-1, and 4-1 based on the control signal B. In addition, as in the case of Step S103, operations of the drive sections DR1-1, DR2-1, DR3-1, and DR4-1 are in block controlled by the same control signal B, so that rated voltages which are respectively predetermined are respectively impressed to the filaments 1-1, 2-1, 3-1, and 4-1 from the electric power control unit Pc1. In addition, the rated voltage impressed to the filaments 1-1 and 2-1 is larger than that impressed to the filaments 3-1 and 4-1, by longer part of filament length.

Here, the temperature information of the zone 1 from the temperature sensor TS1 is inputted into the electric power control unit Pc1. In the period (2)-(3), the electric power control unit Pc1 repeats a comparison operation of the temperature pattern and the temperature information of the zone 1 from the temperature sensor TS1 at the predetermined intervals (for example, 10 ms interval), and the control signal B described above is updated, based on the operation result. That is, each of the drive sections DR1-1, DR2-1, DR3-1, and DR4-1 is controlled in a feedback manner by the electric power control unit Pc1, based on the temperature information of the zone 1. In addition, in FIG. 16, each of the electric power control units Pc2, Pc3, Pc4, and Pc5 which are not shown, respectively controls each drive section DR in a feedback manner, based on the temperature information of each of the zones 2, 3, 4, and 5 from each of the temperature sensors TS2, TS3, TS4, and TS5.

At the same time when the electric power control unit Pc1 transmits control signal B, the electric power control unit Pc6 transmits the control signal B′ to the drive sections DR 1-6, based on the control pattern set up at Step S1062. The drive section DR1-6 which receives the control signal B′ impresses predetermined rated voltage to the filament 9-1 based on the control signal B′. Further, similarly, operations of the drive section DR1-6, and the drive sections DR2-6 to DR8-6 which are not shown in FIG. 16 (refer to FIG. 14), are controlled in block so that rated voltages which are predetermined for the respective filaments, is impressed to each of the filaments 9-1 to 16-1, by the same control signal B′ from the electric power control unit Pc6, as in Step S103. In addition, the rated voltages impressed to the respective filaments 9-1 to 16-1 are different from one another, according to the filament length thereof.

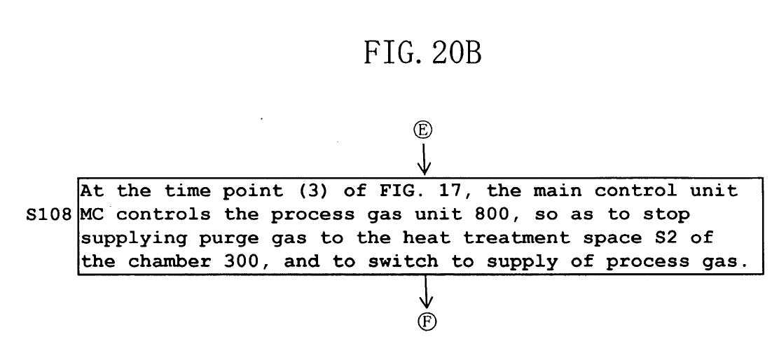

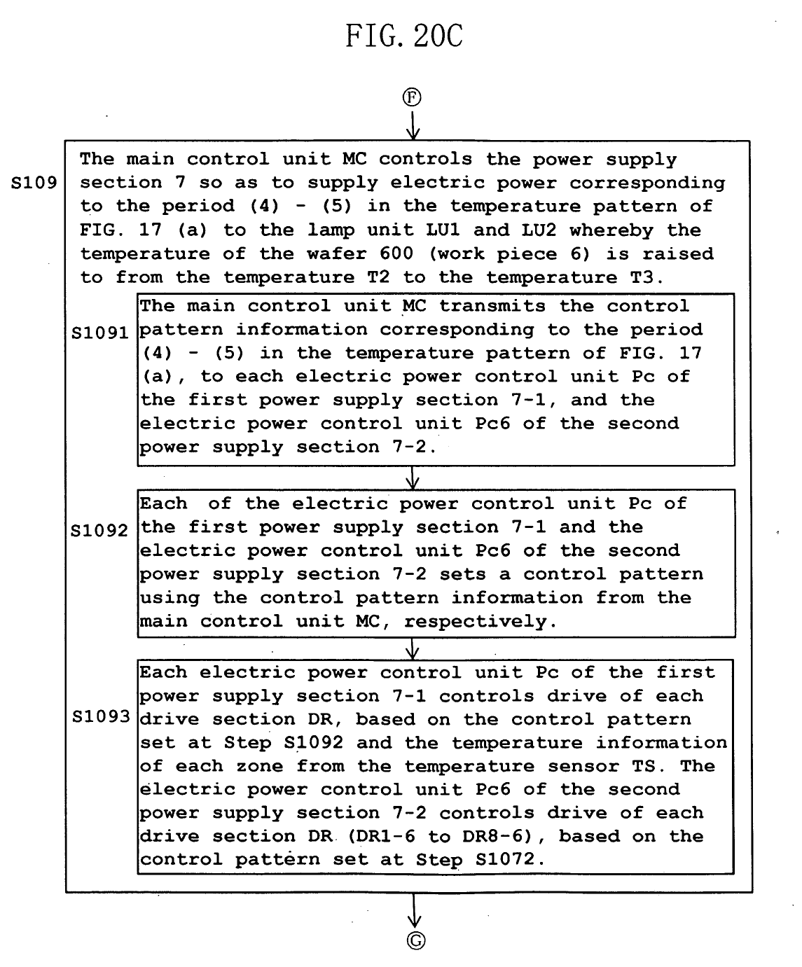

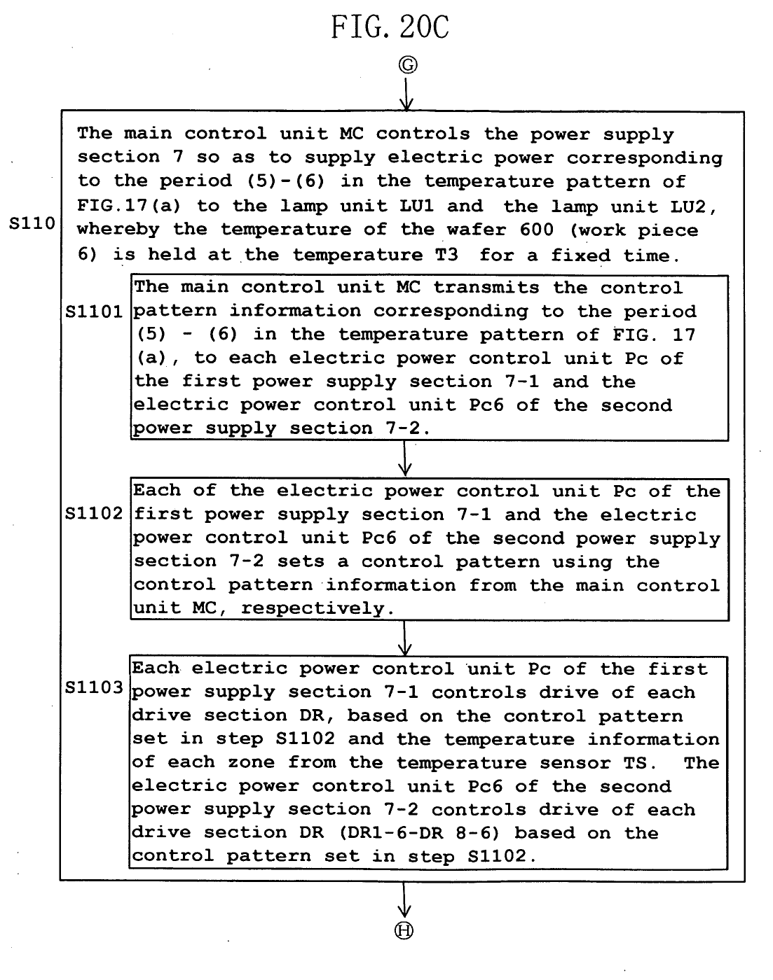

That is, in the period (2)-(3) of FIG. 17, electric power in the applied power pattern which is shown in (b) and (c) of FIG. 17 is respectively supplied to the lamp units LU1 and LU2, according to the drive control of each drive section DR in the first power supply section 7-1 and the drive control of each drive section DR of the second power supply section 7-2. Consequently, the temperature of the wafer 600 (workpiece 6) is raised so as to reach the temperature T1 to the temperature T2 (for example, 600 degree Celsius), by the light emission from the lamp units LU1 and LU2. Next, the main control unit MC controls the power supply section 7 which is connected to the lamps L1 which form the lamp unit LU1 and the lamps L2 which form the lamp unit LU2, so as to supply electric power corresponding to the period (3)-(4) in the temperature pattern of FIG. 17 (a), to the filaments of each lamp L1 of the lamp unit LU1, and the filament of each lamp L2 of the lamp unit LU2, and then the temperature of the wafer 600 (workpiece 6) is held at the temperature T2 (for example, 600 degree Celsius) for a fixed time (for example, for several seconds to tens of seconds) (Step S107 of FIG. 20A).

As described above, the temperature holding time is provided so as to stabilize operations of filaments of each lamp L1 of the lamp unit LU1 and the filament of each lamp L2 of the lamp unit LU2 before the heat treatment, and to attain stabilization of the heat treatment space S2. In addition, since what is necessary is to compensate only the amount of heat radiated from the wafer 600 when the temperature of the wafer 600 is held, as shown in FIGS. 17 (b) and (c), the electric power supplied to the lamp units LU1 and LU2 in the period (3)-(4), is smaller than that in period (2)-(3).

In Step S107, the main control unit MC transmits control pattern information (refer to FIG. 17 (a)) corresponding to the period (3)-(4) of the temperature pattern of FIG. 17, to each electric power control unit Pc of the first power supply section 7-1, and the electric power control unit Pc6 of the second power supply section 7-2 (Step S1071 of FIG. 20A). Each of the electric power control unit Pc of the first power supply section 7-1 and the electric power control unit Pc6 of the second power supply section 7-2 sets the control pattern using the control pattern information from the main control unit MC, respectively (Step S1072 of FIG. 20A). Each electric power control unit Pc of the first power supply section 7-1 controls drive of each drive section DR, based on the control pattern set up at Step S1072 and the temperature information of each zone from the temperature sensor TS. Moreover, the electric power control unit Pc6 of the second power supply section 7-2 controls drive of each drive section DR (DR1-6-DR8-6: refer to FIG. 14), based on the control pattern set in Step S1072 (Step S1073 of FIG. 20A).

In FIG. 16, first, the electric power control unit Pc1 transmits a control signal C to each of the drive section DR1-1, DR2-1, DR3-1, and DR4-1, based on the control pattern set in Step S1072. The drive sections DR1-1, DR2-1, DR3-1, and DR4-1 which receive the control signal C, impress the respective rated voltages to the respective filaments 1-1, 2-1, 3-1, and 4-1, based on the control signal C. In addition, as in the cases of Steps S103 and S106, operations of the drive sections DR1-1, DR2-1, DR3-1, and DR4-1 are in block controlled by the same control signal C from the electric power control unit Pc1, so that predetermined rated voltages are impressed to the respective filaments 1-1, 2-1, 3-1, and 4-1. In addition, the rated voltage impressed to the filaments 1-1 and 2-1 is larger than that impressed to the filaments 3-1 and 4-1 by longer part of filament length.

Here, the temperature information of the zone 1 from the temperature sensor TS1 is inputted into the electric power control unit Pc1. The electric power control unit Pc1 repeats a comparison operation of this temperature pattern and the temperature information of the zone 1 from the temperature sensor TS1 at predetermined intervals (for example, 10 ms interval) in the period (3)-(4), so that the control signal C described above is updated, based on a result of the operation. That is, each of the drive sections DR1-1, DR2-1, DR3-1, and DR4-1 is controlled by the electric power control unit Pc1 in a feedback manner, based on the temperature information of the zone 1. In addition, each drive section DR is controlled in a feedback manner, by each of the electric power control units Pc2, Pc3, Pc4, and Pc5 which are not shown in FIG. 16, based on the temperature information of each of the zones 2, 3, 4, and 5 from each of the temperature sensors TS2, TS3, TS4, and TS5.

At the same time when the electric power control unit Pc1 transmits the control signal C, the electric power control unit Pc6 transmits a control signal C′ to the drive sections DR1-6, based on the control pattern set at Step S1702. The drive section DR1-6 which receives the control signal C′ impresses predetermined rated voltage to the filament 9-1 based on the control signal C′. Further, operations of the drive section DR1-6, and the drive sections DR2-6 to DR8-6 which are not shown in FIG. 16 (refer to FIG. 14), are controlled in block so that rated voltages are respectively impressed to each of the filaments 9-1 to 16-1, by the same control signal C′ from the electric power control unit Pc6, as in Steps S103 and S106. In addition, the rated voltages impressed to the respective filaments 9-1 to 16-1 are different from one another, according to the filament length thereof. That is, in the period (3)-(4) of FIG. 17, electric power in the applied power pattern which is shown in (b) and (c) of FIG. 17 is supplied to the lamp units LU1 and LU2, according to the drive control of each drive section DR of the first power supply section 7-1 and the drive control of each drive section DR of the second power supply section 7-2. Consequently, the temperature of the wafer 600 (workpiece 6) is held at the temperature T2 (for example, 600 degree Celsius) for a fixed period, by the light emission from the lamp units LU1 and LU2.

At the time point (3) of FIG. 17, the main control unit MC controls the process gas unit 800, so as to stop supplying purge gas to the heat treatment space S2 of the chamber 300, and to switch to supply of process gas (for example, oxygen gas) (Step S108 of FIG. 20B). At this time, the process gas pressure and the process gas mass flow in the heat treatment space S2 are controlled by the process gas unit 800 at the predetermined value. In addition, at the time point (4), the purge gas has been almost substituted by the process gas in the heat treatment space S2 so as to be process gas atmosphere.

Next, the main control unit MC controls the power supply section 7 which is connected to the lamps L1 which form the lamp unit LU1 and the lamps L2 which form the lamp unit LU2, so as to supply electric power corresponding to the period (4)-(5) in the temperature pattern of FIG. 17 (a), to the filaments of each lamp L1 of the lamp unit LU1, and the filament of each lamp L2 of the lamp unit LU2, whereby the temperature of the wafer 600 (workpiece 6) is raised to from the temperature T2 to the temperature T3 (for example, 1150 degree Celsius) (Step S109 of FIG. 20C). As described above, this period (4)-(5) is equivalent to the temperature raising period (A) in FIG. 2, in which the electric power is supplied to the lamp units LU1 and LU2 so that the temperature rising speed of the wafer 600 may be 200 to 400 degree Celsius/sec. Since this period is a period which the temperature is raised to the maximum temperature in the temperature pattern shown in FIG. 17 (a), the electric power supplied to the lamp units LU1 and LU2 is larger than any of other periods.

In Step S109, the main control unit MC transmits the control pattern information (refer to FIG. 17 (a)) corresponding to the period (4)-(5) in the temperature pattern of FIG. 17, to each electric power control unit Pc of the first power supply section 7-1, and the electric power control unit Pc6 of the second power supply section 7-2 (Step S1091 of FIG. 20C). Each of the electric power control unit Pc of the first power supply section 7-1 and the electric power control unit Pc6 of the second power supply section 7-2 sets a control pattern using the control pattern information from the main control unit MC, respectively (Step S1092 of FIG. 20C). Each electric power control unit Pc of the first power supply section 7-1 controls drive of each drive section DR, based on the control pattern set at Step S1092 and the temperature information of each zone from the temperature sensor TS. Moreover, the electric power control unit Pc6 of the second power supply section 7-2 controls drive of each drive section DR (DR1-6 to DR8-6: refer to FIG. 14), based on the control pattern set at Step S1072 (Step S1093 of FIG. 20C).

In FIG. 16, first, the electric power control unit Pc1 transmits a control signal D to each of the drive sections DR1-1, DR2-1, DR3-1, and DR4-1 based on the control pattern set in Step S1092. The drive sections DR1-1, DR2-1, DR3-1, and DR4-1 which receive the control signal D, impress the respective rated voltages to the respective filaments 1-1, 2-1, 3-1, and 4-1, based on the control signal D. In addition, as in the cases of Steps S103, S106 and S107, operations of the drive sections DR1-1, DR2-1, DR3-1, and DR4-1 are in block controlled by the same control signal D from the electric power control unit Pc1, so that predetermined rated voltages are impressed to the respective filaments 1-1, 2-1, 3-1, and 4-1. In addition, the rated voltage impressed to the filaments 1-1 and 2-1 is larger than that impressed to the filaments 3-1 and 4-1 by longer part of filament length.

Here, the temperature information of the zone 1 from the temperature sensor TS1 is inputted into the electric power control unit Pc1. The electric power control unit Pc1 repeats a comparison operation of this temperature pattern and the temperature information of the zone 1 from the temperature sensor TS1 at predetermined intervals (for example, 10 ms interval) in the period (4)-(5), so that the control signal D described above is updated, based on a result of the operation. That is, each of the drive sections DR1-1, DR2-1, DR3-1, and DR4-1 is controlled by the electric power control unit Pc1 in a feedback manner, based on the temperature information of the zone 1. In addition, each drive section DR is controlled in a feedback manner, by each of the electric power control units Pc2, Pc3, Pc4, and Pc5 which are not shown in FIG. 16, based on the temperature information of each of the zones 2, 3, 4, and 5 from each of the temperature sensors TS2, TS3, TS4, and TS5.

At the same time when the electric power control unit Pc1 transmits the control signal D, the electric power control unit Pc6 transmits a control signal D′ to the drive sections DR1-6, based on the control pattern set up at Step S1702. The drive section DR1-6 which receives the control signal D′ impresses predetermined rated voltage to the filament 9-1 based on the control signal D′. In addition, operations of the drive section DR1-6, and the drive sections DR2-6 to DR8-6 which are not shown in FIG. 16 (refer to FIG. 14), are controlled in block so that rated voltages are respectively impressed to each of the filaments 9-1 to 16-1, by the same control signal D′ from the electric power control unit Pc6, as in Steps S103 and S106. In addition, the rated voltages impressed to the respective filaments 9-1 to 16-1 are different from one another, according to the filament length thereof.

That is, in the period (4)-(5) of FIG. 17, electric power in the applied power pattern which is shown in (b) and (c) of FIG. 17 is supplied to the lamp units LU1 and LU2, according to the drive control of each drive section DR of the first power supply section 7-1 and the drive control of each drive section DR of the second power supply section 7-2. Consequently, the temperature of the wafer 600 (workpiece 6) is raised to the temperature T3 (1150 degree Celsius) by light emitted from the lamp units LU1 and LU2. In addition, since power applied to the lamp unit LU1 is controlled in a feedback manner, based on the temperature information of each zone as described above, the temperature of the wafer 600 (workpiece 6) is raised while the uniformity of the temperature of the wafer is maintained. As described above, the total power applied to the lamp units LU1 and LU2 is approximately 250 kW, wherein the power applied to the lamp unit LU1 is 50 kW and the power applied to the lamp unit LU2 is 200 kW. That is, when the power applied to the lamp unit LU1 is represented as A1 and the power applied to the lamp unit LU2 is represented as A2, they are lighted under the condition of A1<A2 (A1≠0, A2≠0).

Next, the main control unit MC controls the power supply section 7 which is connected to the lamps L1 which form the lamp unit LU1 and the lamps L2 which form the lamp unit LU2, so as to supply electric power corresponding to the period (5)-(6) in the temperature pattern of FIG. 17 (a), to the filaments of each lamp L1 of the lamp unit LU1, and the filament of each lamp L2 of the lamp unit LU2, whereby the temperature of the wafer 600 (workpiece 6) is held at the temperature T3 (1150 degree Celsius) for a fixed time (Step S110 of FIG. 20D).

In addition, since what is necessary is to compensate only the amount of heat radiated from the wafer 600 when the temperature of the wafer 600 is held, as shown in FIGS. 17 (b) and (c), the electric power supplied to the lamp units LU1 and LU2 in the period (5)-(6), is smaller than that in period (4)-(5). However, since the temperature T3 (1150 degree Celsius) to be held is higher than the temperature T2 (for example, 600 degree Celsius) to be held in the period (2)-(3), the electric power supplied to the lamp units LU1 and LU2 in the period (5)-(6) is larger than that in the period (2)-(3).

In Step S110, the main control unit MC transmits control pattern information (refer to FIG. 17 (a)) corresponding to the period (5)-(6) in the temperature pattern of FIG. 17, to each of the electric power control unit Pc of the first power supply section 7-1 and the electric power control unit Pc6 of the second power supply section 7-2 (Step S1101 of FIG. 20D). Each of the electric power control unit Pc of the first power supply section 7-1 and the electric power control unit Pc6 of the second power supply section 7-2 sets a control pattern using the control pattern information from the main control unit MC, respectively (Step S1102 of FIG. 20D). Each electric power control unit Pc of the first power supply section 7-1 controls drive of each drive section DR, based on the control pattern set in Step S1102 and the temperature information of each zone from the temperature sensor TS. Moreover, the electric power control unit Pc6 of the second power supply section 7-2 controls drive of each drive section DR (DR1-6 to DR8-6: refer to FIG. 14), based on the control pattern set in Step S1102 (Step S1103 of FIG. 20D).

In FIG. 16, first, the electric power control unit Pc1 transmits a control signal E to each of the drive sections DR1-1, DR2-1, DR3-1, and DR4-1, based on the control pattern set in Step S1102. The drive sections DR1-1, DR2-1, DR3-1, and DR4-1 which receive the control signal E impress predetermined rated voltages based on the control signal E, to the respective filaments 1-1, 2-1, 3-1, and 4-1.

In addition, as in the cases of Steps S103, S106, S107 and S109, operations of the drive sections DR1-1, DR2-1, DR3-1, and DR4-1 are in block controlled by the same control signal E from the electric power control unit Pc1, so that predetermined rated voltages are impressed to the respective filaments 1-1, 2-1, 3-1, and 4-1. In addition, the rated voltage impressed to the filaments 1-1 and 2-1 is larger than that impressed to the filaments 3-1 and 4-1 by longer part of filament length.

The temperature information of the zone 1 from the temperature sensor TS1 is inputted into the electric power control unit Pc1. The electric power control unit Pc1 repeats a comparison operation of the temperature pattern and the temperature information of the zone 1 from a temperature sensor TS1 at predetermined intervals (for example, 10 ms interval) in the period (5)-(6), and the control signal E is updated based on a result of the operation. That is, each drive section DR1-1, DR2-1, DR3-1, and DR4-1 is controlled by the electric power control unit Pc1 in a feedback manner based on the temperature information of the zone 1. In addition, each drive section DR is controlled in a feedback manner, by the electric power control units Pc2, Pc3, Pc4, and Pc5 which are not shown in FIG. 16, based on the temperature information of each of the zones 2, 3, 4, and 5 from each of the temperature sensors TS2, TS3, TS4, and TS5.

At the same time when the electric power control unit Pc1 transmits the control signal E, the electric power control unit Pc6 transmits a control signal E′ to the drive sections DR1-6, based on the control pattern set in Step S1702. The drive section DR1-6 which receives the control signal E′ impresses predetermined rated voltage to the filament 9-1 based on the control signal E′. In addition, operations of the drive section DR1-6, and the drive sections DR2-6 to DR8-6 which are not shown in FIG. 16 (refer to FIG. 14), are controlled in block so that rated voltages are respectively impressed to the respective filaments 9-1 to 16-1, by the same control signal E′ from the electric power control unit Pc6, as in steps S103, S106, S107, and S109. In addition, the rated voltages impressed to the respective filaments 9-1 to 16-1 are different from one another, according to the filament length thereof.

That is, in the period (5)-(6) of FIG. 17, electric power in the applied power pattern which is shown in (b) and (c) of FIG. 17 is supplied to the lamp units LU1 and LU2, according to the drive control of each drive section DR of the first power supply section 7-1 and the drive control of each drive section DR of the second power supply section 7-2. Consequently, the temperature of the wafer 600 (workpiece 6) is held at the temperature T3 (1150 degree Celsius) for a fixed period, by the light emission from the lamp units LU1 and LU2.

As described above, the total power applied to the lamp units LU1 and LU2 is approximately 36 kW, wherein the power applied to the lamp unit LU1 is 30 kW and the power applied to the lamp unit LU2 is 6 kW. In addition, also the power applied to the lamp unit LU1 may be set to 36 kW, so as to light the lamp unit LU1. That is, when power applied to the lamp unit LU1 is represented as B1, and the power applied to the lamp unit LU2 is represented as B2 in the constant temperature holding period, the lamp units LU1 and LU2 are lighted under condition of B1>B2 (B1≠0, B2≠0). When the lamp unit LU1 is used, B2=0 and B1≠0.

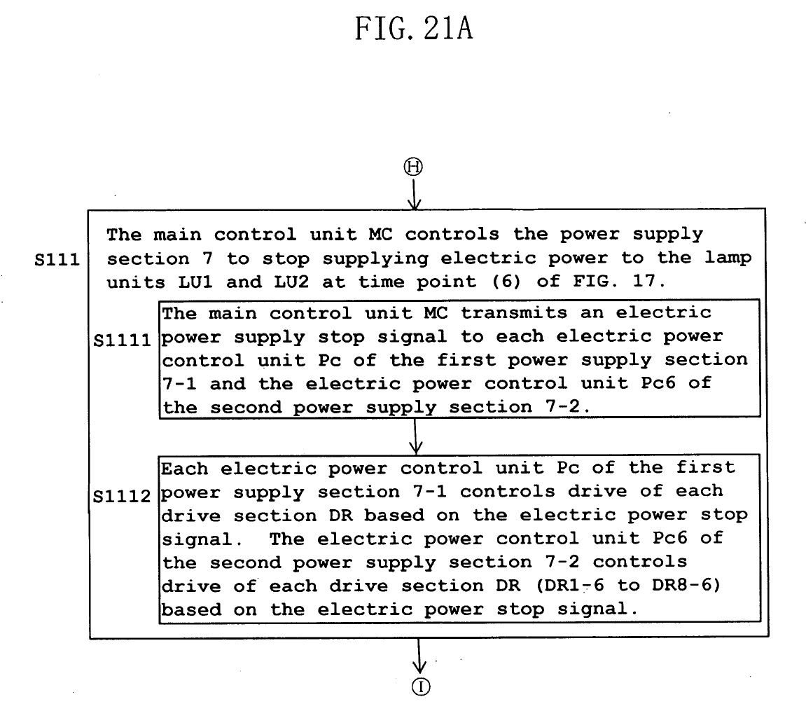

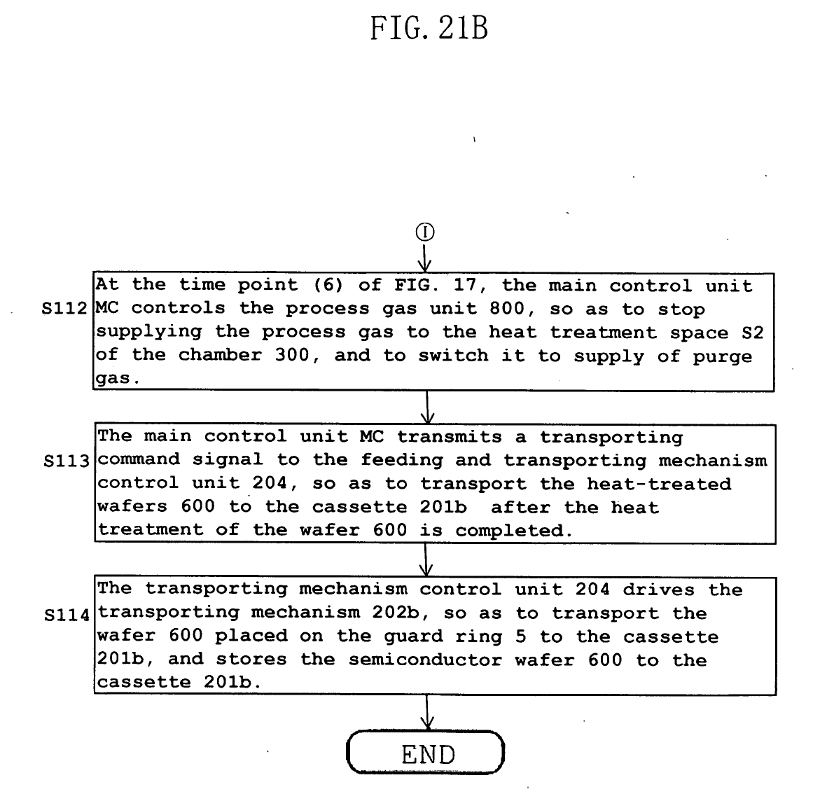

After the temperature of the wafer 600 is held at the predetermined temperature T3 (1150 degree Celsius) for the fixed time (after the time period (6) of FIG. 17), the main control unit MC controls the power supply section 7 (the first power supply section 7-1, the second power supply section 7-2) connected to each of the lamps L1 which form the lamp unit LU1, and each of the lamps L2 which form the lamp unit LU2, so as to stop supplying the electric power to the filaments of each lamp L1 of the lamp unit LU1 and to each lamp L2 of the lamp unit LU2 (step S111 of FIG. 21A). The temperature of the filaments is lowered as shown as a period after the period (6) in the temperature pattern of FIG. 17 (a).

In step S111, the main control unit MC transmits an electric power supply stop signal to each electric power control unit Pc of the first power supply section 7-1, and the electric power control unit Pc6 of the second power supply section 7-2 (step S1111 of FIG. 21A). Each electric power control unit Pc of the first power supply section 7-1 controls drive of each drive section DR based on the electric power stop signal. Moreover, the electric power control unit Pc6 of the second power supply section 7-2 controls drive of each drive section DR (DR1-6 to DR8-6: refer to FIG. 14) based on the electric power stop signal (step S1112 of FIG. 21A).

In FIG. 16, the electric power control unit Pc1 transmits a control signal F to each drive section DR1-1, DR2-1, DR3-1, and DR4-1 first based on the electric power stop signal. The drive sections DR1-1 DR2-1, DR3-1, and DR4-1 which receive the control signal F, stop the voltage impression to each filament 1-1, 2-1, 3-1, and 4-1 based on the control signal F.

In addition, as in the cases of steps S103, S106, S107, and S109, operations of the drive sections DR1-1, DR2-1, DR3-1, and DR4-1 are in block controlled by the same control signal F, to stop supplying the voltages impressed to the filaments 1-1, 2-1, 3-1, and 4-1 from the electric power control unit Pc1.

Since the control signal F is a signal for commanding the drive sections to stop impressing voltage to each of the filaments 1-1, 2-1, 3-1, and 4-1, it is not necessary to control them in a feedback manner, based on the temperature information of the zone 1 from the temperature sensor TS1. In addition, it is not necessary to control, in a feedback manner, the electric power control units Pc2, Pc3, Pc4, and Pc5 (which are omitted in FIG. 16).

At the same time when the electric power control unit Pc1 transmits the control signal F, the electric power control unit Pc6 transmits a control signal F′ to the drive section DR1-6 based on the electric power stop signal. When the drive section DR1-6 receives the control signal F′ it stops impressing the voltage impression to the filament 9-1. In addition, as in the cases of steps S103, S106, S107, S109, and S110, operations of the drive section DR1-6, and the drive sections DR2-6 to DR8-6 which are not shown in FIG. 16 (refer to FIG. 14), are controlled in block so as to stop respectively impressing the rated voltages to the respective filaments 9-1 to 16-1, by the same control signal F′ from the electric power control unit Pc6.

In addition, depending on a type of the heat treatment process, as described above, the electric power supply to the filaments of each lamp L1 of the lamp unit LU1 and each lamp L2 of the lamp unit LU2 are not stopped, and small electric power may be supplied to the lamp units LU1 and LU2. In this case, as in the steps S103, S106, S107, S109, and S110, the main control unit MC transmits control pattern information to each electric power control unit Pc of the first power supply section 7-1 and the electric power control unit Pc6 of the second power supply section 7-2, and these electric power control units set control patterns, using the control pattern information from the main control unit MC, respectively. Based on this control pattern, drive of each drive section DR (the drive section DR of the first power supply section, drive section DR of the second power supply section) is controlled. In addition, since a series of operations thereof is the same as that shown in steps S103, S106, S107, S109, and S110, description of the series of operations is omitted.

At the time point (6) of FIG. 17, the main control unit MC controls the process gas unit 800, so as to stop supplying process gas to the heat treatment space S2 of the chamber 300, and to switch it to supply of purge gas (Step S112 of FIG. 21B). At this time, the purge gas pressure and the process gas mass flow in the heat treatment space S2 are controlled by the process gas unit 800 at a predetermined value.

At the time point (a time point (7) of FIG. 17) when the temperature of the wafer 600 drops to a predetermined temperature, the main control unit MC determines that the heat treatment of the wafer 600 is completed through the predetermined process. The main control unit MC transmits a transporting command signal to the feeding and transporting mechanism control unit 204, so as to transport the heat-treated wafers 600 placed on the guard ring 5 to the cassette 201b (step S113 of FIG. 21B). At the time point (7), the predetermined temperature is set so as to be the heat-resistant temperature of the transporting mechanism 202b or lower. When the feeding and transporting mechanism control unit 204 receives the transporting command signal, it drives the transporting mechanism 202b, so as to transport the wafer 600 placed on the guard ring 5 to the cassette 201b, and stores the semiconductor wafer 600 to the cassette 201b (step S114 of FIG. 21B). The heat treatment of the one of the wafers 600 is completed with the above procedure. Hereafter, when the next workpiece is processed, cooling air is blown onto each lamp 1, and while supply of the purge gas into the chamber 300 is maintained, the steps S103 to S114 are repeated.

The light emission type heating apparatus according to the present invention has two (2) sets of lamp units which form a light emission unit, wherein two or more straight-bulb filament lamps are arranged in parallel. The two or more filament lamps L1 which form the lamp unit LU1 include the multi-filament lamps which the inventors proposed. Each of the multi-filament lamps has two or more filaments aligned in the axial direction of the light emission bulb inside the light emission bulb, wherein electric power can be supplied individually to these filaments. Therefore, if the length and arrangement of filaments in each of the two or more filament lamps L1 which form the lamp unit LU1, is set, taking into consideration, the heating/cooling property of a workpiece, the shape of the workpiece, and the physical property distribution of the workpiece, and if the electric power supply to each filament is adjusted, the local illuminance distribution can be controlled in the irradiated area including the workpiece. Therefore, it is possible to make the temperature of the workpiece uniform all over the workpiece by such control. Moreover, by making the diameter of a filament line of each filament in the two or more filament lamps L1 small, and making the heat capacity of the filament made as small as possible, it is possible to set the intensity of light emitted from the filaments to a predetermined value at a high speed when the power applied to the filament lamps L1 is controlled. That is, by configuring the lamp unit LU1 as described above, in the illuminance control on the irradiated area including the workpiece, it is possible to realize (2) a high speed response of illuminance control, and (3) good local illuminance control, whereby it is possible to realize control of the uniform temperature of the workpiece highly precisely.

The other two or more filament lamps L2 which form the lamp unit LU2 are single filament lamps. When the length and arrangement of each of the filaments in two or more filament lamps L2 which form the lamp unit LU2 is set, taking into consideration the shape of the workpiece, and the electric power supply to each filament is adjusted, it is possible to uniformly control the illuminance distribution on the whole irradiated area surface which includes the work. By making the diameter of a filament line of each filament in two or more filament lamps L2 large and making the heat capacity of the filament large as much as possible, the intensity of light emitted from the filament is increased, and the illuminance on the irradiated area is also increased. That is, (1) a workpiece temperature rise at a high speed can be realized by forming the lamp unit LU2 as described above.

That is, the light emission type heating apparatus according to the present invention is formed so that large electric power can be applied thereto, wherein a light emission unit is formed of the lamp unit LU2 capable of realizing (1) a workpiece temperature rise at a high speed, and the lamp unit LU1 capable of (2) a high speed response of illuminance control, and (3) good local illuminance control. Thus, different roles are respectively assigned to the two lamp units LU1 and LU2, and furthermore, by appropriately controlling lighting of the two lamp units LU1 and LU2 in the light emission type heating apparatus according to the present invention, all of the conditions (1) a workpiece temperature rise at a high speed, (2) a high speed response of illuminance control, and (3) a good local illuminance control become possible.

The light emission type heating method of the first embodiment 1 is performed, using the light emission type heating apparatus.

(A) Temperature Raising Period

On the other hand, it turned out by experiment of inventors that the electric power applied to the filaments required for the adjustment (uniform temperature control of the workpiece) of the temperature distribution of a workpiece, which is performed by local illuminance control in the temperature raising period, is approximately 20% of the total electric power which is applied to the filaments and which is needed in the temperature raising period. On the other hand, it turned out that the electric power applied to the filaments simply needed for raising the temperature of the workpiece, is approximately 80% of the total electric power applied to the filaments needed in the temperature raising period. Therefore, when, of the total electric power applied to the light emission unit during the temperature raising period, the electric power applied to the lamp unit LU1, is approximately 20% of the total electric power, and the electric power applied to the lamp unit LU2 is approximately 80% of the total electric power, (1) the high temperature raising at a high speed, (2) The high speed response of illuminance control, (3) All good local illuminance control becomes possible. That is, in the temperature raising period, it is possible to realize a workpiece temperature rise at a high speed, while maintaining the temperature uniformity of the workpiece with high precision.

In summary, (I) when the power applied to the lamp unit LU1 is represented as A1 and the power applied to the lamp unit LU2 is represented as A2, they are lighted under the condition of A1<A2 (A1≠0, A2≠0), (II) the pattern of power applied to the lamp unit LU1 (which is equivalent to the period (4)-(5) of FIG. 17 (a)) corresponding to the temperature raising pattern of the workpiece temperature pattern is updated based on the temperature information of the workpiece, in a feedback control, so that the temperature of the whole workpiece surface becomes uniform, and (III) when the applied power control to the lamp unit LU2 which takes charge of the high speed raising temperature of the workpiece is carried out based on the predetermined electric power control pattern (preset program) corresponding to the temperature raising pattern in the temperature pattern (which is equivalent to the period (4)-(5) of FIG. 17 (a)), in the temperature raising period, it is possible to realize all the conditions, that is, (1) a high temperature raising at a high speed, (2) a high speed response of illuminance control, and (3) a good local illuminance control.

If the feedback control is adopted as lighting control of both the lamp unit LU1 and the lamp unit LU2, they may interfere with each other, so that there is a possibility that temperature may not be stabilized (converge). Therefore, if lighting of the lamp unit LU2 is controlled according to the preset program, and lighting of the lamp unit LU1 is controlled in a feedback manner, it is possible to carry out a temperature control without such interference.

(B) Constant Temperature Holding Period

On the other hand, it turned out by experiment of inventors that the electric power applied to the filaments required for the adjustment (uniform temperature control of the workpiece) of the temperature distribution of the workpiece, which is performed by local illuminance control in the constant temperature holding period, is approximately 20% of the total electric power which is applied to the filaments and which is needed in the constant temperature holding period. On the other hand, the electric power applied in (B) the constant temperature holding period may be smaller than the electric power applied in (A) the temperature raising period, and it turned out that it is possible to carry out adjustment of the temperature distribution of the workpiece and temperature maintenance, which are performed by local illuminance control, by only the lamp unit LU1.

In summary, when the power applied to the lamp unit LU1 is represented as B1, and the power applied to the lamp unit LU2 is represented as B2 in the constant temperature holding period, only the lamp unit LU1 is lighted under the conditions of B1≠0 and B2≠0, or the lamp unit LU1 is lighted under the condition of B1>B2 (B1≠0, B2≠0) and the lamp unit LU2 is lighted very slightly, so that (II) the temperature of the whole workpiece surface becomes uniform, wherein when the pattern of power applied to the lamp unit LU1 (which is equivalent to the period (5)-(6) of FIG. 17 (a)) corresponding to the temperature raising pattern of the workpiece temperature pattern is updated based on the temperature information of the workpiece, in a feedback control, it is possible to realize (2) a high speed response of illuminance control, and (3) good local illuminance control in the constant temperature holding period. In addition, when the lamp unit LU2 is lighted very slightly, (III) the applied power control to the lamp unit LU2 is carried out, based on the predetermined electric power control pattern corresponding to the constant temperature maintaining pattern (the period (5)-(6) of FIG. 17 (a)) of the workpiece temperature pattern.

(C) Temperature Lowering Period

(C) In a temperature lowering period, since it is necessary to lower the temperature of the workpiece as soon as possible, both of the lamp unit LU1 and the lamp unit LU2 are turned off.

As described above, according to the heating method using the light emission type heating apparatus according to the present invention, in the high temperature heat treatment mainly comprising three steps, that is, a step of raising a workpiece temperature, a step of maintaining a constant temperature, and a step of lowering the temperature, it is possible to meet all of the conditions, that is, (1) a temperature rise at a high speed, (2) a high speed response of illuminance control, and (3) good local illuminance control. In addition, when, in the constant temperature holding period, the power applied to the lamp unit LU2 is represented as A2, the power applied to the lamp unit LU1 is represented as A1, and, in the constant temperature holding period, the power applied to the lamp unit LU2 is represented as B2 and the power applied to the lamp unit LU1 is represented as B1, the relation of A1, A2, B1, and B2 may be described as (A2/A1)>(B2/B1), wherein A1≠0, A2≠0, and B1≠0.

Therefore, in a manufacturing process of a semiconductor integrated circuit, such as film thinning of a gate oxide film, it is possible to realize a temperature rise at a high speed in a high temperature heat treatment process of the light emission type heating method according to the present invention. It is also possible to make the temperature of the workpiece uniform with high precision, in the high temperature heating process in which the miniaturization and high performance of a semiconductor device is required. In addition, in setting according to this embodiment, not only the irradiated area of a workpiece is set concentrically as in the prior art, but also the single concentric circle is divided into two or more zones. In the setting of such a zone, not only influence of the thermal radiation from an edge portion of the workpiece but also influence of the atmosphere (for example, the flow of gas, uneven light reflection due to a wall portion of the heat treatment space, etc.) of the heat treatment space where the workpiece is placed, are also taken into consideration. As shown in FIG. 7, when the length and arrangement of each filament of the lamp unit LU1 is set up according to each such zone, and the feedback control of the lamp unit LU1 is carries out, so that the illuminance on each zone may be set to a predetermined value, it is possible to perform a light emission type heat treatment of the wafer, while maintaining uniform temperature distribution with high precision all over the wafer.

Here, it not necessary to provide independent control systems whose number is the number of filaments, and when two or more filaments corresponding to each zone are set as a filament group, and the electric power is controlled so as to be supplied to filaments belonging to the same group in block by one control signal, it is possible to efficiently carry out electric power supply control to the filaments of the lamps corresponding to each zone set in the area to be irradiated with light by a comparatively simple structure. That is, even if the number of filaments becomes large when a large workpiece is used, the light emission type heating treatment apparatus does not become large, so that it is possible to suppress increase of cost of the apparatus.

### (7) Second Embodiment of Heating Method

Next, a second embodiment of the light emission type heating method according to the present invention will be described below. The second embodiment shows a heating method for a spike anneal process in which the temperature of a workpiece is lowered immediately after the temperature of the workpiece is raised to a predetermined temperature at a high speed. As described above, such a heat treatment process is applied to, for example, an activation process of the impurity ions, in which a shallow impurity diffused layer is formed. Thus, by shortening a period in which a semiconductor wafer is a high temperature, as much as possible, it is possible to form a shallow PN junction with low resistor, since undesired diffusion of the impurity ions in a depth direction of the wafer is suppressed.

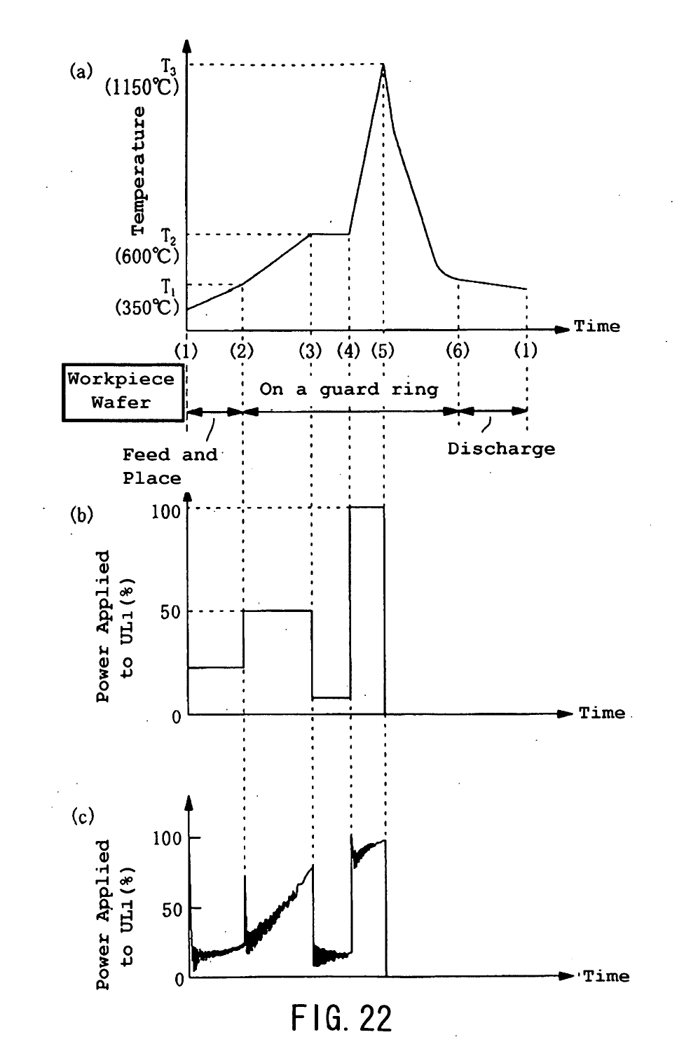

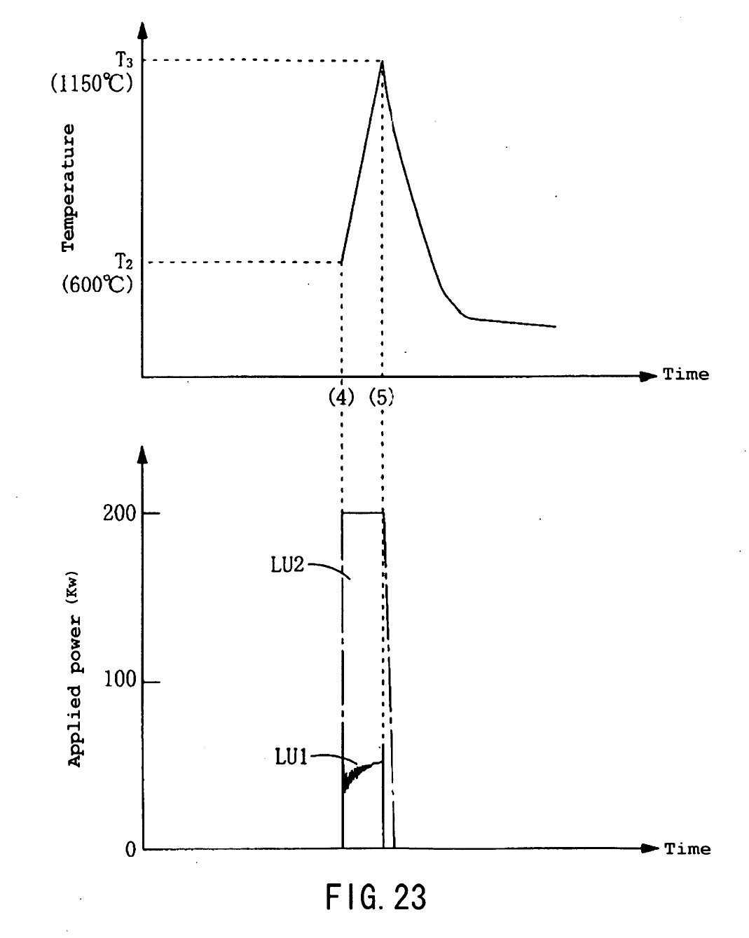

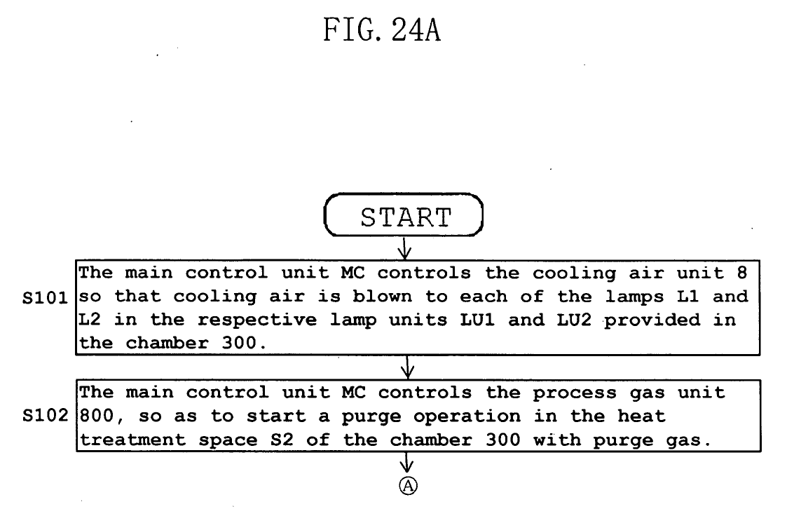

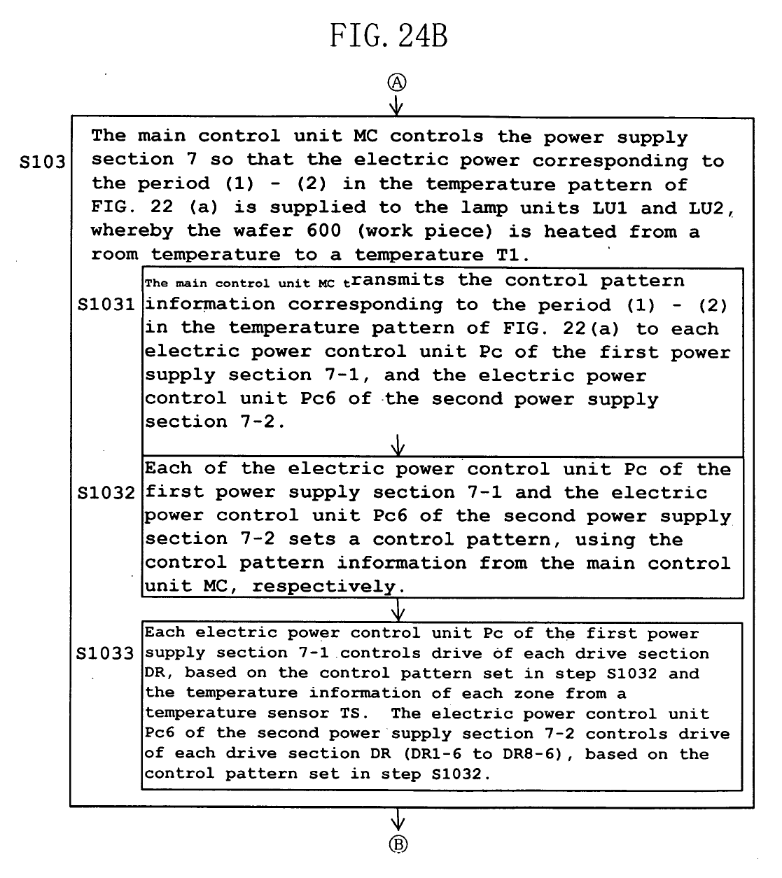

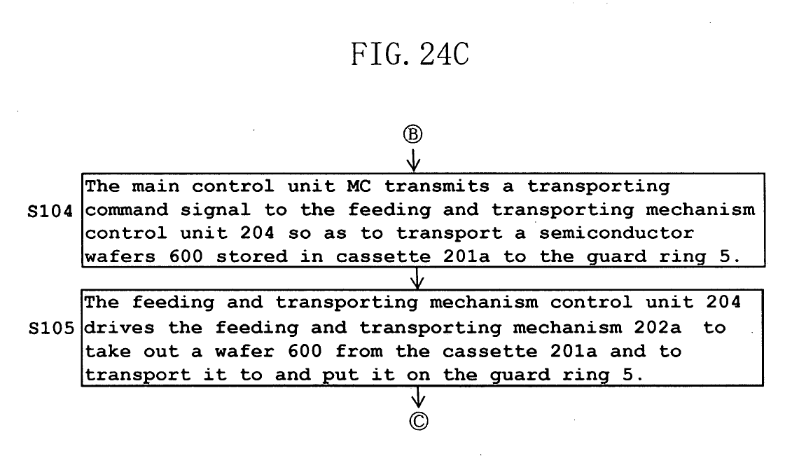

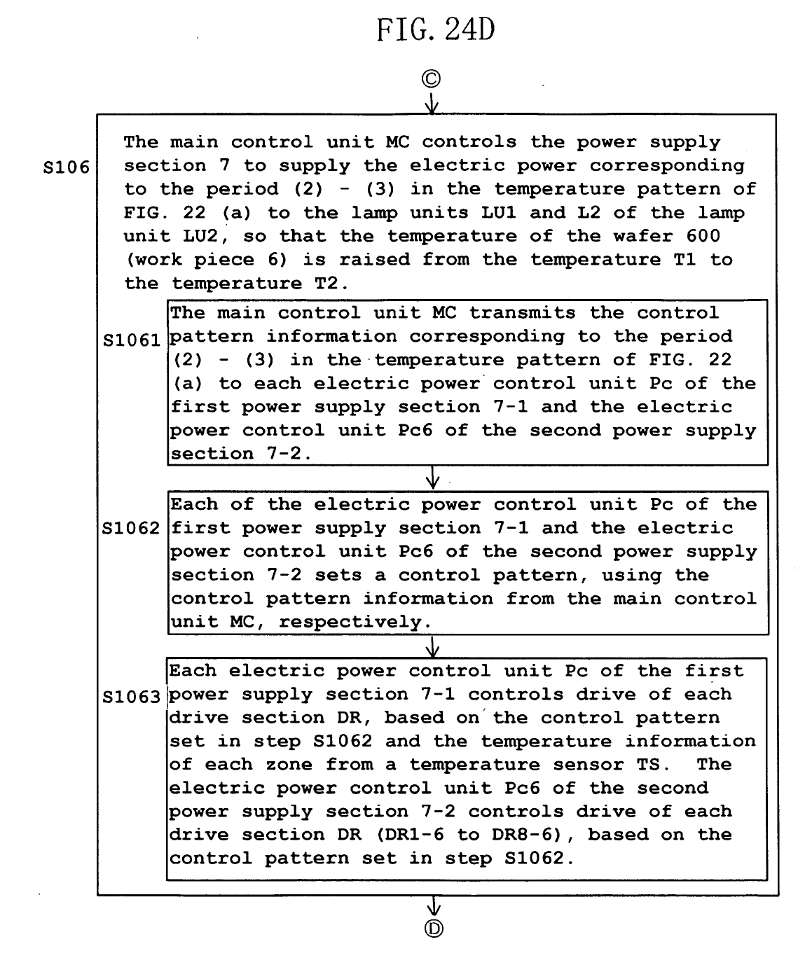

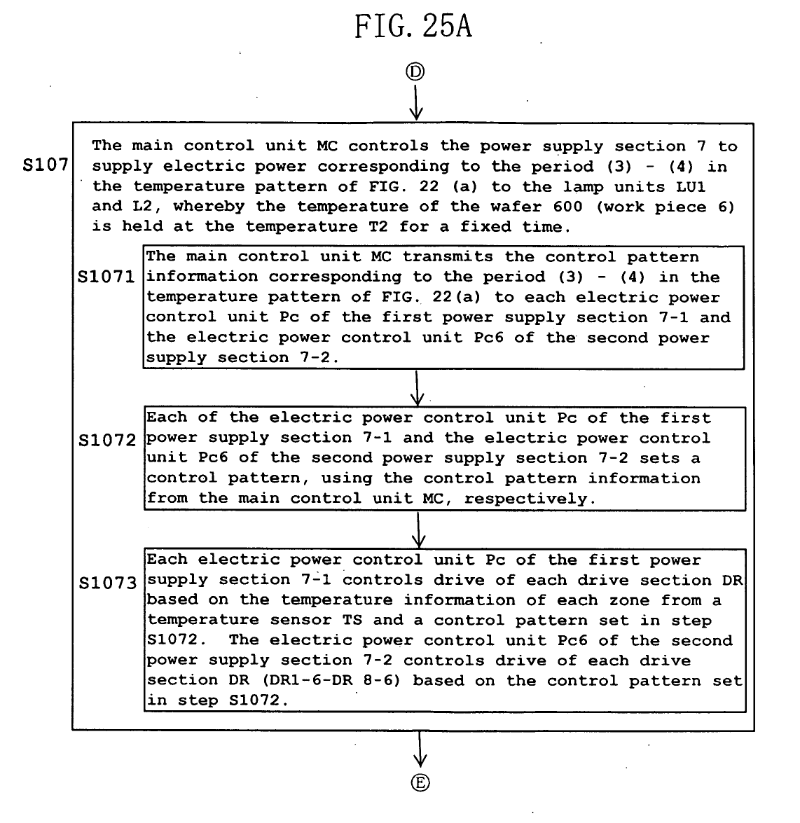

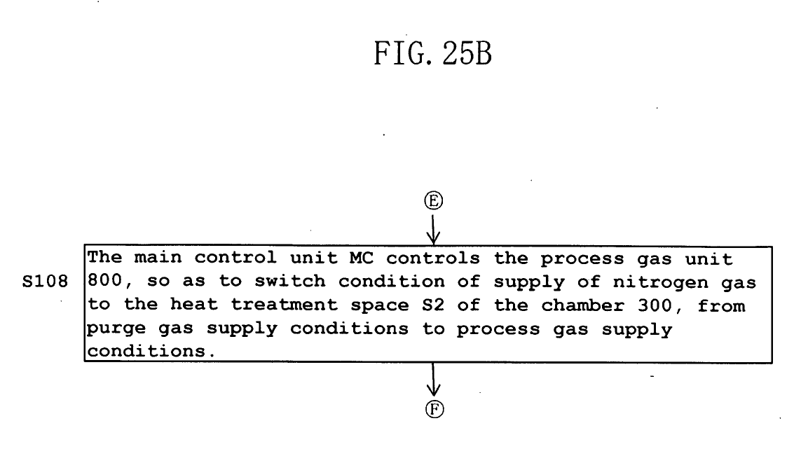

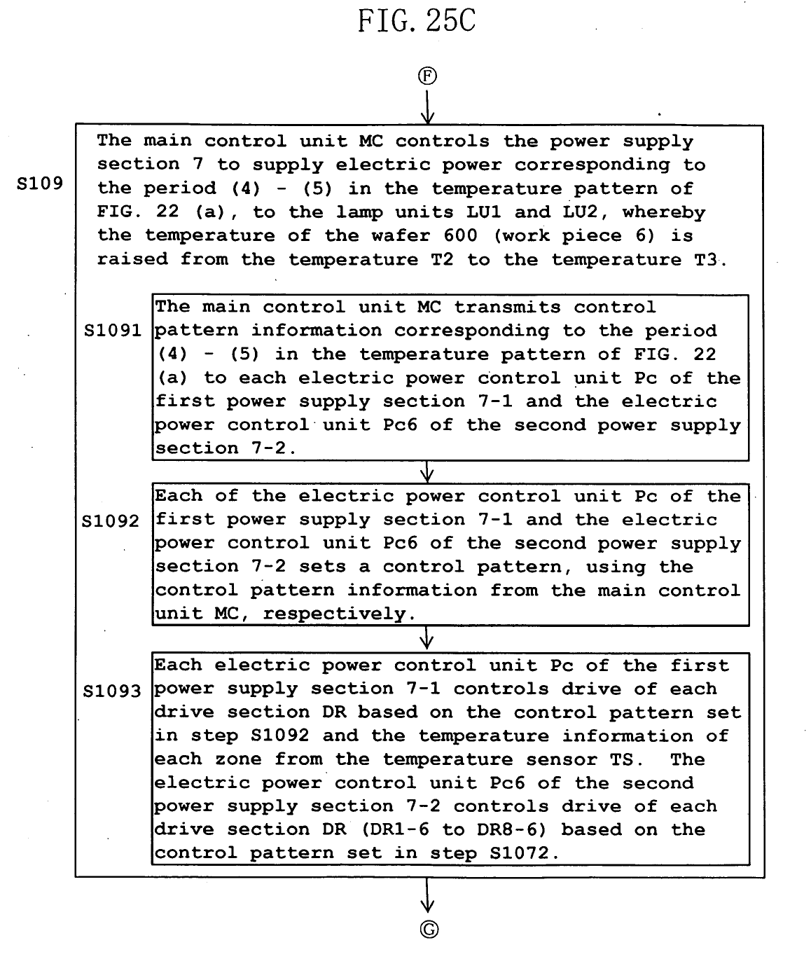

FIG. 22 (a) shows an example of a temperature change (temperature pattern) of a workpiece at time of a heat treatment corresponding to the spike anneal process for activating impurity ions. The workpiece is a semiconductor wafer (silicon wafer) with a diameter of 300 mm as an example as in the first embodiment. In a period (1)-(2), the wafer (workpiece) is heated to a temperature T1 which is in a range of from a room temperature to 350 degree Celsius. This period is a period in which lighting of each lamp L1 of the lamp unit LU1 and each lamp L2 of the lamp unit LU2 starts. When large electric power is supplied to each lamp at time of lighting, the power supply section 7 may receive damage under an influence of rush current. Therefore, in order to control the influence of the rush current, small electric power is supplied to each lamp at time of lighting of each lamp. That is, in this period, the wafer is heated from a room temperature to the temperature T1.

In a period (2)-(3), the temperature of the wafer is raised so that an attained temperature may be set between the temperature T1 and a temperature T2, in a period (3)-(4), the wafer is held at the temperature T2. The temperature T2 is in a range of 500 degrees Celsius to 700 degree Celsius, for example, 600 degree Celsius. On the other hand, the temperature holding time is, for example, a couple of seconds to tens of seconds. One of reasons for providing this temperature holding time, is to stabilize operations of filaments of each lamp L1 of the lamp unit LU1 and a filament of each lamp L2 of the lamp unit LU2 before heat treatment, and another reason therefor is to attain stabilization of heat treatment atmosphere (the heat treatment space S2: refer to FIG. 4). In addition, when the radiation thermometer which can measure the high temperature region of more than 1000 degree Celsius with sufficient accuracy, is used as the temperature measuring section 91, the temperature detection limit (minimum temperature which can be measured highly precisely) thereby is approximately 500 degree Celsius, and a temperature measurement error becomes large at the detection limit or lower. Therefore, the wafer in a state of a pre-heat-treatment is comparatively gently raised to the temperature T2 which is approximately 500 degrees C. to 700 degree Celsius. In addition, if a measurement system, such as a thermocouple, in which a temperature can be measured with sufficient accuracy in a comparatively low temperature range, is used as the temperature measuring section 91, in combination with the radiation thermometer in which a high temperature range can be measured with sufficient accuracy, the temperature of the workpiece can be controlled with sufficient accuracy over the entire temperature range.

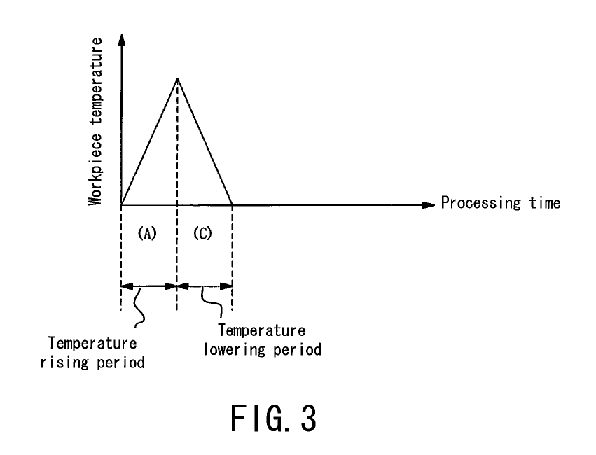

After the heat treatment atmosphere is stabilized, in a period (4)-(5), the temperature of the workpiece is raised until the temperature of the workpiece itself reaches 1150 degree Celsius (shown as T3 in FIG. 22), wherein, for example, the temperature rising speed is 200 to 400 degree Celsius/sec. This period (4)-(5) is equivalent to the temperature raising period (A) shown in FIG. 3. After a time point (5), the temperature of the workpiece is lowered. The period after the time period (5) is equivalent to the temperature lowering period (C) shown in FIG. 3.

In order to realize the temperature pattern shown in FIG. 22 (a), control patterns of electrical energy (applied power) applied to the lamp unit LU1 and the lamp unit LU2 is determined. That is, the control patterns which are in advance set in the electric power control unit Pc of the first power supply section 7-1 and the electric power control unit Pc6 of the second power supply section 7-2 are based on a temperature pattern. The applied power pattern to the lamp unit LU2 is shown in FIG. 22 (b). As described above, the lamp unit LU2 takes charge only of (1) a workpiece temperature rise at a high speed, and a lighting control of each of the lamps L2 which form the lamp unit LU2, is carried out by the control pattern set in advance in the electric power control unit Pc6. Therefore, the power applied to the lamp unit LU2, basically, forms a stairs-like pattern. As shown in FIG. 22 (b), the applied power at the heating-up time of the workpiece (the periods (1)-(2), (2)-(3) and (4)-(5)), is larger than the applied power of the temperature holding period (period (3)-(4)) of the workpiece. Moreover, the power applied to the lamp unit LU2 becomes large, as the attained temperature in the temperature raising period is large.

The applied power pattern to the lamp unit LU1 is shown in FIG. 22 (c). As described above, the lamp unit LU1 takes charge of (2) a high speed response of illuminance control, and (3) good local, illuminance control, wherein lighting control of each of the lamps L1 which form the lamp unit LU1 is performed by a feedback control based on the control pattern which is in advance set in the electric power control unit Pc and the temperature information. Therefore, the power applied to the lamp unit LU1 does not form a stairs-like pattern. In a macroscopic view, the applied power in the temperature raising period of the workpiece (periods (1)-(2), (2)-(3) and (4)-(5)), is larger than the applied power of the temperature holding period (the period (3)-(4)) of the workpiece. Moreover, the power applied to the lamp unit LU1 becomes large, as the attained temperature in the temperature raising period is large. However, since the applied power control is the feedback control based on the temperature information, the applied power pattern forms a fine oscillatory wave form, near these turning points (2), (3) and (4) of the temperature pattern.

FIG. 23 is a diagram in which electric power applied to the lamp unit LU1 is compared with that applied to the lamp unit LU2 in a temperature raising period (4)-(5) and the temperature lowering period after the time point (5). In the period (4)-(5), for example, when the temperature of the workpiece (wafer) is raised to 1150 degree Celsius, the total power applied to the lamp units LU1 and LU2 is approximately 250 kW, wherein the power applied to the lamp unit LU1 is 50 kW and the power applied to the lamp unit LU2 is 200 kW. That is, when the power applied to the lamp unit LU1 is represented as A1 and the power applied to the lamp unit LU2 is represented as A2, they are lighted under the condition of A1<A2 (A1≠0, A2≠0). Since it is necessary to lower the temperature of the workpiece as soon as possible in the temperature lowering period after the time period (5), both of the lamp unit LU1 and the lamp unit LU2 are turned off.

As described above, in the heating method using the present light emission type heating apparatus which, as a light emission unit, has the lamp unit LU1 made up of a group of the lamps L1 including the multi-filament lamps capable of a high speed response, and the lamp unit LU2 made up of a group of the single filaments L2 to which large electric power can be applied, (A) in a temperature raising period, the lamp units LU1 and UL2 are simultaneously lighted under condition of “power applied to the lamp unit LU1 A1”<“power applied to the lamp unit LU2 A2” (A1≠0, A2≠0), and (C) in a temperature lowering period, both of the lamp units LU1 and LU2 are turned off. Therefore, in the high temperature heat treatment mainly comprising two steps, that is, a step of raising a workpiece temperature, and a step of lowering the temperature, it is possible to meet all of the conditions, that is, (1) a temperature rise at a high speed, (2) a high speed response of illuminance control, and (3) good local illuminance control.

In this case, (ii) the lamp unit LU1 performs a control in a feed back manner, so that the temperature of the whole workpiece surface may become uniform, based on a temperature signal from the temperature monitor for a workpiece, which is not shown in FIG. 4, and (iii) since the lamp unit LU2 is lighted in a predetermined electric power pattern (preset program), it is possible to carry out a temperature control without an inference.

Hereafter, steps of a heat treatment of a workpiece in the light emission type heat treatment method according to the present invention, will be described below, referring to FIGS. 4, 6, 16, 22, 24A-24D, 25A-25D and 26. In addition, procedure of the heat treatment of the second embodiment is one that a temperature holding period (B) (the period (5)-(6) shown in FIG. 22 (a)) is omitted from the procedure of heat treatment in the first embodiment. Since the other procedures are substantially the same, description thereof will be briefly given here.

In FIGS. 4 and 6, the main control unit MC controls the cooling air unit 8 so that cooling air is blown to each of the lamps L1 and L2 in the respective lamp units LU1 and LU2 provided in the chamber 300 (step S101 in FIG. 24A). Moreover, the main control unit MC controls the process gas unit 800, so as to start a purge operation in the heat treatment space S2 of the chamber 300 with purge gas (for example, nitrogen gas) (step S102 of FIG. 24A). At this time, the purge gas pressure and the process gas mass flow in the heat treatment space S2 are controlled by the process gas unit 800 at a predetermined value. Next, the main control unit MC controls the power supply section 7 connected to each of the lamps L1 which form the lamp unit LU1, and each of the lamps L2 which form the lamp unit LU2, so that the electric power corresponding to the period (1)-(2) in the temperature pattern of FIG. 22 (a) is supplied to the filaments of each lamp unit LU1 and the filament of each lamp L2 of the lamp unit LU2, whereby the wafer 600 (workpiece) is heated to the temperature T1 which is in a range of from a room temperature to T1 (for example, 350 degree Celsius)(step S103 of FIG. 24B). In addition, the period (1)-(2) in the temperature pattern, is set so that the wafer 600 (workpiece 6) may be taken out from the cassette 201a (which is described later) and is set on the guard ring 5 which is an installation stand.

Since an example of the electric power supply from the power supply section 7 to each filament, is the same as that of the first embodiment, detailed description thereof is omitted. That is, in step 103, the main control unit MC transmits the control pattern information (refer to FIG. 22 (a)) corresponding to the period (1)-(2) in the temperature pattern of FIG. 22 to each electric power control unit Pc of the first power supply section 7-1, and the electric power control unit Pc6 of the second power supply section 7-2 (step S1031 of FIG. 24B). Each of the electric power control unit Pc of the first power supply section 7-1 and the electric power control unit Pc6 of the second power supply section 7-2 sets a control pattern, using the control pattern information from the main control unit MC, respectively (step S1032 of FIG. 24B). Each electric power control unit Pc of the first power supply section 7-1 controls drive of each drive section DR, based on the control pattern set in step S1032 and the temperature information of each zone from a temperature sensor TS (feedback control). Moreover, the electric power control unit Pc6 of the second power supply section 7-2 controls drive of each drive section DR (DR1-6 to DR8-6: refer to FIG. 14), based on the control pattern set in step S1032 (step S1033 of FIG. 24B).

That is, in the period (1)-(2) of FIG. 22, the electric power in applied power pattern shown in FIGS. 22 (b) and (c) is supplied to the lamp units LU1 and LU2 by drive control of each drive section DR in the first power supply section 7-1, and drive control of each drive section DR of the second power supply section 7-2. Consequently, by the light emitted from the lamp units LU1 and LU2, the temperature of the wafer 600 (workpiece 6) is raised to from a room temperature to the temperature T1 (for example, 350 degree Celsius).

The main control unit MC transmits a transporting command signal to the feeding and transporting mechanism control unit 204 so as to transport one of the semiconductor wafers 600 stored in cassette 201a to the guard ring 5 in the chamber 300 and to set it on the guard ring 5 (step S104 of FIG. 24C). The feeding and transporting mechanism control unit 204 which receives the transporting command signal drives the feeding and transporting mechanism 202a, so as to take out one of wafers 600 from the cassette 201a, and to transport it to and put it on, the guard ring 5 (step S105 of FIG. 24C). The steps S101-S105 are performed in the period (1)-(2) of FIG. 22.

In addition, as described above, after the time period (1), the small electric power is supplied to the filaments of each of the lamps L1 and L2 of the lamp units LU1 and LU2 so as to satisfy the conditions that the temperature of the wafer 600 reaches from a room temperature to the temperature T1. Therefore, the feeding and transporting mechanism 202a is heated when the wafer 600 is put on the guard ring 5. The condition of the small electric power is equivalent to condition that attained temperature becomes a heat-resistant temperature of the feeding and transporting mechanism 202a or lower when the feeding and transporting mechanism 202a is heated.

Next, the main control unit MC controls the power supply section 7 connected to each of the lamps L1 which form the lamp unit LU1 and each of the lamps L2 which form the lamp unit LU2, to supply the electric power corresponding to the period (2)-(3) in the temperature pattern of FIG. 22 (a), to the filaments of each lamp L1 of the lamp unit LU1, and the filament of each lamp L2 of the lamp unit LU2, so that the temperature of the wafer 600 (workpiece 6) is raised from the temperature T1 to the temperature T2 (for example, 600 degree Celsius) (step S106 of FIG. 24D). In addition, since the temperature of the wafer 600 is raised, as shown in FIGS. 22 (b) and (c), in the period (2)-(3), the electric power supplied to the lamp units LU1 and LU2 is larger than that supplied in the period (1)-(2). Moreover, in step S105, when the wafer 600 is put on the guard ring 5, air from the outside gets mixed to air in the heat treatment space S2. The period (2)-(3) is set so that this mixed air may fully be discharged from the heat treatment space S2 by purge gas.

In step 106, the main control unit MC transmits the control pattern information (refer to FIG. 22 (a)) corresponding to the period (2)-(3) in the temperature pattern of FIG. 22 to each electric power control unit Pc of the first power supply section 7-1, and the electric power control unit Pc6 of the second power supply section 7-2 (step S1061 of FIG. 24D). Each of the electric power control unit Pc of the first power supply section 7-1 and the electric power control unit Pc6 of the second power supply section 7-2 sets a control pattern, using the control pattern information from the main control unit MC, respectively (step S1062 of FIG. 24D). Each electric power control unit Pc of the first power supply section 7-1 controls drive of each drive section DR, based on the control pattern set in step S1062 and the temperature information of each zone from a temperature sensor TS. Moreover, the electric power control unit Pc6 of the second power supply section 7-2 controls drive of each drive section DR (DR1-6 to DR8-6: refer to FIG. 14), based on the control pattern set in step S1062 (step S1063 of FIG. 24D).

That is, in the period (2)-(3) of FIG. 22, electric power in the applied power pattern which is shown in (b) and (c) of FIG. 22 is supplied to the lamp units LU1 and LU2, according to the drive control of each drive section DR of the first power supply section 7-1 and the drive control of each drive section DR of the second power supply section 7-2. Consequently, the temperature of the wafer 600 (workpiece 6) is raised to from the temperature T1 to the temperature T2 (for example 600 degree Celsius), by light emitted from the lamp units LU1 and LU2.

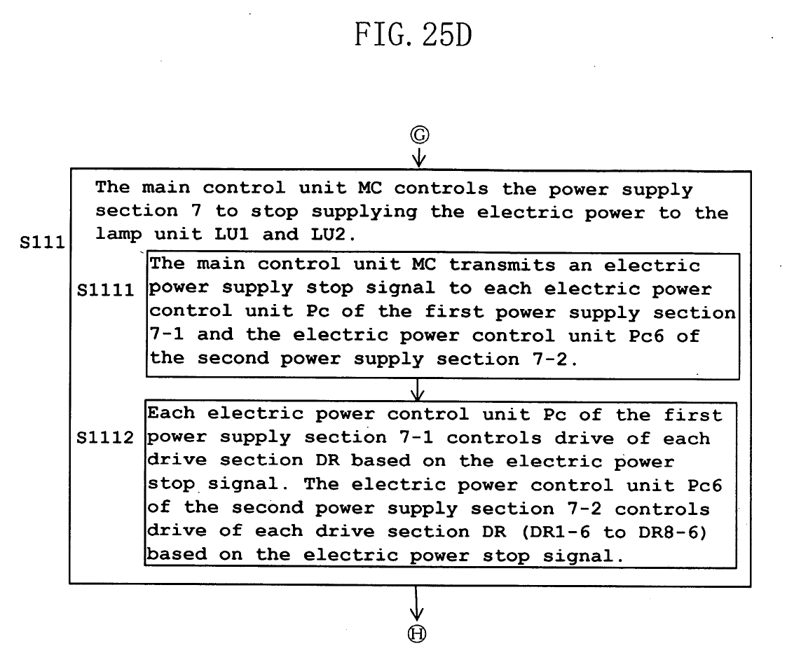

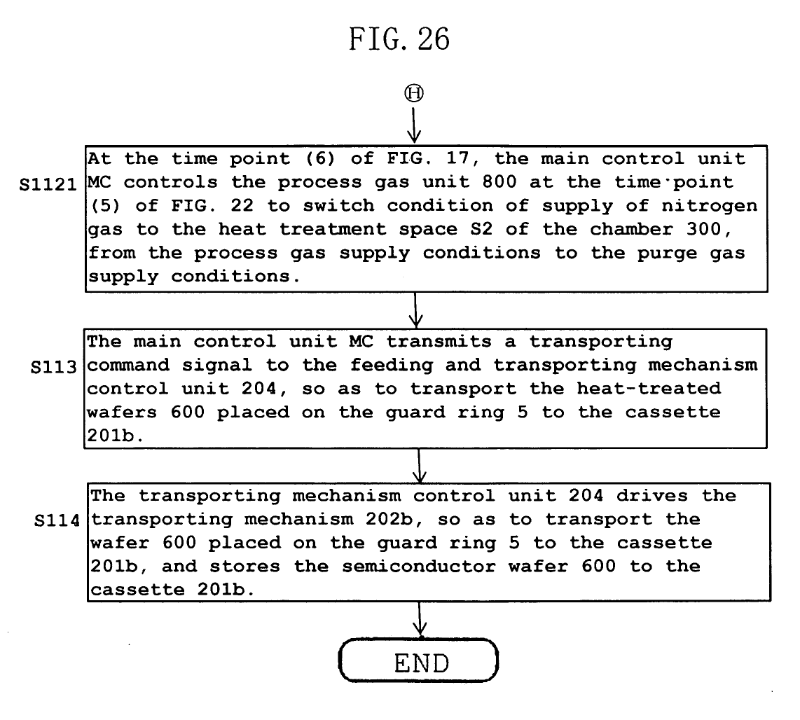

Next, the main control unit MC controls the power supply section 7 connected to the lamps L1 which form the lamp unit LU1 and the lamps L2 which form the lamp unit LU2, so as to supply electric power corresponding to the period (3)-(4) in the temperature pattern of FIG. 22 (a), to the filaments of each lamp L1 of the lamp unit LU1, and the filament of each lamp L2 of the lamp unit LU2, whereby the temperature of the wafer 600 (workpiece 6) is held at the temperature T2 (600 degree Celsius) for a fixed time (for example, for several seconds to tens of seconds) (step S107 of FIG. 25A).

As described above, one of reasons for providing this temperature holding time, is to stabilize operations of filaments of each lamp L1 of the lamp unit LU1 and a filament of each lamp L2 of the lamp unit LU2 before heat treatment, and another reason therefor is to attain stabilization of heat treatment atmosphere (the heat treatment space S2: refer to FIG. 4). The temperature T2 is a temperature at which impurity diffusion does not generate in the wafer 600 heated by a light emission, or a temperature which does not affect a thin film structure (circuit structure) formed by the wafer 600 even if impurity diffusion occurs. In addition, since what is necessary is to compensate only the amount of heat discharged from the wafer 600 when the temperature of the wafer 600 is held, as shown in FIGS. 22(b) and (c), the electric power supplied to the lamp units LU1 and LU2 in the period (3)-(4), is smaller than that in period (2)-(3).

In step 107, the main control unit MC transmits the control pattern information (refer to FIG. 22 (a)) corresponding to the period (3)-(4) in the temperature pattern of FIG. 22 to each electric power control unit Pc of the first power supply section 7-1, and the electric power control unit Pc6 of the second power supply section 7-2 (step S1071 of FIG. 25A). Each of the electric power control unit Pc of the first power supply section 7-1 and the electric power control unit Pc6 of the second power supply section 7-2 sets a control pattern, using the control pattern information from the main control unit MC, respectively (step S1072 of FIG. 25A).

Each electric power control unit Pc of the first power supply section 7-1 controls drive of each drive section DR based on the control pattern set in step S1072 and the temperature information of each zone from the temperature sensor TS. Moreover, the electric power control unit Pc6 of the second power supply section 7-2 controls drive of each drive section DR (DR1-6 to DR8-6: refer to FIG. 14) based on the control pattern set in step S1072 (step S1073 of FIG. 25A). That is, in the period (3)-(4) of FIG. 22, the electric power in the applied power pattern shown in FIGS. 22 (b) and (c) is supplied to the lamp units LU1 and LU2, according to drive control of each drive section DR in the first power supply section 7-1 and drive control of each drive section DR of the second power supply section 7-2. Consequently, the temperature of the wafer 600 (workpiece 6) is held for a fixed period by light emitted from the lamp units LU1 and LU2 at the temperature T2 (for example, 600 degree Celsius).

In the first embodiment, in the step (step S108 of FIG. 20B) which follows the step S107, the main control unit MC controls the process gas unit 800, to stop the purge gas supply to the heat treatment space S2 of the chamber 300, and switch it to supply of process gas (for example, oxygen gas). In the case of the spike anneal process for activation of impurity ion, in general, the heat treatment is carried out in nitrogen gas atmosphere in many cases. Therefore, the second embodiment shows a case where the same nitrogen gas as purge gas is used for the process gas. That is, at the time point (3) of FIG. 24, the main control unit MC controls the process gas unit 800, so as to switch condition of supply of nitrogen gas to the heat treatment space S2 of the chamber 300, from purge gas supply conditions to process gas supply conditions (step S108 of FIG. 25B). The nitrogen gas pressure and the mass flow in the heat treatment space S2 are controlled by the process gas unit 800 at a predetermined value. In addition, when the purge gas supply conditions and the process gas supply conditions are the same, step S1081 is skipped.

Next, the main control unit MC controls the power supply section 7 connected to the lamps L1 which form the lamp unit LU1 and the lamps L2 which form the lamp unit LU2, so as to supply electric power corresponding to the period (4)-(5) in the temperature pattern of FIG. 22 (a), to the filaments of each lamp L1 of the lamp unit LU1, and the filament of each lamp L2 of the lamp unit LU2, whereby the temperature of the wafer 600 (workpiece 6) is raised from the temperature T2 to the temperature T3 (for example, 1150 degree Celsius) (for example, for several seconds to tens of seconds) (step S109 of FIG. 25C). As described above, this period (4)-(5) is equivalent to the temperature raising period (A) in FIG. 3, electric power is supplied to the lamp units LU1 and LU2 so that the temperature rising speed of the wafer 600 may be 200 to 400 degree Celsius/sec. Since this period is a period which the temperature is raised to the maximum temperature in the temperature pattern shown in FIG. 22 (a), the electric power supplied to the lamp units LU1 and LU2 is larger than any of other periods.

In step 109, the main control unit MC transmits control pattern information (refer to FIG. 22 (a)) corresponding to the period (4)-(5) in the temperature pattern of FIG. 22 to each electric power control unit Pc of the first power supply section 7-1, and the electric power control unit Pc6 of the second power supply section 7-2 (step S1091 of FIG. 25C). Each electric power control unit Pc of the first power supply section 7-1 and the electric power control unit Pc6 of the second power supply section 7-2 sets a control pattern, using the control pattern information from the main control unit MC, respectively (step S1092 of FIG. 25C). Each electric power control unit Pc of the first power supply section 7-1 controls drive of each drive section DR based on the control pattern set in step S1092 and the temperature information of each zone from the temperature sensor TS. Moreover, the electric power control unit Pc6 of the second power supply section 7-2 controls drive of each drive section DR (DR1-6 to DR8-6: refer to FIG. 14) based on the control pattern set in step S1072 (step S1093 of FIG. 25C).

That is, in the period (4)-(5) of FIG. 22, the electric power in the applied power pattern shown in FIGS. 22 (b) and (c) is supplied to the lamp units LU1 and LU2, according to drive control of each drive section DR in the first power supply section 7-1 and drive control of each drive section DR of the second power supply section 7-2. Consequently, the temperature of the wafer 600 (workpiece 6) is raised to the temperature T3 (1150 degree Celsius) by light emitted from the lamp units LU1 and LU2. As described above, since power applied to the lamp unit LU1 is controlled in a feedback manner, based on the temperature information of each zone, the temperature of the wafer 600 (workpiece 6) is raised while the uniformity of the temperature of the wafer is maintained.

As described above, the total power applied to the lamp units LU1 and LU2 is approximately 250 kW, wherein the power applied to the lamp unit LU1 is 50 kW and the power applied to the lamp unit LU2 is 200 kW. That is, when the power applied to the lamp unit LU1 is represented as A1 and the power applied to the lamp unit LU2 is represented as A2, in the period (4)-(5), they are lighted under the condition of A1<A2 (A1≠0, A2≠0). When the temperature of the wafer 600 reaches the predetermined temperature T3 (1150 degree Celsius) (the time point (5) of FIG. 22), the main control unit MC controls the power supply section 7 (the first power supply section 7-1, the second power supply section 7-2) connected to each of the lamps L1 which form the lamp unit LU1, and each of the lamps L2 which form the lamp unit LU2, so as to stop supplying the electric power to the filaments of each lamp L1 of the lamp unit LU1 and to each lamp L2 of the lamp unit LU2 (step S111 of FIG. 25D). The temperature of the filaments is lowered as shown as a period after the period (5) in the temperature pattern of FIG. 22 (a).

In step S111, the main control unit MC transmits an electric power supply stop signal to each electric power control unit Pc of the first power supply section 7-1 and the electric power control unit Pc6 of the second power supply section 7-2 (step S1111 of FIG. 25D).

Each electric power control unit Pc of the first power supply section 7-1 controls drive of each drive section DR based on the electric power stop signal. Moreover, the electric power control unit Pc6 of the second power supply section 7-2 controls drive of each drive section DR (DR1-6 to DR8-6: refer to FIG. 14) based on the electric power stop signal (step S1112 of FIG. 25D).

In addition, at the time point (5) of FIG. 22, the main control unit MC controls the process gas unit 800, so as to switch condition of supply of nitrogen gas to the heat treatment space S2 of the chamber 300, from the process gas supply conditions to the purge gas supply conditions (step S1121 of FIG. 26). At this time, the purge gas pressure and the process gas mass flow in the heat treatment space S2 are controlled by the process gas unit 800 at a predetermined value. In addition, when the purge gas supply conditions and the process gas supply conditions are the same, step S1081 is skipped.

At the time point (the time point (6) of FIG. 22) when the temperature of the wafer 600 drops to a predetermined temperature, the main control unit MC determines that the heat treatment of the wafer 600 is completed through the predetermined process. The main control unit MC transmits a transporting command signal to the feeding and transporting mechanism control unit 204, so as to transport the heat-treated wafers 600 placed on the guard ring 5 to the cassette 201b (step S113 of FIG. 26). At the time point (6), the predetermined temperature is set so as to be the heat-resistant temperature of the transporting mechanism 202b or lower. When the feeding and transporting mechanism control unit 204 receives the transporting command signal, it drives the transporting mechanism 202b, so as to transport the wafer 600 placed on the guard ring 5 to the cassette 201b, and to store the semiconductor wafer 600 to the cassette 201b (step S114 of FIG. 26). The heat treatment of the one of the wafers 600 is completed with the above procedure. Hereafter, when the next workpiece is processed, cooling air is blown onto each lamp 1, supply of the purge gas into the chamber 300 is maintained, and the steps S103 to S114 are repeated.

(A) Temperature Rising Period

Description of effects of the light emission type heating method will be described below.

From experiments of the present inventors, it turned out that electric power which is needed for the adjustment of the temperature distribution of the workpiece performed by such local illuminance control, and which is applied to the filaments, is approximately 20% of the total electric power applied to the filaments needed in the temperature raising period. Electric power which is applied to the filaments and which is simply needed to raise the workpiece temperature, becomes approximately 80% of the total electric power applied to the filaments needed in the temperature raising period. Therefore, when, of the total electric power applied to the light emission unit during the temperature raising period, the electric power applied to the lamp unit LU1, is approximately 20% of the total electric power, and the electric power applied to the lamp unit LU2 is approximately 80% of the total electric power, (1) the high temperature raising at a high speed, (2) The high speed response of illuminance control, (3) good local illuminance control becomes possible. That is, in the temperature raising period, it is possible to realize a workpiece temperature rise at a high speed, while maintaining the temperature uniformity of the workpiece with high precision.

That is, (i) when the power applied to the lamp unit LU1 is represented as A1 and the power applied to the lamp unit LU2 is represented as A2, they are lighted under the condition of A1<A2 (A1≠0, A2≠0), (ii) the pattern of power applied to the lamp unit LU1 (which is equivalent to the period (4)-(5) of FIG. 22 (a)) corresponding to the temperature raising pattern of the workpiece temperature pattern is updated based on the temperature information of the workpiece, in a feedback control, so that the temperature of the whole workpiece surface becomes uniform, and (iii) when the applied power control to the lamp unit LU2 which takes charge of the high speed raising temperature of the workpiece is carried out based on the predetermined electric power control pattern (preset program) corresponding to the temperature raising pattern in the temperature pattern (which is equivalent to the period (4)-(5) of FIG. 17 (a)), in the temperature raising period, it is possible to realize all the conditions, that is, (1) a high temperature raising at a high speed, (2) a high speed response of illuminance control, and (3) a good local illuminance control. If the feedback control is adopted as lighting control of both the lamp unit LU1 and the lamp unit LU2, they may interfere with each other, so that there is a possibility that temperature may not be stabilized (converge). Therefore, if lighting of the lamp unit LU2 is controlled according to the preset program, and lighting of the lamp unit LU1 is controlled in a feedback manner, it is possible to carry out a temperature control without such interference.

(C) Temperature Lowering Period

(C) In a temperature lowering period, since it is necessary to lower the temperature of the workpiece as soon as possible, both of the lamp unit LU1 and the lamp unit LU2 are turned off.

Therefore, in the high temperature heat treatment mainly comprising two steps, that is, a step of raising a workpiece temperature, and a step of lowering the temperature, it is possible to satisfy all of the conditions, that is, (1) a temperature rise at a high speed, (2) a high speed response of illuminance control, and (3) good local illuminance control. Therefore, in the high temperature heating process of a manufacturing process of a semiconductor integrated circuit, such as a formation of a shallow junction, it is possible to raise the temperature of such a workpiece at a high speed. Moreover, due to the miniaturization and high performance of a semiconductor device, the highly precise uniformity in temperature of the workpiece can be realized in the high temperature heating process.

In addition, in setting of this embodiment, not only the irradiated area of a workpiece is set concentrically as in the prior art, but also the single concentric circle is divided into two or more zones. In the setting of such a zone, not only influence of the thermal radiation from an edge portion of the workpiece but also influence of the atmosphere (for example, the flow of gas, uneven light reflection due to a wall portion of the heat treatment space, etc.) of the heat treatment space where the workpiece is placed, are also taken into consideration. As shown in FIG. 7, when the length and arrangement of each filament of the lamp unit LU1 is set up according to each such zone, and the feedback control of the lamp unit LU1 is carries out, so that the illuminance on each zone may be set to a predetermined value, it is possible to perform a light emission type heat treatment of the wafer, while maintaining uniform temperature distribution with high precision all over the wafer.

Here, it not necessary to provide independent control systems whose number is the number of filaments, and when two or more filaments corresponding to each zone are set as a filament group, and the electric power is controlled so as to be supplied to the filaments belonging to the same group in block by one control signal, it is possible to efficiently carry out electric power supply control to the filaments of the lamps corresponding to each zone set in the area to be irradiated with light by a comparatively simple structure. That is, even if the number of filaments becomes large when a large workpiece is used, the light emission type heating treatment apparatus does not become large, so that it is possible to suppress increase of cost of the apparatus.

### (8) Other Embodiment

In the embodiment, in the first power supply section 7-1, as an example, the drive section DR which supplies electric power in electrical energy to each of the filaments belonging to each filament group, is controlled in block by the same control signal (command signal) from the electric power control unit Pc which is respectively provided for each filament group. The command signal is obtained from the comparison operation of the temperature information from the temperature sensors TS1-TS5 provided in the respective zones, and the temperature pattern set in advance in each electric power control unit Pc. That is, the electric power supplied to the filaments of each of the lamps L1 which form the first lamp unit LU1 is controlled in a feedback manner, based on the temperature information of each zone. Depending on a type of heat treatment, the electric power supplied to the first lamp unit LU1 may be controlled, based on the predetermined control pattern (preset program), as in the second lamp unit LU2.

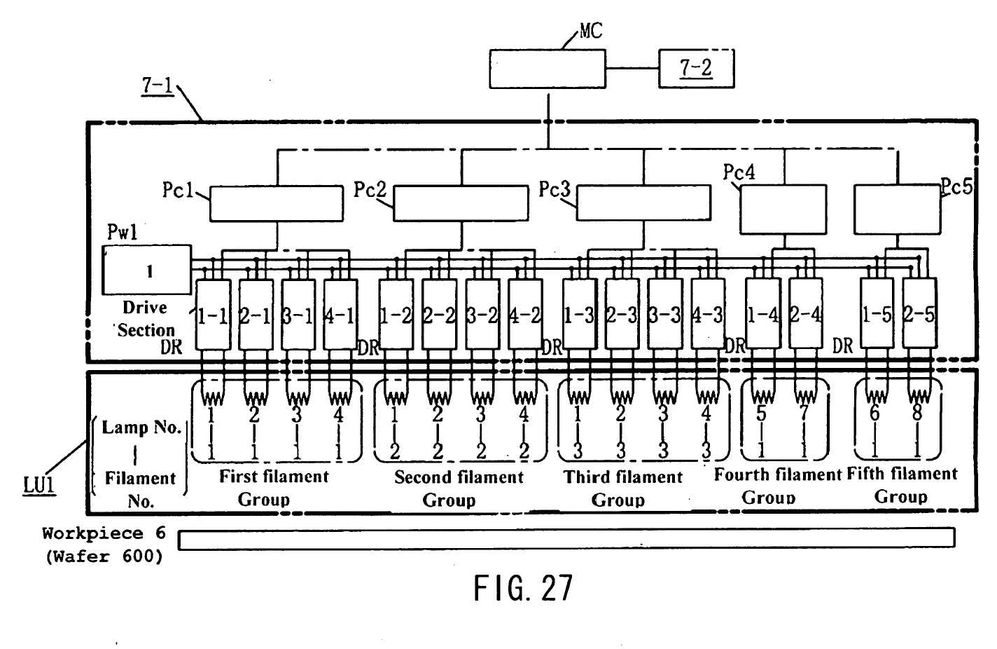

In this case, in an example of configuration example and arrangement of the lamp unit LU1 corresponding to the zone division shown in FIG. 7, the temperature sensors TS1, TS2, TS3, TS4, and TS5 which measure the temperature of respective zones are omitted. Moreover, as shown in FIG. 27, the structure of the first power supply section 7-1, is configured so that the temperature sensors TS1, TS2, TS3, TS4, and TS5 and the temperature information from the temperature sensor are omitted from the structure shown in FIG. 12. Furthermore, the structure of the drive section DR becomes equivalent to the structure of the drive section DR belonging to the second power supply section 7-2 shown in FIG. 15. That is, the control pattern corresponding to the temperature pattern (which, for example, has three periods, a temperature raising period of a workpiece, a constant temperature holding period, and a temperature lowering period, serially) for the heat treatment of the workpiece is set in advance, in each electric power control unit Pc, wherein each electric power control unit Pc controls the drive section DR based on the control pattern, so that the temperature of each zone is approximately in agreement with the temperature pattern. By such control, the illuminance on each zone is adjusted to a predetermined value, and the temperature of the workpiece under heat treatment is held so as to be approximately uniform.

Similarly to the case of the embodiment described above, in the first power supply section 7-1 shown in FIG. 27, the drive section DR which supplies electric power in electrical energy to each of the filaments belonging to each filament group is controlled in block by the same control signal (command signal) from the electric power control unit Pc provided for every filament group, respectively. Since the heat capacity of the filaments of each lamp L1 which form the first lamp unit LU1 is made as small as possible in this embodiment, it is possible to suppress poor control, such as overshoot and undershooting, in workpiece temperature control. That is, in the first lamp unit LU1, the high speed response of the filament lamp L1 is realized, and the intensity of light emitted from the filaments of the filament lamp turns into a predetermined value at high speed, as a result of control of the power applied to the filament lamps. An example of the heating method in case of controlling electric power supplied to the first lamp unit LU1 and the second lamp unit LU2 based on the predetermined control pattern (preset program) will be described below.

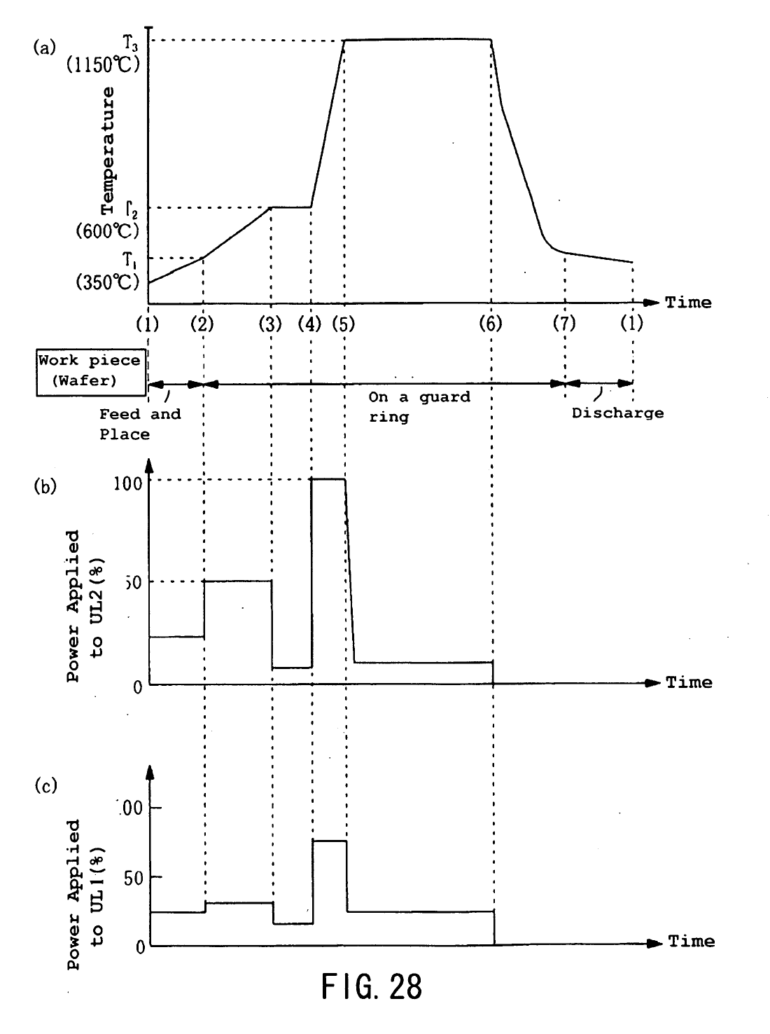

FIG. 28 (a) shows an example of the temperature change (temperature pattern) of the workpiece at the time of heat treatment. Here, temperature change (temperature pattern) of the workpiece at time of the heat treatment is the same as that shown in FIG. 17 (a), and detailed explanation is omitted, below. In order to realize the temperature pattern shown in FIG. 28 (a), the control pattern of electrical energy (applied power) supplied in the lamp unit LU1 and the lamp unit LU2 is determined. That is, the control pattern which is in advance set in the electric power control unit Pc of the first power supply section 7-1 and the electric power control unit Pc6 of the second power supply section 7-2, is determined, based on the temperature pattern.

FIG. 28 (b) shows a pattern of power applied to the lamp unit LU2. As described above, the lamp unit LU2 takes charge only of (1) a workpiece temperature rise at a high speed, and lighting control of each of the lamps L2 which form the lamp unit LU2 is performed by the control pattern which is in advance set in the electric power control unit Pc6. Therefore, the power applied to the lamp unit LU2, basically, forms a stairs-like pattern. As shown in FIG. 28 (b), the applied power at the heating-up time of the workpiece (the periods (1)-(2), (2)-(3) and (4)-(5)), is larger than the applied power of the temperature holding period (the periods (3)-(4) and (5)-(6)) of the workpiece. Moreover, the power applied to the lamp unit LU2 becomes large, as the attained temperature in the temperature raising period is large.

The applied power pattern to the lamp unit LU1 is shown in FIG. 28 (c). As described above, the lamp unit LU1 takes charge of (2) a high speed response of illuminance control, and (3) good local illuminance control, and lighting control of each of the lamps L1 which form the lamp unit LU1 is performed in the control pattern which is in advance set in the electric power control unit Pc. Therefore, the applied power pattern to the lamp unit LU1, basically, forms a stairs-like pattern. As shown in FIG. 28 (c), the applied power at time of raising the temperature of the workpiece (the periods (1)-(2), (2)-(3) and (4)-(5)) is larger than the applied power in the temperature holding period (the periods (3)-(4) and (5)-(6)) of the workpiece, and the power applied to the lamp unit LU1 becomes large, as the attained temperature in the temperature raising period becomes large.

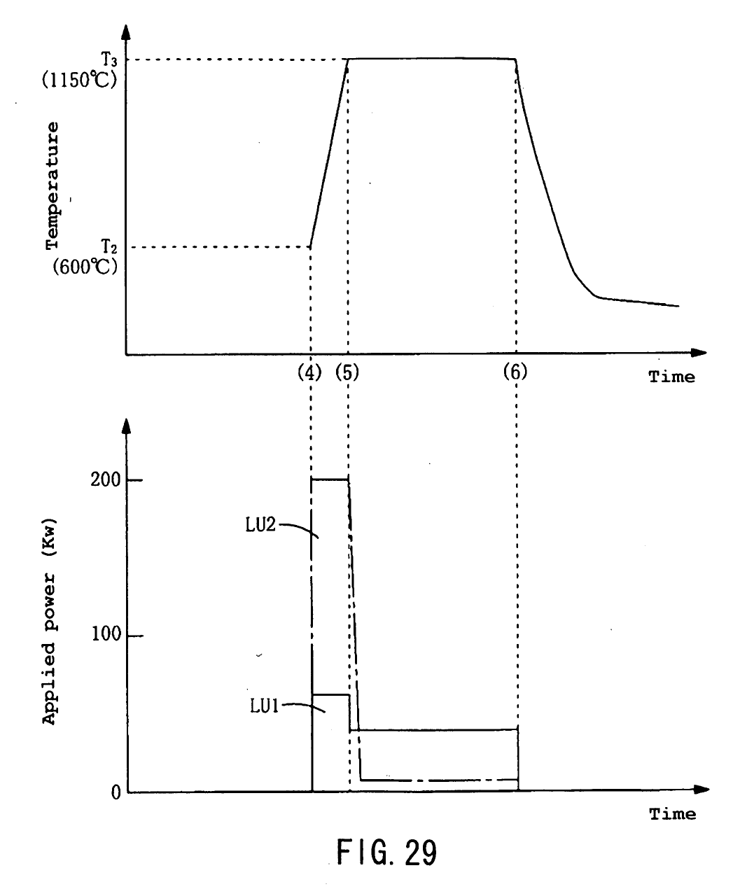

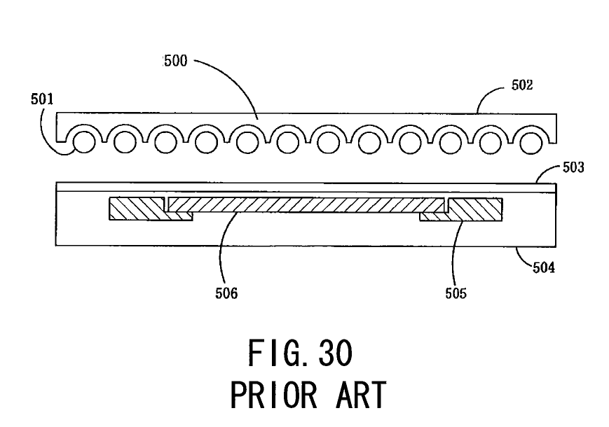

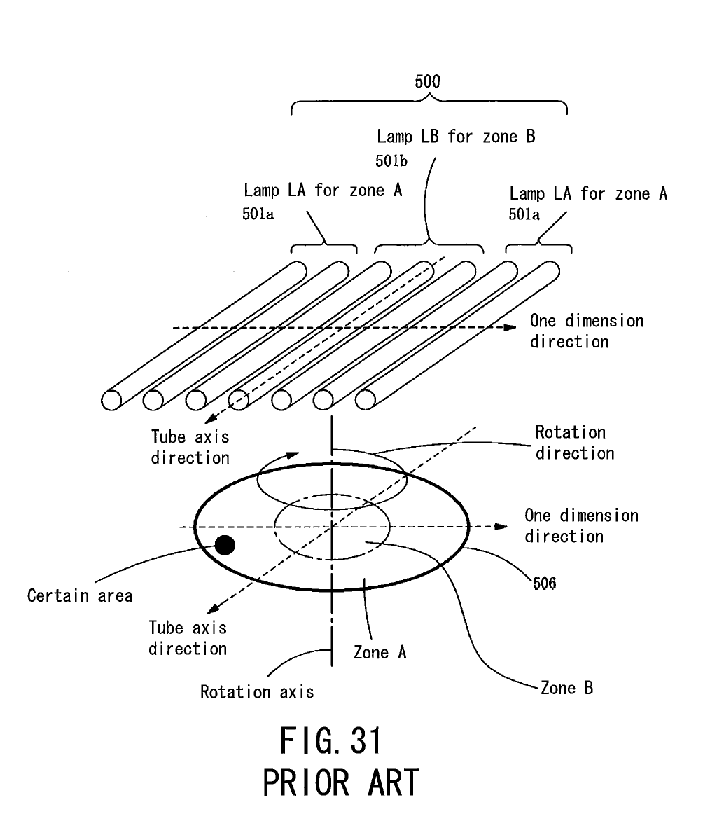

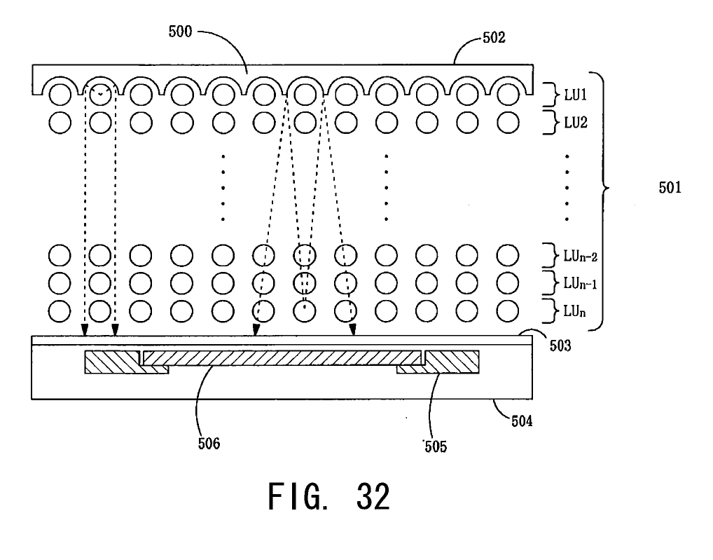

FIG. 29 is a diagram in which electric power applied to the lamp unit LU1 is compared with that applied to the lamp unit LU2, in a temperature raising period (4)-(5), the temperature holding period (5)-(6), and the period after the period (6) (the temperature lowering period). In the period (4)-(5), for example, when the temperature of the workpiece (wafer) is raised to 1150 degree Celsius, the total power applied to the lamp units LU1 and LU2 is approximately 250 kW, wherein the power applied to the lamp unit LU1 is 50 kW and the power applied to the lamp unit LU2 is 200 kW. That is, when the power applied to the lamp unit LU1 is represented as A1 and the power applied to the lamp unit LU2 is represented as A2, they are lighted under the condition of A1<A2 (A1≠0, A2≠0).

Next, when the temperature of the workpiece (wafer) is held at 1150 degree Celsius in the period (5)-(6), the total power applied to the lamp units LU1 and LU2 is approximately 36 kW. As described above, when constant temperature control of the semiconductor wafer (silicon wafer) with a diameter of 300 mm is carried out at 1150 degree Celsius, if its attention is paid only to temperature maintenance, the required electric power which is applied to the filaments of all the filament lamps of the light emission unit is approximately 30 kW. On the other hand, it turned out by experiment of inventors that it was approximately 20% of the total electric power which is applied to the filaments and which is needed for temperature maintenance, in order to perform local illuminance control for maintaining the temperature distribution of the workpiece or a target temperature. Therefore, the electric power applied to the filaments of the filament lamp needed for local illuminance control is set to approximately 6 kW (=30 kW×20%).

Although the constant temperature control of the workpiece (wafer) can be performed by lighting only the lamp unit LU1, here, as shown in FIG. 29, the lamp units LU1 and LU2 are lighted on simultaneously. The power applied to the lamp unit LU1 is set to approximately 30 kW and the power applied the lamp unit LU2 is set to approximately 6 kW. That is, when power applied to the lamp unit LU1 is represented as B1, and the power applied to the lamp unit LU2 is represented as B2 in the constant temperature holding period, the lamp units LU1 and LU2 are lighted simultaneously under condition of B1>B2 (B1≠0, B2≠0). When the lamp unit LU1 is used, B2=0 and B1≠0. Since it is necessary to lower the temperature of the workpiece as soon as possible in the temperature lowering period after the time period (6), both of the lamp unit LU1 and the lamp unit LU2 are turned off.

Since in the procedure of the present embodiment, power applied to the lamp unit LU1 is not controlled in a feedback manner as in the heat treatment procedure of the first and second embodiments of heat treatment, but controlled in the predetermined control pattern, the procedure thereof is omitted here since the fundamental procedure is the same as each other. In addition, the heat treatment procedure of this embodiment differs from that of the first embodiment, in that in the present embodiment, the control signals A, B, C, D, E, and F shown in FIG. 16 are obtained based on only the control patterns which are set in advance, and are not changed based on the temperature information of each zone from the temperature sensors TS.

The preceding description has been presented only to illustrate and describe exemplary embodiments of the present light emission type heating method and light emission type heating apparatus according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light emission type heating method in which a workpiece is heated according to a predetermined heating pattern, using a light emission type heating apparatus, comprising a first lamp unit which includes two or more straight-bulb lamps arranged in parallel, in which at least one of the lamps includes two or more filaments in its light emission bulb, and intensity of light emitted from each filament can be independently controlled, and a second lamp unit which is made up of two or more straight-bulb lamps arranged in parallel, each of which has a filament, and wherein in the two or more straight-bulb lamps of the first lamp unit, in each of which a filament of at least one of the lamps and a filament of another one of the lamps are arranged so as to form a group, whereby as a whole, two or more groups of filaments are formed, the lamp emission type heating method comprising the following steps of:
detecting a temperature of the workpiece, and
controlling electric power to be applied to each of the groups of filaments which form the first lamp unit, based on the detected temperature of the workpiece.

2. The light emission type heating method according to claim 1, wherein a heat capacity of each filament in each of the lamps which form the first lamp unit is smaller than that of each filament in each of the lamps which form the second lamp unit, and wherein electric power to be individually applied to the each group of the filaments of the lamps which form the first lamp unit, is controlled based on the detected temperature of the workpiece so that a temperature of a workpiece surface becomes approximately uniform, and electric power to be applied to the filaments of the lamps which form the second lamp unit is controlled in the predetermined heating pattern.

3. The light emission type heating method according to claim 1, wherein in the step of detecting the temperature of the workpiece, the temperature of the workpiece is detected as to each group, and based on the detected temperature of the workpiece, electric power to be applied to the filaments of the lamps belonging to each group is controlled in block.

4. The light emission type heating method according to claim 1, wherein the predetermined heating pattern includes a workpiece temperature raising period, and a relation of a total electric power A1 which can be applied to the filaments of the lamps forming the first lamp unit in the workpiece temperature raising period, and a total electric power A2 which can be applied to the filaments of the lamps forming the second lamp unit in the workpiece temperature raising period is 0.1□A1/A1+A2)□0.4.

5. A light emission type heating treatment apparatus for heating a workpiece according to a predetermined heating pattern by emitting light, comprising:
a first lamp unit including two or more of straight-bulb lamps arranged in parallel, wherein at least one of the lamps has two or more filaments arranged in an axis direction in its light emission bulb, and the two or more filaments are connected to respective lead wires from which electric power is applied to the two or more filaments individually;
a second lamp unit including two or more straight tube type lamps arranged in parallel;
wherein the first lamp unit and the second lamp unit form a two layer structure, and the first lamp unit is provided so as to directly face the workpiece,
a first driving section which applies electric power to the filaments of the two or more lamps which form the first lamp unit;
a second driving section which applies electric power to filaments of the two or more lamps which form the second lamp unit; a first electric power controller which controls the first driving section;
a second electric power controller which controls the second driving section; and
a temperature sensor which detects a temperature of the workpiece,
wherein the filaments of the lamps which form the first lamp unit are divided into two or more groups, in each of which a filament of at least one of the lamps and a filament of another lamp are formed so as to be a group,
wherein the first electric power controller is provided for each of the two or more groups, and
wherein the first electric power controller controls the first driving section based on the detected temperature of the workpiece by the temperature sensor.

6. The light emission type heating treatment apparatus according to claim 5, wherein a heat capacity of the filament of each of the lamps which form the first lamp unit is smaller than that of the filament of each of the lamps which form the second lamp unit, wherein a predetermined electric power supply control pattern is set in the second electric power controller, wherein the second electric power controller controls the second driving section based on the predetermined electric power supply control pattern.

7. The light emission type heating treatment apparatus according to claim 5, wherein the temperature sensor is provided at a position corresponding to each group, in which the first electric power controller which is provided for each group, controls the first driving section for each group in block, based on the detected temperature of the workpiece detected by each temperature sensor.

8. The light emission type heating treatment apparatus according to claim 5, wherein the first electric power controller and the second electric power controller control the first driving section and the second driving section, respectively, according to a predetermined heating pattern which includes a period during which the workpiece temperature is raised to a predetermined temperature, so that a relation of a total electric power A1 which can be applied to the filaments of the lamps forming the first lamp unit in the workpiece temperature raising period, and a total electric power A2 which can be applied to the filaments of the lamps forming the second lamp unit in the workpiece temperature raising period is 0.1□A1/(A1+A2)□0.4.

9. The light emission type heating treatment apparatus according to claim 5, wherein at least one of the lamps which form the second lamp unit has a center portion where light is not emitted therefrom or light intensity thereof is lower than other portions.
